(19) United States
(12) Patent Application Publication
(10) Pub. No.: US 2015/0010143 A1
(43) Pub. Date: Jan. 8, 2015

(54) SYSTEMS AND METHODS FOR SIGNATURE COMPUTATION IN A CONTENT LOCALITY BASED CACHE

(71) Applicant: HGST Netherlands B.V., Amsterdam (NL)

(72) Inventor: Ken Qing YANG, Saunderstown, RI (US)

(21) Appl. No.: 14/332,113

(22) Filed: Jul. 15, 2014

Related U.S. Application Data
(63) Continuation-in-part of application No. 13/615,422, filed on Sep. 13, 2012.
Application No. 13/615,422 is a continuation of application No. 13/366,846, filed on Feb. 6, 2012.
Application No. 13/366,846 is a continuation of application No. 12/762,993, filed on Apr. 19, 2010.
(60) Provisional application No. 61/174,166, filed on Apr. 30, 2009.
(60) Provisional application No. 61/534,915, filed on Sep. 15, 2011.
(60) Provisional application No. 61/533,990, filed on Sep. 13, 2011.
(60) Provisional application No. 61/497,549, filed on Jun. 16, 2011.
(60) Provisional application No. 61/447,208, filed on Feb. 28, 2011.
(60) Provisional application No. 61/441,976, filed on Feb. 11, 2011.

(51) Int. Cl. H04L 9/14; G06F 3/06; G06F 12/08; H04L 9/08

(52) U.S. Cl. CPC H04L 9/14; H04L 9/0816; G06F 3/0611; G06F 3/0619; G06F 3/0655; G06F 3/068; G06F 12/0866; G06F 2212/214
USPC 380/28; 711/118

(57) ABSTRACT

The present disclosure relates to methods and circuits for signature computation in a content locality cache. A method can include dividing a received block into shingles, where each shingle represents a subset of the received block. The method can include, for each shingle, determining an intermediate fingerprint by processing the shingle, and determining whether the intermediate fingerprint is more representative of the contents of the block than a previous fingerprint. If so, the method can include storing the intermediate fingerprint as a representative fingerprint. If not, the method can include keeping the previous fingerprint as the representative fingerprint. The method can further include determining whether there are more shingles to process. If so, the method can include processing the next shingle. If not, the method can include computing the signature of the contents of the block by adding the representative fingerprint to a sketch of the received block.

### CROSS-REFERENCE TO RELATED APPLICATIONS

This application is a continuation-in-part of U.S. patent application Ser. No. 13/615,422, filed Sep. 13, 2012, which further claims the benefit of U.S. Provisional Patent Application Ser. No. 61/534,915 filed Sep. 15, 2011; and U.S. Provisional Patent Application Ser. No. 61/533,990 filed Sep. 13, 2011.

U.S. patent application Ser. No. 13/615,422 is a continuation of U.S. patent application Ser. No. 13/366,846, filed Feb. 6, 2012, which further claims the benefit of U.S. Provisional Patent Application Ser. No. 61/497,549 filed Jun. 16, 2011; U.S. Provisional Patent Application Ser. No. 61/447,208 filed Feb. 28, 2011; and U.S. Provisional Patent Application Ser. No. 61/441,976 filed Feb. 11, 2011;

U.S. patent application Ser. No. 13/366,846 is a continuation of U.S. patent application Ser. No. 12/762,993 filed Apr. 19, 2010, which further claims the benefit of U.S. Provisional Patent Application Ser. No. 61/174,166 filed Apr. 30, 2009.

The entire contents of each application are incorporated by reference herein.

### FIELD OF THE DISCLOSURE

The present disclosure relates to data caching techniques, and more particularly to caching techniques based on content locality.

### BACKGROUND

Recent developments in solid state drives (SSDs) have been promising with rapid increases in capacity and decreases in cost. Because SSDs are implemented on a semiconductor device, SSDs provide advantages in terms of high-speed random reads, low power consumption, compact size, and shock resistance. Accordingly, current performance and cost characteristics of SSDs make them a good fit for a cache layer between system random access memory (RAM) and hard disk drive (HDD). However, traditional cache designs such as least recently used (LRU) eviction and variants do not work well for SSD cache, because SSD cache exhibits physical properties quite different from traditional RAM memories that have been used in cache designs for several decades.

Both flash memory cells and phase change memory (PCM) cells used in an SSD show asymmetrical properties in terms of read performance and write performance. For example, writes typically exhibit slower performance and resource usage (e.g., several times or an order of magnitude slower) compared with reads because of physical properties of the memory cells. In addition, write operations wear these memory cells, causing endurance problems. Take flash memory as an example. Each memory cell in flash memory may be changed in only one direction, i.e. from 1 to 0 but not vice versa. As a result, flash memory requires write operations to be performed on a clean page (e.g., a page having all 1's). The page then becomes the basic write unit for flash memory, typically sized around a few kilobytes (KB). In other words, write operations are not performed in-place. Overwriting a desired page thus is typically performed in new and clean pages in SSD. Therefore, when SSD is used as a cache having repeated read and write operations, the SSD may fill quickly. If there are no clean pages available for writes, garbage collection may be triggered. Garbage collection makes clean pages by erasing pages containing obsolete data. Such erase operations are done per unit of flash blocks, in which each flash block contains 64, 128, or more pages. Due to random reads and writes, a block chosen for erasure may contain pages with valid data. These pages with valid data may have to be moved to other blocks in order to erase the block. This phenomenon is referred to as write amplification: one write cascades into multiple writes for garbage collection. The cost of garbage collection and write amplification can be dramatic as SSD utilization approaches its full capacity.

### SUMMARY

The present disclosure relates to signature computation in a content locality based cache.

In one embodiment, the present disclosure describes a method for computing a signature of contents of a block in a cache. The method can include dividing a received block into shingles, where each shingle represents a subset of the received block. For each shingle, the can include determining an intermediate fingerprint by processing the shingle, and determining whether the intermediate fingerprint is more representative of the contents of the block than a previous fingerprint. If the intermediate fingerprint is determined to be more representative of the contents of the block, the method can include storing the intermediate fingerprint as a representative fingerprint. If the intermediate fingerprint is determined to be less representative of the contents of the block, the method can include keeping the previous fingerprint as the representative fingerprint. The method can further include determining whether there are more shingles to process. If there are more shingles to process, the method can include processing the next shingle. If there are no more shingles to process, the method can include computing the signature of the contents of the block by adding the representative fingerprint to a sketch of the received block.

In one embodiment, the present disclosure describes a circuit for computing a signature of contents of a block in a cache. The circuit can include a fingerprint circuit, a fingerprint buffer, and a comparator. The fingerprint circuit can be configured for processing a shingle of a received block, where the shingle represents a subset of the contents of the received block, and where the fingerprint circuit is configured to determine an intermediate fingerprint by processing the shingle. The fingerprint buffer can be configured for storing a previous fingerprint. The comparator can be in electrical communication with the fingerprint circuit and the fingerprint buffer. The comparator can be configured for comparing the intermediate fingerprint from the fingerprint circuit with the previous fingerprint from the fingerprint buffer to determine whether the intermediate fingerprint is more representative of the contents of the received block than the previous fingerprint. The comparator can also be configured for storing, in the fingerprint buffer, the intermediate fingerprint as a representative fingerprint for inclusion in the signature of the contents of the block, if the intermediate fingerprint is determined to be more representative.

The embodiments described herein can include additional aspects. For example, determining whether the intermediate fingerprint is more representative of the contents of the block than the previous fingerprint can include comparing the intermediate fingerprint with the previous fingerprint to determine whether the intermediate fingerprint is larger compared with the previous fingerprint, and if the intermediate fingerprint is determined to be larger compared with the previous fingerprint, the intermediate fingerprint can be determined to be more representative of the contents of the block. Determining whether the intermediate fingerprint is more representative of the contents of the block than the previous fingerprint can include comparing the intermediate fingerprint with the previous fingerprint to determine whether the intermediate fingerprint is smaller compared with the previous fingerprint, and if the intermediate fingerprint is determined to be smaller compared with the previous fingerprint, the intermediate fingerprint can be determined to be more representative of the contents of the block. Determining the intermediate fingerprint can include computing a hash value for the shingle. Determining the intermediate fingerprint can include determining a first intermediate fingerprint by performing a modulo operation between a Mersenne prime and the shingle, where the modulo operation is performed using a plurality of addition operations, determining a second intermediate fingerprint by performing a random permutation of the first intermediate fingerprint; and using the second intermediate fingerprint as the intermediate fingerprint. Performing the random permutation of the first intermediate fingerprint can include performing a bit shift operation by a random number of bits on the first intermediate fingerprint, and performing an addition operation by a random constant on the second intermediate fingerprint. Determining the intermediate fingerprint can include determining a first intermediate fingerprint by performing Rabin fingerprinting on the shingle, where the Rabin fingerprinting calculates a random irreducible polynomial based on the shingle using a plurality of shift operations and exclusive or (XOR) operations, determining a second intermediate fingerprint by performing a random permutation of the first intermediate fingerprint, and using the second intermediate fingerprint as the intermediate fingerprint. The method can further include sampling a first subset of bits from the first intermediate fingerprint, determining whether the sampled first subset of bits from the first intermediate fingerprint matches a bit mask pattern, if the sampled first subset of bits from the first intermediate fingerprint matches the bit mask pattern, determining the second intermediate fingerprint based on a remaining second subset of bits from the first intermediate fingerprint, and otherwise, processing the next shingle. Determining the intermediate fingerprint can include determining a first intermediate fingerprint by calculating a random irreducible polynomial based on the shingle, sampling a first subset of bits from the first intermediate fingerprint, determining whether the sampled first subset of bits from the first intermediate fingerprint matches a bit mask pattern, if the sampled first subset of bits from the first intermediate fingerprint matches the bit mask pattern, determining a second intermediate fingerprint based on a remaining second subset of bits from the first intermediate fingerprint, and using the second intermediate fingerprint as the intermediate fingerprint; and otherwise, processing the next shingle. Calculating the random irreducible polynomial can include performing a table lookup of a pre-computed term of the random irreducible polynomial. The random irreducible polynomial can include (b₁*p⁷+b₂*p⁶+b₃*p⁵+b₄*p⁴+b₅*p³+b₆*p²+b₇*p¹+b₈) mod M, where bᵢ denotes an i′th byte string of the shingle, where p denotes a prime constant, and M denotes a constant. The comparator configured for comparing the intermediate fingerprint from the fingerprint circuit with the previous fingerprint from the fingerprint buffer to determine whether the intermediate fingerprint is more representative of the contents of the previous block than the previous fingerprint can include the comparator being configured for determining whether the intermediate fingerprint is larger than the previous fingerprint, and where determining whether the intermediate fingerprint is larger than the previous fingerprint determines whether the intermediate fingerprint is more representative of the contents of the received block than the previous fingerprint. The comparator configured for comparing the intermediate fingerprint from the fingerprint circuit with the previous fingerprint from the fingerprint buffer to determine whether the intermediate fingerprint is more representative of the contents of the previous block than the previous fingerprint can include the comparator being configured for determining whether the intermediate fingerprint is smaller than the previous fingerprint, and where determining whether the intermediate fingerprint is smaller than the previous fingerprint determines whether the intermediate fingerprint is more representative of the contents of the received block than the previous fingerprint. The fingerprint circuit can include a first adder, a second adder, a third adder, a fourth adder, and a bit shifter. The first adder, the second adder, and the third adder can be configured for determining a first intermediate fingerprint by performing a modulo operation between a Mersenne prime and the shingle. The modulo operation can be performed by adding, using the first adder, a first subset of high order bits of the shingle to a second subset of high order bits of the shingle; adding, using the second adder, a first subset of low order bits of the shingle to a second subset of low order bits of the shingle; and determining, using the third adder, the first intermediate fingerprint by adding a result of the first adder to a result of the second adder. The bit shifter and the fourth adder can be configured for determining a second intermediate fingerprint by performing a random permutation of the first intermediate fingerprint. Performing the random permutation can include performing, using the bit shifter, a bit shift operation by a random number of bits on the first intermediate fingerprint; performing, using the fourth adder, an addition operation by a random constant on the second intermediate fingerprint, and using the second intermediate fingerprint as the intermediate fingerprint. The fingerprint circuit can include a polynomial subcircuit, a bit shifter, and an adder. The polynomial subcircuit can be configured for determining the first intermediate fingerprint, where the polynomial subcircuit includes a plurality of shift registers and a plurality of logic gates arranged to generate a Rabin fingerprint of the shingle, where the Rabin fingerprint represents a hash value of the contents of the received block. The bit shifter and the adder can be configured for determining a second intermediate fingerprint by performing a random permutation of the first intermediate fingerprint. Performing the random permutation can include performing, using the bit shifter, a bit shift operation by a random number of bits on the first intermediate fingerprint; performing, using the adder, an addition operation by a random constant on the second intermediate fingerprint; and using the second intermediate fingerprint as the intermediate fingerprint. The fingerprint circuit can include a polynomial subcircuit, a first logic gate, and a second logic gate. The polynomial subcircuit can be configured for determining the first intermediate fingerprint, where the polynomial subcircuit includes a plurality of shift registers and a plurality of logic gates arranged to generate a Rabin fingerprint of the shingle, where the Rabin fingerprint represents a hash value of the contents of the received block. The first logic gate can be configured for sampling a first subset of bits from the first intermediate fingerprint by bit masking a subset of high order bits from the first intermediate fingerprint. The second logic gate can be configured for determining the second intermediate fingerprint, upon performing a logical AND operation to determine whether the sampled first subset of bits from the first intermediate fingerprint matches the bit mask pattern; and using the second intermediate fingerprint as the intermediate fingerprint. The fingerprint circuit can include a polynomial subcircuit, a first logic gate, and a second logic gate. The polynomial subcircuit can be configured for determining the first intermediate fingerprint, where the polynomial subcircuit includes a plurality of shift registers and an adder, where the plurality of shift registers and the adder are arranged to calculate a random irreducible polynomial based on the shingle, where the random irreducible polynomial represents a hash value of the contents of the received block. The first logic gate can be configured for sampling a first subset of bits from the first intermediate fingerprint by bit masking a subset of low order bits from the first intermediate fingerprint. The second logic gate is configured for determining the second intermediate fingerprint, upon performing a logical AND operation to determine whether the sampled first subset of bits from the first intermediate fingerprint matches the bit mask pattern; and using the second intermediate fingerprint as the intermediate fingerprint. The polynomial subcircuit can further include a lookup table, where the lookup table includes a pre-computed term of the random irreducible polynomial, and where a term of the random irreducible polynomial is calculated based on looking up a corresponding pre-computed term in the lookup table. The polynomial subcircuit can be configured to store in the shift registers the random irreducible polynomial (b₁*p⁷+b₂*p⁶+b₃*p⁵+b₄*p⁴+b₅*p³+b₆*p²+b₇*p¹+b₈)mod M, where bᵢ denotes an i′th byte string of the shingle, where p denotes a prime constant, and where M denotes a constant.

### BRIEF DESCRIPTION OF THE FIGURES

Various objects, features, and advantages of the present disclosure can be more fully appreciated with reference to the following detailed description when considered in connection with the following drawings, in which like reference numerals identify like elements. The following drawings are for the purpose of illustration only and are not intended to be limiting of the invention, the scope of which is set forth in the claims that follow.

FIGS. 1-2 depict block diagrams of a data storage system consisting of a host computer in communication with an SSD memory chip, in accordance with some embodiments of the present disclosure.

FIGS. 3A-3B illustrate high performance primary storage cache based storage systems, in accordance with some embodiments of the present disclosure.

FIGS. 4A-4B depict block diagrams of an example write operation in content locality caching, in accordance with some embodiments of the present disclosure.

FIG. 5 depicts a high-level logic flowchart of an example write operation by the content locality based cache system, in accordance with some embodiments of the present disclosure.

FIGS. 6A-6B illustrate example operation of a read request for the content locality based cache, in accordance with some embodiments of the present disclosure.

FIG. 7 illustrates a high-level logic flowchart of an example method for read operations, in accordance with some embodiments of the present disclosure.

FIGS. 8A-8B illustrate block diagrams of example disk controllers for content locality based caching, in accordance with some embodiments of the present disclosure.

FIGS. 9A-10B illustrate example block diagrams of a host bus adaptor (HBA) for content locality based caching, in accordance with some embodiments of the present disclosure.

FIGS. 11-13A depict example block diagrams of software-based implementations of content locality based caching, in accordance with some embodiments of the present disclosure.

FIG. 13B illustrates an example method for caching a block in the content locality cache, in accordance with some embodiments of the present disclosure.

FIG. 13C illustrates an example method for reading a cached block from the content locality cache, in accordance with some embodiments of the present disclosure.

FIG. 13D illustrates an example structure of the content locality based cache, in accordance with some embodiments of the present disclosure.

FIG. 14 illustrates an example write operation directed to primary storage using the content locality based cache, in accordance with some embodiments of the present disclosure.

FIG. 15 illustrates a flow diagram of an example primary storage directed write operation using content locality based caching, in accordance with some embodiments of the present disclosure.

FIG. 16 illustrates an example read operation directed to primary storage using the present content locality based caching, in accordance with some embodiments of the present disclosure.

FIG. 17 illustrates a flow diagram of an example primary storage directed read operation using content locality based caching, in accordance with some embodiments of the present disclosure.

FIG. 18 shows a flowchart for an example similarity detection method for content locality based caching, in accordance with some embodiments of the present disclosure.

FIG. 19 illustrates a flowchart of example cache management actions upon a cache miss in content locality based caching, in accordance with some embodiments of the present disclosure.

FIGS. 20-21 show measured speedups for benchmarks in a prototype, in accordance with some embodiments of the present disclosure.

FIGS. 22-23 show I/O reductions for all benchmarks with block size being 4 KB and 8 KB, respectively, in the prototype, in accordance with some embodiments of the present disclosure.

FIG. 24 illustrates the percentage of independent blocks found in the experiments, in accordance with some embodiments of the present disclosure.

FIG. 25 illustrates average delta sizes of the delta compression for all the benchmarks, in accordance with some embodiments of the present disclosure.

FIG. 26 illustrates measured performance results for some cases, in accordance with some embodiments in accordance with some embodiments of the present disclosure.

FIG. 27 illustrates a ratio of the number of SSD writes of the baseline system to the number of writes of the I-CASH prototype, in accordance with some embodiments of the present disclosure.

FIG. 28A illustrates a block diagram of an example tag array and data array in the content locality based cache, in accordance with some embodiments of the present disclosure.

FIG. 28B illustrates examples of sub-block signatures and a HeatMap used in the content locality based cache, in accordance with some embodiments of the present disclosure.

FIG. 28C illustrates another example implementation of a HeatMap for use in the content locality based cache, in accordance with some embodiments of the present disclosure.

FIG. 29 shows example cache data content after selecting block (A, D) as a reference block in content locality based caching, in accordance with some embodiments.

FIG. 30 illustrates an example classification of cached pages into different categories for content locality based caching, in accordance with some embodiments of the present disclosure.

FIG. 31 illustrates an example reference page selection process for content locality based caching, in accordance with some embodiments of the present disclosure.

FIG. 32 illustrates an example cache management algorithm for content locality based cache, in accordance with some embodiments of the present disclosure.

FIG. 33 illustrates an example block diagram of the system including the RAM layout for RAM cache, in accordance with some embodiments of the present disclosure.

FIGS. 34-35 illustrate block diagrams of example compression/de-duplication in content locality based caching, in accordance with some embodiments of the present disclosure.

FIG. 36 illustrates a block diagram of example storage of data in a cache memory of a data storage system that is capable of similarity-based delta compression, in accordance with some embodiments of the present disclosure.

FIG. 37 illustrates a block diagram of example differentiated data storage in a cache memory system that comprises at least two different types of memory, in accordance with some embodiments of the present disclosure.

FIG. 38 illustrates a block diagram of example caching based on data content locality, spatial locality, or data temporal locality, in accordance with some embodiments of the present disclosure.

FIG. 39 illustrates a block diagram of example similarity detection of data, such as data associated with an application, in accordance with some embodiments of the present disclosure.

FIGS. 40-41 illustrate flowcharts of example methods of performing similarity detection of data associated with an application, in accordance with some embodiments of the present disclosure.

FIG. 42 illustrates a flowchart of an example method of dynamically setting a similarity threshold based on false positive, reference block, and associated block detection performance, in accordance with some embodiments of the present disclosure.

FIGS. 43-44 illustrate flowcharts of example methods of selecting a subset of most frequently generated signatures, in accordance with some embodiments of the present disclosure.

FIG. 45 illustrates a flowchart of an example method of selecting a most significant byte of each of the subset of most frequently generated signatures, in accordance with some embodiments of the present disclosure.

FIG. 46 illustrates a flowchart of an example method of performing mod operations on the most frequently generated signatures for sample-based similarity detection, in accordance with some embodiments of the present disclosure.

FIG. 47 illustrates a flowchart of an example method of selecting a subset of sub-signatures for sample-based similarity detection in a cache management algorithm, in accordance with some embodiments of the present disclosure.

FIG. 48A illustrates an example method of signature computation for the content locality cache, in accordance with some embodiments of the present disclosure.

FIG. 48B illustrates an example of a fingerprint circuit for content locality caching, in accordance with some embodiments of the present disclosure.

FIG. 49A illustrates an example method of signature computation for the content locality cache, in accordance with some embodiments of the present disclosure.

FIG. 49B illustrates an example implementation of a fingerprint circuit, in accordance with some embodiments of the present disclosure.

FIG. 50A illustrates an example method of signature computation for the content locality cache, in accordance with some embodiments of the present disclosure.

FIG. 50B illustrates an example implementation of a fingerprint circuit, in accordance with some embodiments of the present disclosure.

FIG. 51A illustrates an example method of signature computation for the content locality cache, in accordance with some embodiments of the present disclosure.

FIG. 51B illustrates an example implementation of a fingerprint circuit, in accordance with some embodiments of the present disclosure.

FIG. 52A illustrates an example method of signature computation for the content locality cache, in accordance with some embodiments of the present disclosure.

FIG. 52B illustrates an example implementation of a fingerprint circuit, in accordance with some embodiments of the present disclosure.

FIG. 53 illustrates an example block diagram of periodic scanning between reference blocks and associated blocks, in accordance with some embodiments of the present disclosure.

FIGS. 54-56 illustrate expected performance for an example hardware implementation of content locality based caching, in accordance with some embodiments of the present disclosure.

FIGS. 57-58 illustrate an expected comparison of a number of virtual machines supportable in content locality based caching, in accordance with some embodiments.

### DETAILED DESCRIPTION OF EXAMPLE EMBODIMENTS

The present disclosure relates to a content locality based cache design that can be implemented in hardware, firmware, or as a custom application-specific integrated circuit (ASIC). As used herein, content locality refers to systems and methods for caching data blocks according to contents identified to be similar to other cached blocks. For example, some embodiments of the content locality cache can determine data to cache based on recency and frequency of internal contents of data blocks.

Traditional caching has been based on spatial locality, i.e. caching data blocks with similar logical block addresses (LBAs) in memory. Instead, content locality can keep data contents in cache that are popular, and shared by many active data blocks. Popularity and active sharing can represent two indicators that a data block can exhibit content locality. In some embodiments, popularity can be identified by tracking frequency and recency of “content signatures,” also referred to herein as “fingerprints,” which are being accessed by I/O operations. In some embodiments, fingerprint circuits, also referred to herein as signature computation circuits or similarity detection circuits, can identify data blocks that exhibit content locality based on similarity. Accordingly, the signature computation circuits can identify popular content that is cached. Furthermore, the content locality based cache can use delta compression hardware circuits and/or software modules to improve cache usage upon determination or creation of a corresponding associated block.

In some embodiments, the content locality cache can be self-contained and can be offloaded to a host bus adapter (HBA) card or storage controller. Example storage controllers can include an SSD controller, an HDD controller, or a hybrid HDD controller. Example memory used in SSD may include flash memory, phase change memory (PCM), magnetoresistive random access memory (MRAM or MeRAM), or memory resistor (memristor). A high level logic design of the cache can exploit content locality of I/O operations. Advantages of the design can include minimal write operations on SSD, high I/O performance because of effective caching, data reduction as a superset of traditional data deduplication, longer endurance for flash memory and PCM SSD, low overhead in the range of nanoseconds, and scalability and expandability to large server clusters with coherent multiple caches.

To make an SSD an effective cache between system RAM and HDD, systems using content locality caching can reduce write operations in SSD to leverage physical properties of the SSD. The cache can exploit content locality that is independent of and in addition to temporal locality and spatial locality. Temporal locality and spatial locality are principles that have driven traditional cache design. Temporal locality represents the concept that data that has been read or written recently can benefit from caching, under an assumption that the system is likely to access the data again. Spatial locality represents the concept that the system can benefit from caching related data in close-by memory addresses. Experimental results and customer installations have shown advantages of content locality based caching. For example, the content locality cache has been implemented as software working at the level of data blocks as a device driver running in OS kernels. This software implementation has advantages of working with any storage hardware, and being portable to different operating systems to provide performance advantages.

However, the fact that the prototype can be implemented as software running on servers can also have limitations. First, the software implementation can use system resources of the server on which the software runs. Example resources used can include CPU time, system RAM space, and bus bandwidth. In contrast, a hardware-based implementation can offload cache functions to a controller or device level, thereby allowing the host to spend more time and resources working on applications. Second, the overhead of software cache management algorithms can take microseconds of precious I/O processing time. As device technologies advance, access times of PCM, MRAM, and memrister come down to the range of nanoseconds. Therefore, the high speed cache design may benefit from overhead shorter than microsecond-length overhead. Accordingly, the content locality based cache exploits physical properties of SSDs and data content locality of I/O operations to provide performant I/O without using server resources and while providing manageable overhead in the nanosecond range.

In the summary above, the detailed description, the claims below, and in the accompanying drawings, reference is made to particular features (including method steps). It is to be understood that the disclosure this specification includes all possible combinations of such particular features. For example, where a particular feature is disclosed in the context of a particular aspect or embodiment, or a particular claim, that feature can also be used, to the extent possible, in combination with and/or in the context of other particular aspects and embodiments, and embodiments generally.

Where reference is made herein to a method comprising two or more defined steps, the defined steps can be carried out in any order or simultaneously (except where the context would indicate otherwise), and the method can include one or more other steps which are carried out before any of the defined steps, between two of the defined steps, or after all the defined steps (except where the context would indicate otherwise).

A host computer system can refer to any computer system that uses and accesses a data storage system for data read and data write operations. Such host system may run applications such as databases, file systems, web services, and so forth.

SSD can refer to any solid state disks such as NAND gate flash memory, NOR gate flash memory, phase change memory (PCM), memory resistor (memristor) memory, resistive random access memory (ReRAM), magnetoresistive random access memory (MRAM or MeRAM), or any nonvolatile solid state memory having the properties of fast reads, slow writes, and limited life time due to wearing caused by write operations.

Mass storage can include hard disk drives (HDDs) including but not limited to hard disk drives, nonvolatile RAM (NVRAM), MEMS storage, and battery backed DRAM. Although the descriptions in this disclosure include hard disk drives with spinning disks, generally any type of non-volatile storage can be used in place of hard disk drive.

An intelligent processing unit can refer to any computation engine capable of high performance computation and data processing, including but not limited to GPU (graphic processing unit), CPU (central processing unit), embedded processing unit, MCU (micro controller unit), a custom ASIC (application-specific integrated circuit), firmware, or custom hardware. The term intelligent processing unit and GPU/CPU are used interchangeably in the present disclosure.

HBA can refer to any host bus adaptor that connects a storage device to a host through a bus, such as PCI, PCI-Express, PCI-X, InfiniBand, HyperTransport, and the like. Examples of HBAs include SCSI PCI-E card, SATA PCI-E card, iSCSI adaptor card, Fibre Channel PCI-E card, etc.

LBA can refer to a logic block address that represents the logical location of a data block in a storage system. A host computer may use a logical block address to read or write a data block.

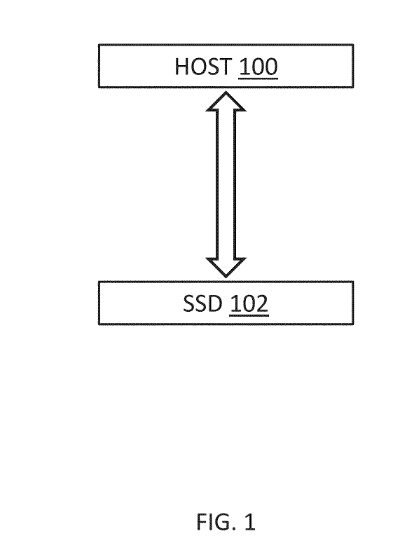

FIG. 1 illustrates a block diagram of a known data storage system consisting of a host computer 100 in communication with an SSD memory chip 102, in accordance with some embodiments of the present disclosure. Host computer 100 can read data from and write data to a NAND-gate flash, NOR-gate flash, or other known SSD memory chip 102. As described above, this simple system can provide I/O performance limited to that available from SSD technology and limited memory chip operating life based on SSD limitations described herein and elsewhere.

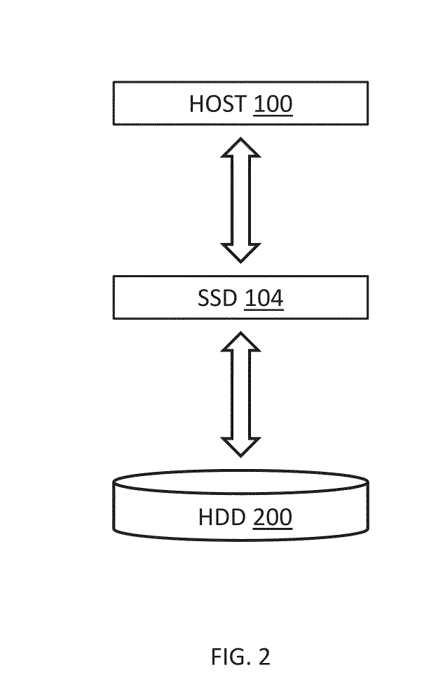

FIG. 2 depicts a block diagram of a similar known data storage system, in accordance with some embodiments of the present disclosure. The system includes host 100, SSD 104 used as a lower level storage cache, and HDD 200 for primary data storage. The performance increase from using SSD 104 can be limited in part because storage I/O requests do not take advantage of data locality or content locality. In addition, large quantities of random writes can slow down SSD performance and shorten the operating life of an SSD.

### Cache Architecture

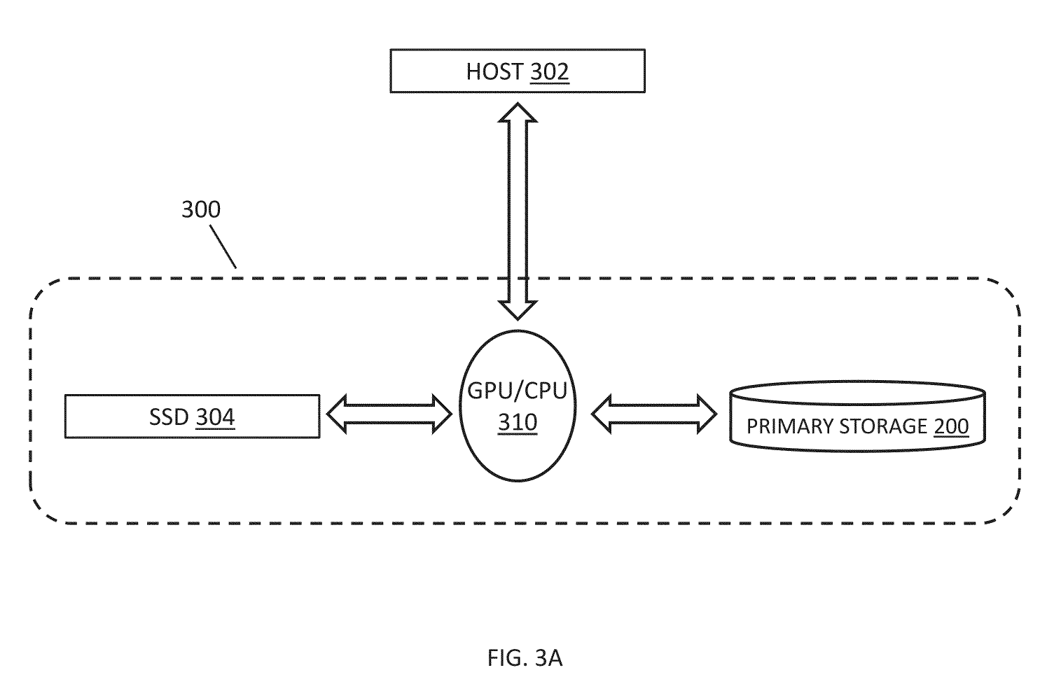

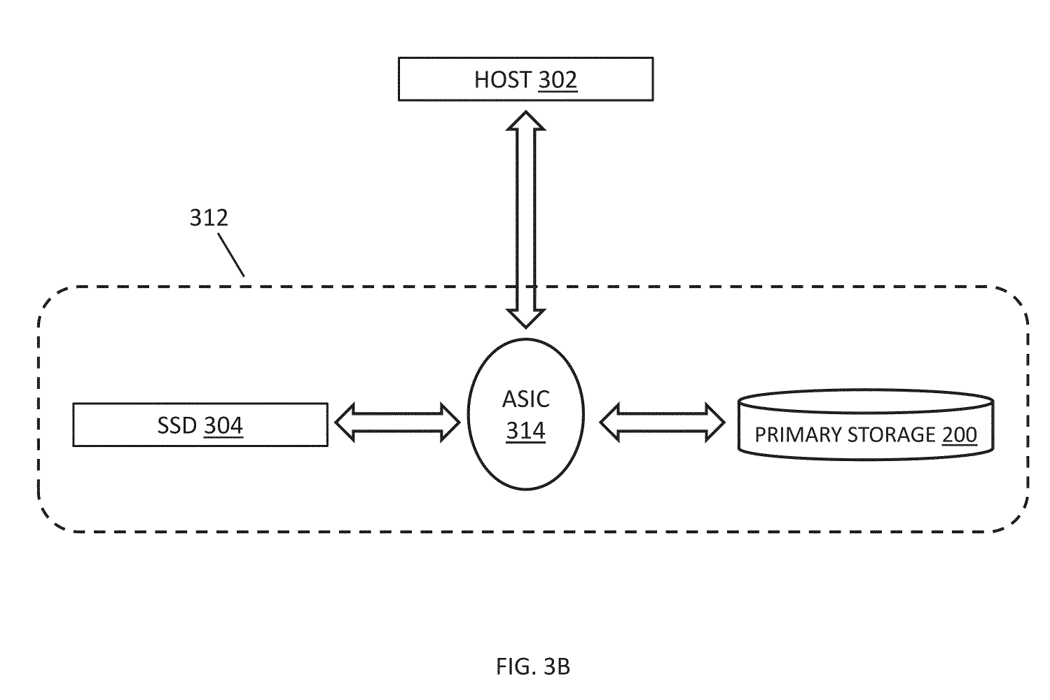

FIG. 3A illustrates a high performance primary storage cache based storage system 300, in accordance with some embodiments of the present disclosure. Some embodiments may provide significant performance improvements over the systems of FIGS. 1 and 2 by intelligently coupling an SSD 304 and primary storage 308 with a high performance GPU/CPU 310 into a high performance primary storage cache based storage system 300. Host computer 302 runs applications and accesses data in primary storage via high performance primary storage cache 300. SSD 304 may be any type of non-volatile memory such as NAND-gate flash, NOR-gate flash, phase change memory (PCM), and the like. Alternatively SSD 304 may be any type of SSD or equivalent storage, such as that which is described herein or generally known. SSD 304 may store read data called reference blocks. A reference block represents baseline data used in identifying, compressing, and decompressing cached data. The reference blocks may be written infrequently during primary storage I/O operations. SSD 304 may also store delta blocks. Delta blocks may contain compressed deltas, each of which may be derived dynamically at run time to represent differences between a data block of an active disk I/O operation and its corresponding reference block. SSD 304 may also store most recently or frequently accessed independent blocks. An independent block represents data that may not exhibit content locality, but may exhibit temporal locality or spatial locality and therefore should be cached. Accordingly, independent blocks may not have a corresponding reference block or delta block. In other words, an independent block is “independent” of other reference blocks and delta blocks based on content locality. Other data types may be stored in SSD as well.

Primary storage 308 includes but is not limited to spinning hard disk drives, non-volatile random access memory (NVRAM), battery backed dynamic random access memory (DRAM), MEMS storage, SAN, NAS, virtual storage, and the like. Primary storage 308 may store deltas in delta blocks. A delta represents differences between a data block of an active disk I/O operation and its corresponding reference block. Delta blocks may be data blocks that contain multiple deltas. A delta may be derived dynamically at run time. The delta may represent a difference between a data block of an active primary storage I/O operation and its corresponding reference block that may be stored in SSD 304. Intelligent processing unit 310 may be any type of computing engine such as a GPU, CPU, or MCU capable of doing computations such as similarity detection, delta derivations upon I/O writes, combining deltas with reference blocks upon I/O reads, data compression and decompression, and other necessary functions for interfacing primary storage 308 with host 302. Although FIG. 3A shows only one SSD 304 and one primary storage module 308, any embodiment may utilize more than one SSD 304 and more than one primary storage module 308.

FIG. 3B illustrates a high performance primary storage cache based storage system 312, in accordance with some embodiments of the present disclosure. FIG. 3B illustrates use of an application specific integrated circuit (ASIC) 314 for the intelligent processing unit, instead of a CPU/GPU to interact with host 302, SSD 304, and primary storage 200. Rather than using a general-purpose intelligent processing unit such as a CPU/GPU, ASIC 314 can be specifically configured for controlling cache functions including similarity detection of data blocks having similar content; block classification of data blocks into reference blocks, corresponding deltas, and/or independent blocks; cache eviction for removing data blocks from cache; and data placement.

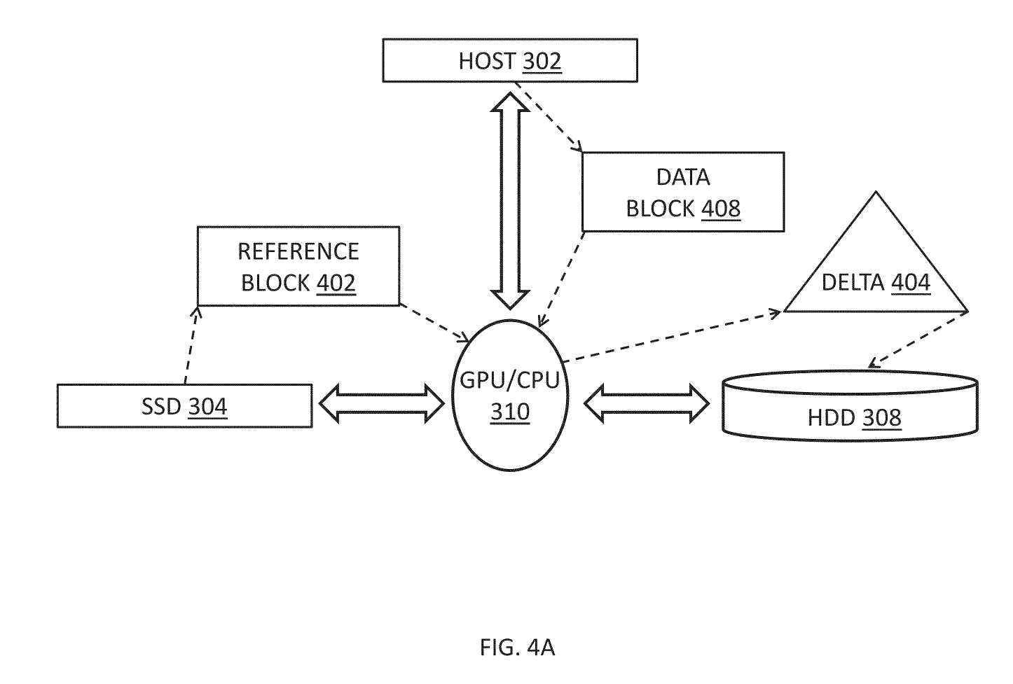

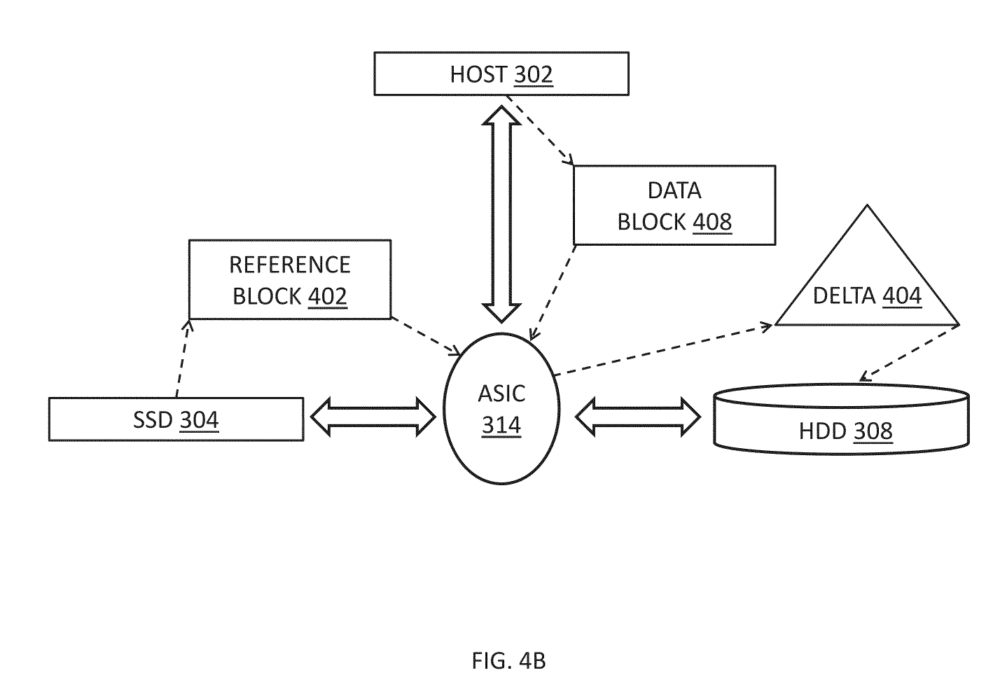

FIG. 4A depicts a block diagram of an example write operation for content locality caching, in accordance with some embodiments of the present disclosure. The write operation by data storage system 300 is in response to an I/O write by host 302. Intelligent processing unit 310 identifies a reference block 402 in SSD 304 and computes a delta 404 with respect to identified reference block 402. The write operation may include host computer 302 issuing a write request to write data block 408 to storage. Intelligent processing unit 310 processes the request and communicates with SSD 304 and primary storage 308 to serve the write operation. Intelligent processing unit 310 first identifies reference block 402 stored in SSD 304 that corresponds to data block 408. Intelligent processing unit 310 derives delta 404 (i.e., the difference between data block 408 and reference block 402) by comparing reference block 402 with data block 408 to be written. The derived delta 404 may be grouped with other previously derived deltas and stored in the primary storage 308 as a delta block. Derived delta 404 may be stored in RAM, SSD, and any other memory suitable for use in cache memory storage system 300.

FIG. 4B illustrates a block diagram of a write operation by content locality based cache system 312, in accordance with some embodiments of the present disclosure. FIG. 4B illustrates use of ASIC 314 to perform the requested write operation by interacting with reference blocks 402, data blocks 408, and deltas 404 as described in connection with FIG. 4A. ASIC 314 can be configured for controlling cache functions including similarity detection, block classification, cache eviction logic, and data placement logic to perform the requested write operation.

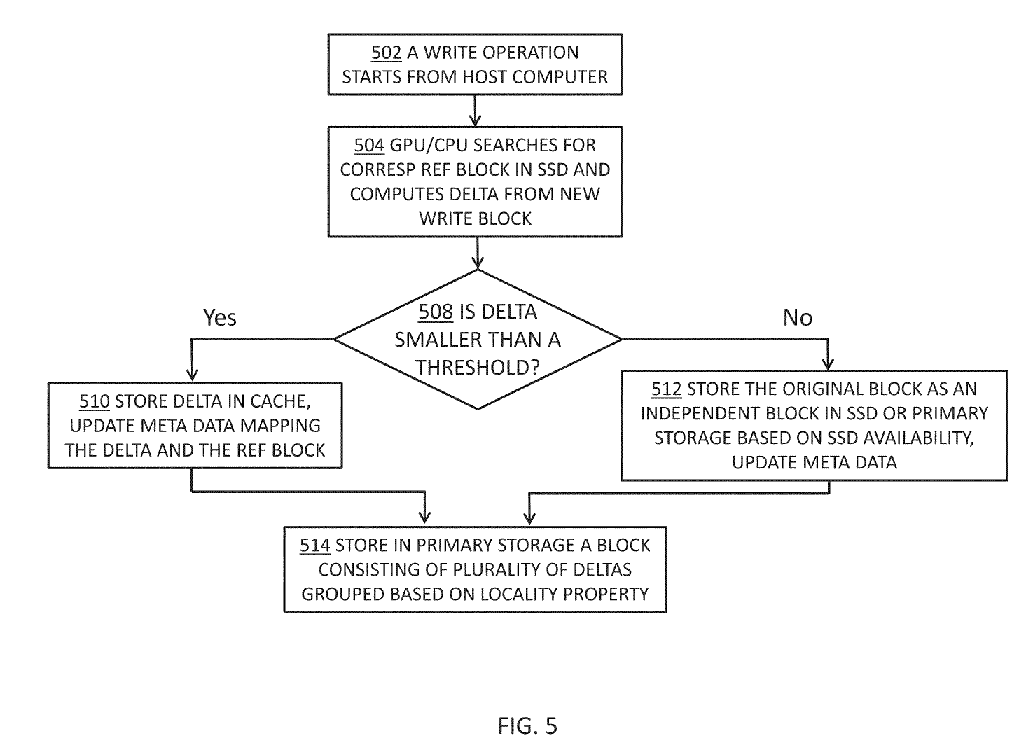

FIG. 5 depicts a high-level logic flowchart of an example write operation by the content locality based cache system, in accordance with some embodiments of the present disclosure. The host starts a write operation (step 502). The intelligent processing unit searches for a corresponding reference block in the SSD and computes a delta with respect to the new data block to be written (step 504). The intelligent processing unit determines whether the derived delta is smaller than a predetermined and configurable threshold value (step 508). If the derived delta is smaller than the threshold value (step 508: Yes), the newly derived delta may be stored in a cache delta buffer, and the metadata mapping the delta and the reference block may be updated (step 510). In some embodiments, the delta buffer may be implemented on a custom ASIC, custom firmware, or other hardware. In other embodiments, the cache delta buffer may be a delta buffer of a GPU/CPU. The intelligent processing unit groups the new delta with previously derived deltas based on a content locality, temporal locality, or spatial locality property in to a delta block. If the newly derived delta is larger than the threshold (step 508: No), the original data block may be identified as an independent block. Metadata may be updated and the independent block may be stored unchanged in the SSD if space permits or in the primary storage if space is not available in the SSD (step 512). When enough deltas are derived to fill a primary storage data block, the generated delta block may be stored in the primary storage (step 514).

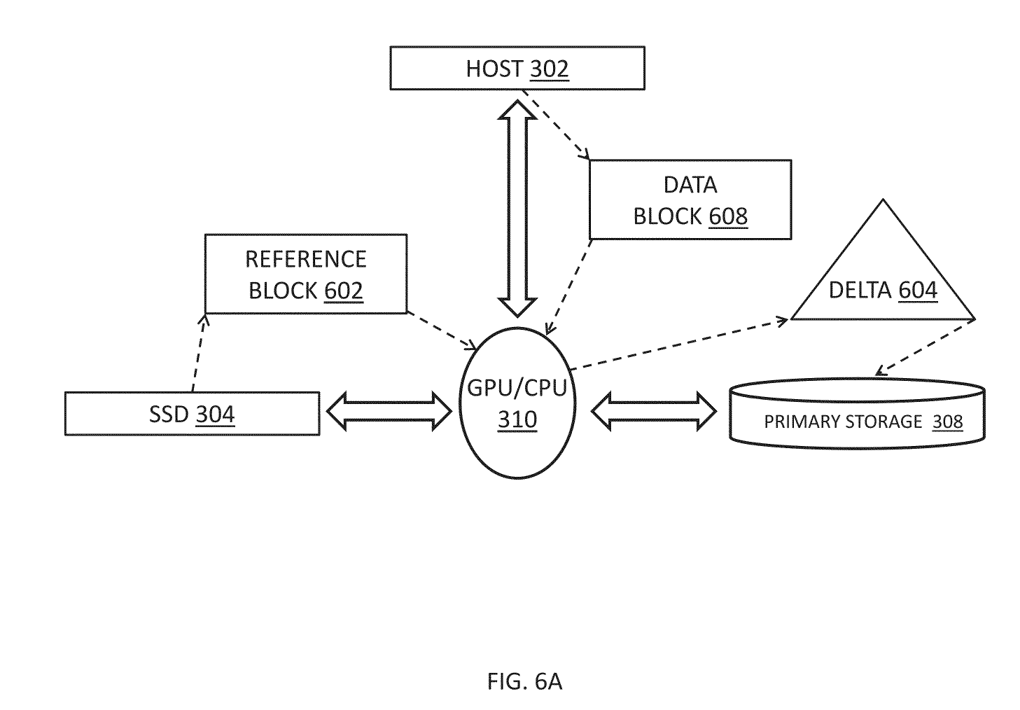

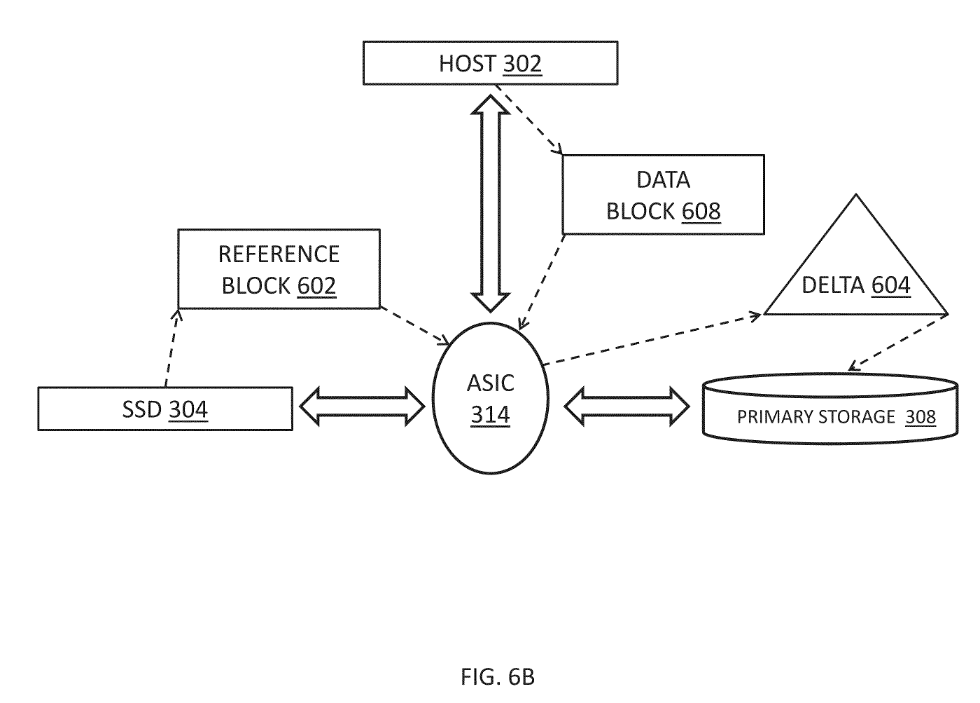

FIG. 6A illustrates example operation of a read request in a content locality based cache, in accordance with some embodiments of the present disclosure. Host computer 302 issues a read request to read data block 608 from storage. In response to this read request, requested data block 608 is returned by combining delta 604 with its corresponding reference block 602 in intelligent processing unit 310. Intelligent processing unit 310 processes the request and communicates with SSD 304 and primary storage 308 (if needed) to service the read operation.

Intelligent processing unit 310 first determines whether requested data block 608 has a corresponding reference block 602 stored in SSD 304. If a corresponding reference block 602 is stored in SSD 304, intelligent processing unit 310 accesses corresponding reference block 602 stored in SSD 304 and reads corresponding delta 608 from either cache or primary storage based on the requested data block metadata that is accessible to intelligent processing unit 310. Intelligent processing unit 310 then combines reference block 602 with delta 604 to obtain the requested contents of data block 608. Intelligent processing unit 310 then returns combined data block 608 to host 302.

FIG. 6B illustrates example operation of a read request in the content locality based cache, in accordance with some embodiments of the present disclosure. FIG. 6B illustrates use of ASIC 314 as an intelligent processing unit instead of a CPU/GPU. ASIC 314 can interact with reference block 602, data block 608, and delta 604 as described in connection with FIG. 6A, to return the requested contents.

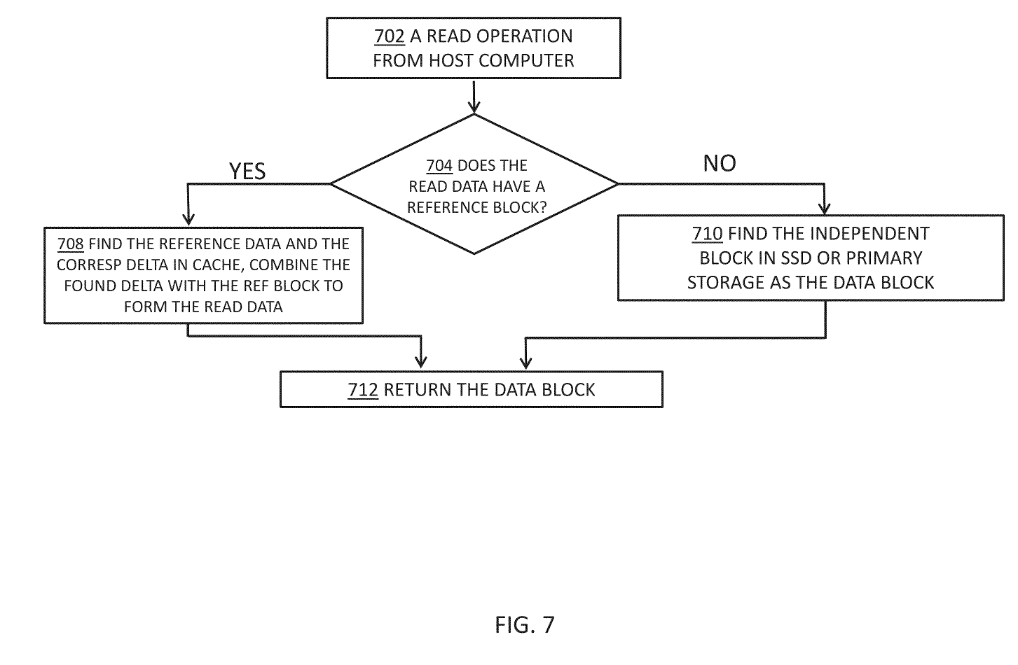

FIG. 7 illustrates a high-level logic flowchart of an example method for read operations, in accordance with some embodiments of the present disclosure. The host may start a read operation (step 702). The intelligent processing unit determines whether or not the requested data block has a reference block (step 704). In some embodiments, the intelligent processing unit may be a custom ASIC or other custom hardware or custom firmware. In other embodiments, the intelligent processing unit may be a GPU/CPU. If the data block has a reference block (step 704: Yes), the intelligent processing unit searches for the corresponding reference block and the corresponding delta block in the cache (step 708). If no corresponding delta is present in the RAM cache of the intelligent processing unit, the intelligent processing unit searches for the corresponding delta in the primary storage. Once both the reference block and the delta are found, the intelligent processing unit combines the reference block and the delta to form the requested data block. If the intelligent processing unit finds that the newly requested data block does not have a corresponding reference block (step 704: No), the intelligent processing unit identifies an independent block in the SSD, the CPU/GPU cache, or the primary storage (step 710) and returns the independent data block to the host (step 712).

Since deltas may generally be small due to data regularity and content locality, some embodiments store deltas in a compact form so that one SSD or HDD operation contains enough deltas to generate tens or even hundreds of I/Os operations. The goal may be to convert the majority of I/O operations from traditional seek-rotation-transfer I/O operations on HDD to I/O operations involving mainly SSD reads and high-speed computations. The former can take tens of milliseconds whereas the latter can take tens of microseconds or even nanoseconds using implementations of the content locality based cache in hardware and/or software. The speedups described herein can represent differences of three to six orders of magnitude in improvements. As a result, the SSD in some embodiments may function as an integral part of a cache memory architecture that takes full advantage of fast SSD read performance while avoiding the drawbacks of SSD erase/write performance. Because of 1) high speed read performance of reference blocks stored in SSDs, 2) potentially large number of small deltas packed in one delta block stored in HDD, and 3) high performance hardware coupling the two, some embodiments greatly improve disk I/O performance.

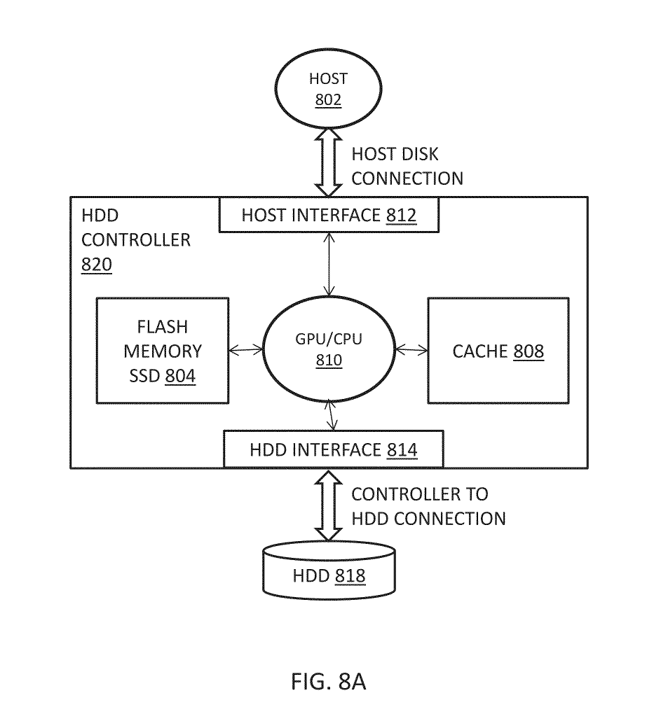

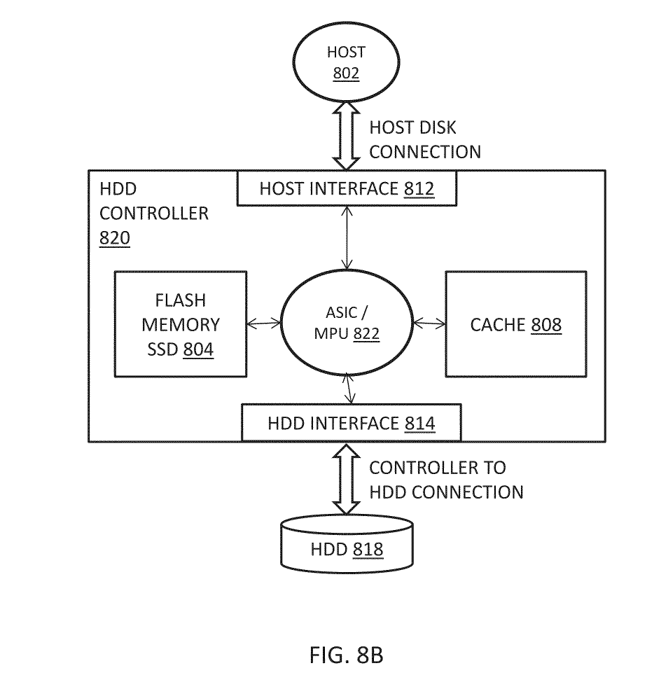

FIG. 8A illustrates a block diagram of an example disk controller 820 for content locality based caching, in accordance with some embodiments of the present disclosure. Some embodiments may be embedded inside disk controller 820. Disk controller 820 may include a disk controller board adapted to include NAND-gate flash SSD 804 or similar device, GPU/CPU 810, and DRAM buffer 808 in addition to existing disk control hardware and interfaces such as the host bus adapter (HBA). Host 802 may be connected to disk controller 820 using a standard interface 812. Such an interface can be SCSI, SATA, SAS, PATA, iSCSI, FC, or the like. Flash memory 804 may be an SSD, such as to store reference blocks, delta blocks, independent blocks, and similar data. Intelligent processing unit 810 performs logical operations such as delta derivation, similarity detection, combining delta with reference blocks, managing reference blocks, managing metadata, and other operations described herein or known for maximizing SSD-based caching. RAM cache 808 may temporarily store reference blocks, deltas, and independent blocks for active I/O operations. The HDD controller 820 may be connected to the HDD 818 by known means through the interface 814.

FIG. 8B illustrates a block diagram of an example disk controller 820 for content locality based caching, in accordance with some embodiments of the present disclosure. Disk controller 820 includes application-specific integrated circuit/microprocessor unit (ASIC/MPU) 822, flash memory 804, cache 808, host interface 812, and HDD interface 814.

FIG. 8B illustrates example structures of a design for content locality based caching, in accordance with some embodiments of the present disclosure. Disk controller 820 includes an example structure implementing the cache on a disk or hybrid disk controller. ASIC/MPU 822 can control cache functions including similarity detection, block classification, cache eviction, and data placement. Flash memory 804 can provide primary storage. In some embodiments, flash memory 804 can include phase change memory (PCM), or magnetoresistive random access memory (MRAM). Cache 808 can include a high speed buffer to store temporary metadata, lookup tables, and intermediate storage as a working space. In some embodiments, cache 808 can be a random access memory (RAM) block.

Examples of basic operations of cache 808 are described below for two types of operations: (1) read I/O and (2) write I/O.

Disk controller 820 can receive a read I/O requesting the contents of a block. For example, disk controller 820 can receive the read I/O from host 802 via host interface 812. The content locality based cache can check to see if the requested block is in cache 808. If there is a cache hit, disk controller 820 can return the requested contents immediately. If the block is an associated block (i.e., if the block is able to be represented by a reference block and a delta block), disk controller 820 can perform decompression to recreate the requested contents. If there is a cache miss, disk controller 820 can initiate a read operation from primary storage to load the requested data from primary storage. In some embodiments, primary storage can be a hard disk drive (HDD) or storage attached network (SAN). When disk controller 820 loads data to the cache and returns the requested content to the host, disk controller 820 can perform fingerprint computation and similarity detection in parallel, to classify the missed block. If the missed block is determined to be similar enough to a reference block, disk controller 820 can perform data compression. Disk controller 820 can write the requested block to cache 808 according to its type: e.g., reference block, associated block (i.e., delta block), or independent block.

Upon a write I/O, disk controller 820 can perform fingerprint computation and similarity detection. If disk controller 820 identifies a reference block based on the fingerprint computation and similarity detection, disk controller 820 can perform data compression. Depending on whether the write request represents a cache hit or miss and where in the cache the requested block hits, disk controller 820 can perform cache operations similar to the read I/O operations described above. If cache 808 operates as a write-through cache, the data block can be directly written to HDD in parallel to all cache operations such as fingerprint computation and similarity detection. If cache 808 operates as a write-back cache, disk controller 820 can write the data block as dirty data in cache 808 only. Disk controller 820 can later write the dirty data to HDD using write algorithms including pre-cleaning, on-demand destaging, or FIFO flushing. If peer to peer caches are implemented for high availability (HA), disk controller 820 can perform data mirroring after compression to selected peer caches. In some embodiments, disk controller 820 can perform data mirroring using a cache coherence protocol including a sliding window of eager execution transactions (SWEET). Further information regarding the SWEET cache coherence protocol may be found in U.S. Pat. No. 8,140,772, entitled “System and method for maintaining redundant storages coherent using sliding windows of eager execution transactions” and filed Oct. 31, 2008, the entire contents of which are incorporated by reference herein.

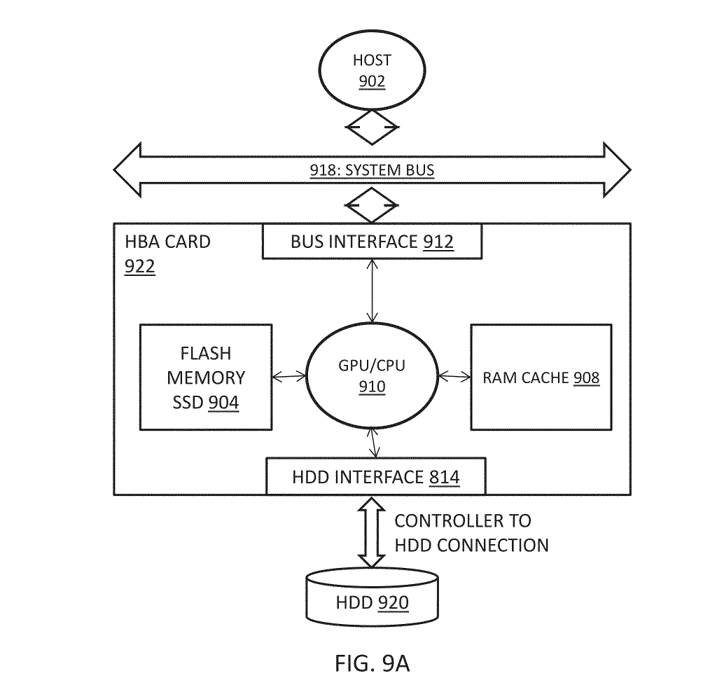

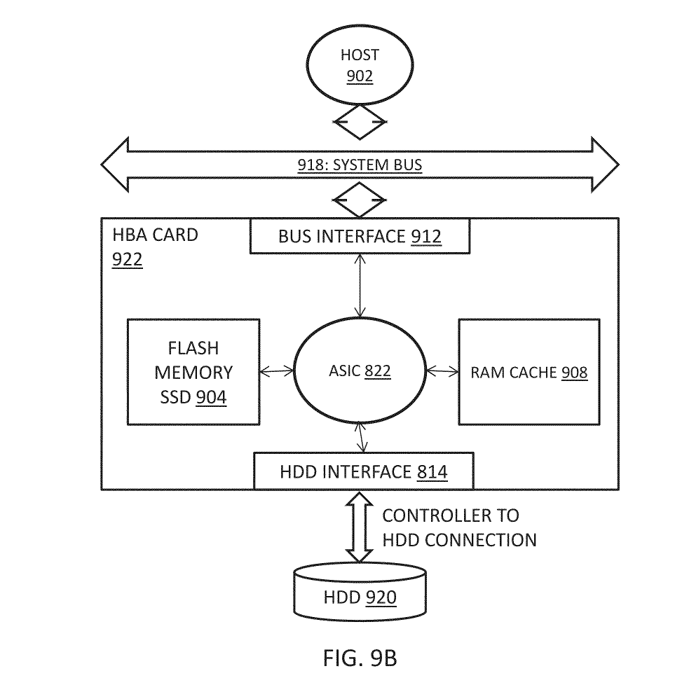

FIG. 9A illustrates an example block diagram of host bus adaptor (HBA) 922 for content locality based caching, in accordance with some embodiments of the present disclosure. HBA card 922 may include flash SSD 904, intelligent processing unit 910, and cache 908. In some embodiments, cache 908 may be a DRAM buffer to an existing HBA, such as SCSI, IDE, SATA card, or the like. HBA card 922 may include NAND-gate flash SSD 904 or other SSD, intelligent processing unit 910 (e.g., a GPU/CPU), and cache 908 added to existing HBA control logic. In some embodiments, cache 908 may be a small DRAM buffer. Host 902 may be connected to system bus 918. HBA card 922 may also include bus interface 912 and HDD interface 814. Bus interface 912 allows HBA card 922 to be connected to system bus 918. In some embodiments, system bus 918 may be PCI, PCI-Express, PCI-X, HyperTransport, InfiniBand, and the like. Flash memory 904 may be an SSD for storing reference blocks and other data. Intelligent processing unit 910 may perform processing functions such as delta derivation, similarity detection, combining delta with reference blocks, managing reference blocks, executing cache management functions described herein, and managing metadata. RAM cache 908 may temporarily store reference blocks, deltas, and independent blocks for active I/O operations. In some embodiments, HBA card 922 may be connected to HDD 920 through HDD interface 914 using a suitable protocol such as SCSI, SATA, SAS, PATA, iSCSI, or FC.

FIG. 9B illustrates an example block diagram of host bus adaptor (HBA) 922 for content locality based caching, in accordance with some embodiments of the present disclosure. FIG. 9B illustrates that HBA card 922 can work as a host bus adaptor interfacing directly to system bus 918 and controlling attached HDD 920. For example, HBA card 922 can use a hardware-based implementation such as ASIC 822 or firmware. ASIC 822 can control cache functions including similarity detection, block classification, cache eviction logic, and data placement logic.

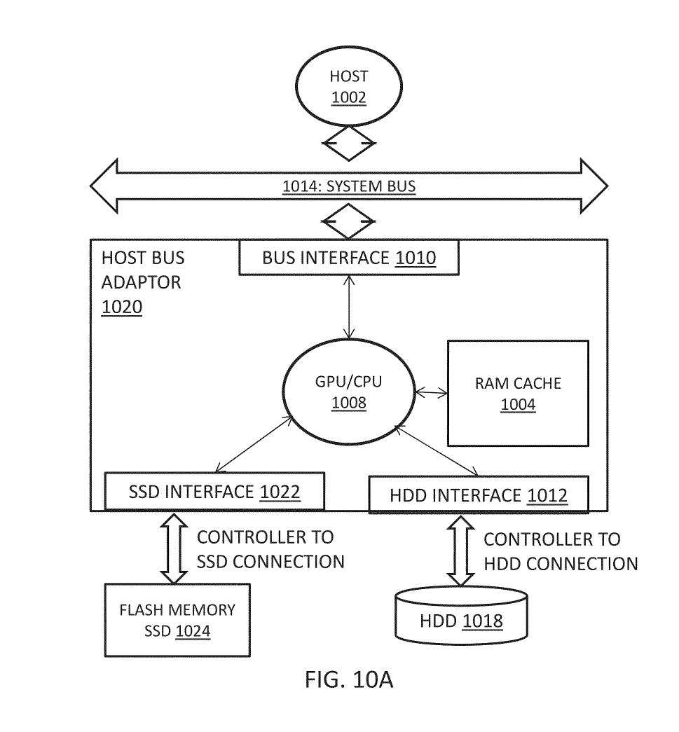

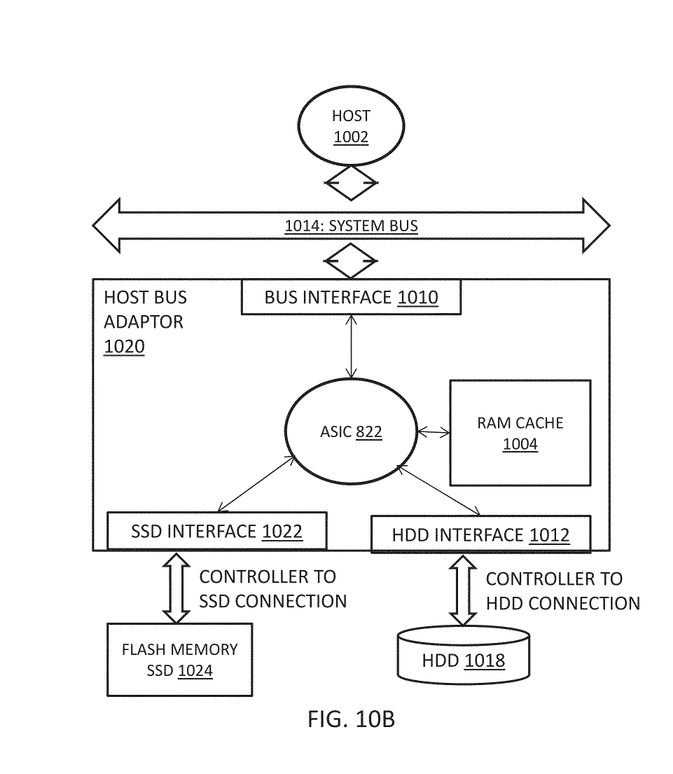

FIG. 10A illustrates an example block diagram of host bus adaptor (HBA) 1020 for content locality based caching, in accordance with some embodiments of the present disclosure. In some embodiments, HBA 1020 may include no onboard flash memory. Instead, external flash memory 1024 such as PCIe SSD, SAS SSD, SATA SSD, SCSI SSD, or other SSD drive may be used similarly to an onboard SSD. HBA 1020 includes intelligent processing unit 1008 and DRAM buffer 1004, in communication with existing HBA control logic and interfaces. Host 1002 may be connected to system bus 1014. In some embodiments, system bus 1014 may be PCI, PCI-Express, PCI-X, HyperTransport, or InfiniBand. HBA 1020 includes bus interface 1010, SSD interface 1022, and HDD interface 1012. Bus interface 1010 allows HBA card 1020 to be connected to system bus 1014. Intelligent processing unit 1008 performs processing functions such as delta derivation, similarity detection, combining delta with reference blocks, managing reference blocks, executing cache algorithms that are described herein, managing metadata, and the like. RAM cache 1004 temporarily stores deltas for active I/O operations. External SSD 1024 may be connected by SSD interface 1022 to HBA card 1020 for storage of reference blocks and other data.

FIG. 10B illustrates an example block diagram of host bus adaptor (HBA) 1020 for content locality based caching, in accordance with some embodiments of the present disclosure. Instead of HBA card 1020 including an on board memory, HBA card 1020 may instead be a lighter version with external flash memory 1024. External flash memory 1024 may be an external device connected to HBA card 1020. While the block diagrams illustrated in FIGS. 8B, 9B, 10B perform different external functionalities, some embodiments may implement the internal structure in a similar fashion.

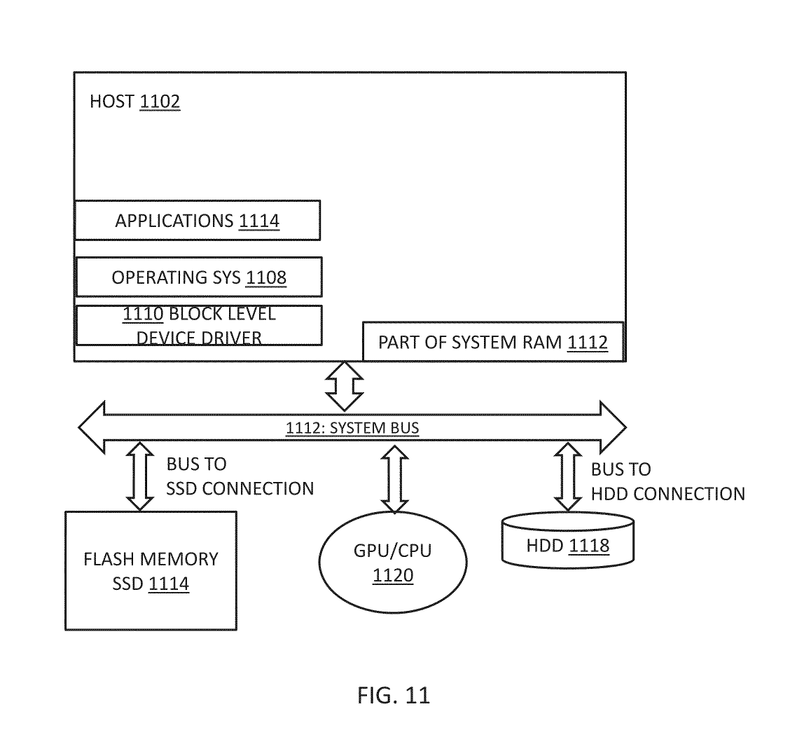

FIG. 11 depicts an example block diagram of a software-based implementation of content locality based caching, in accordance with some embodiments of the present disclosure. Some embodiments include a software approach using commodity off-the-shelf hardware. For example, device driver program 1110 may control separate flash memory 1114, intelligent processing unit 1120, and HDD 1118 connected to system bus 1112. In some embodiments, intelligent processing unit 1120 may include a GPU/CPU embedded controller card. These embodiments leverage standard off-the-shelf hardware such as SSD drive 1114, HDD 1118, and embedded controller/GPU/CPU/MCU card 1120. These standard hardware components may be connected to system bus 1122, such as PCI, PCI-Express, PCI-X, HyperTransport, InfiniBand, and the like. The software for this fourth implementation may be divided into two parts: one part running on host 1102 and another part running on embedded system 1120. One possible partition of software between the host and the embedded system may be to have device driver program 1110 capable of block level operation running on host 1102 that performs metadata management while interfacing with upper layer software (e.g., operating system 1108 or application 1104), and the remaining software functions running on the embedded system 1120. The software functions can be scheduled between host 1102 and the embedded system 1120 so as to balance the loads of embedded system 1120 and host 1102 by taking into account all workload demand of OS 1108, databases and applications 1104, etc., running on host 1102. For example, embedded system 1120 may perform computation-intensive functions such as similarity detections, compression/decompression, and hashing functions. Embedded system 1120 can off-load many functions from host 1102 to reduce the computation burden on host 1102. A part of system RAM 1112 may be used to cache reference blocks, deltas, and other hot data for efficient I/O operations and may be accessible to software modules that support these embodiments.

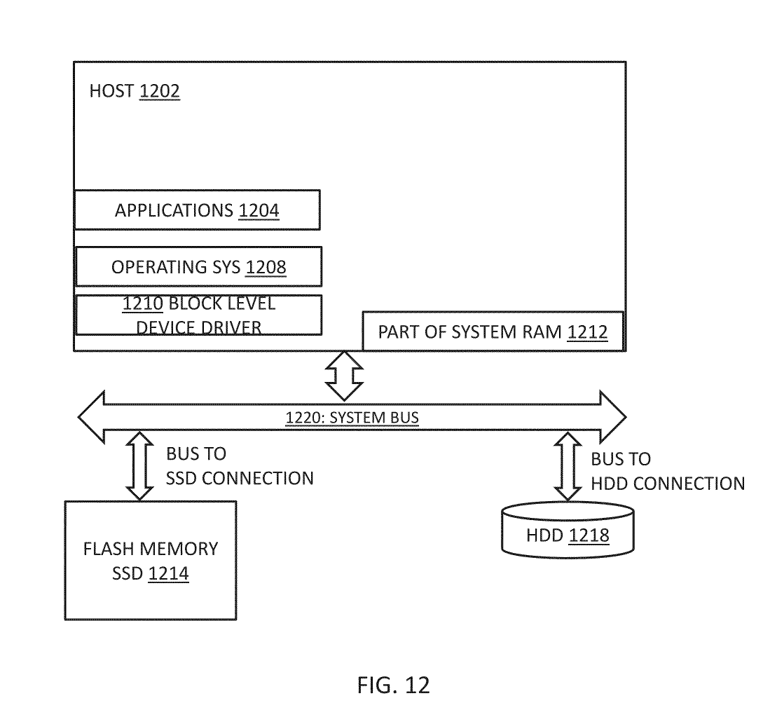

FIG. 12 depicts another example block diagram of a software-based implementation of content locality based caching, in accordance with some embodiments of the present disclosure. In some embodiments, a software module runs entirely on the host computer. The software solution uses a part of system RAM 1212 as the DRAM buffer, but otherwise assumes no additional hardware except for any type of off-the-shelf flash memory 1214 and HDD 1218.

Software module 1210 runs at the device driver level such as a generic block layer, a filter driver layer, or any layer in the I/O stack. Software module 1210 controls an independent flash memory 1214 and independent HDD 1218 that may be connected to system bus 1220. Software module 1210 interfaces over system bus 1220 with standard off-the-shelf hardware for flash memory 1214 and HDD 1218. System bus 1220 includes but is not limited to protocols such as PCI, PCI-Express, PCI-X, HyperTransport, InfiniBand, SAS, SATA, SCSI, PATA, USB, etc. Software module 1210 runs on host 1202. Software module 1210 operates and communicates directly with flash memory 1214 and HDD 1218. Software module 1210 also controls part of system RAM 1212 as a cache to buffer reference blocks, deltas, and independent blocks for efficient I/O operations. Software module 1210 also interfaces and communicates with upper layer software modules such as OS 1208 and applications 1204 running on host 1202.

In some embodiments, software module 1210 may be implemented without requiring hardware changes, but may use system resources such as CPU, RAM, and system bus. For I/O bound jobs, CPU utilization may be very low and the additional overhead caused by the software expected to be small. This is particularly evident as processing power of CPUs may increase more rapidly than I/O systems. In addition, software implementations may require different designs and implementations for different operating systems.

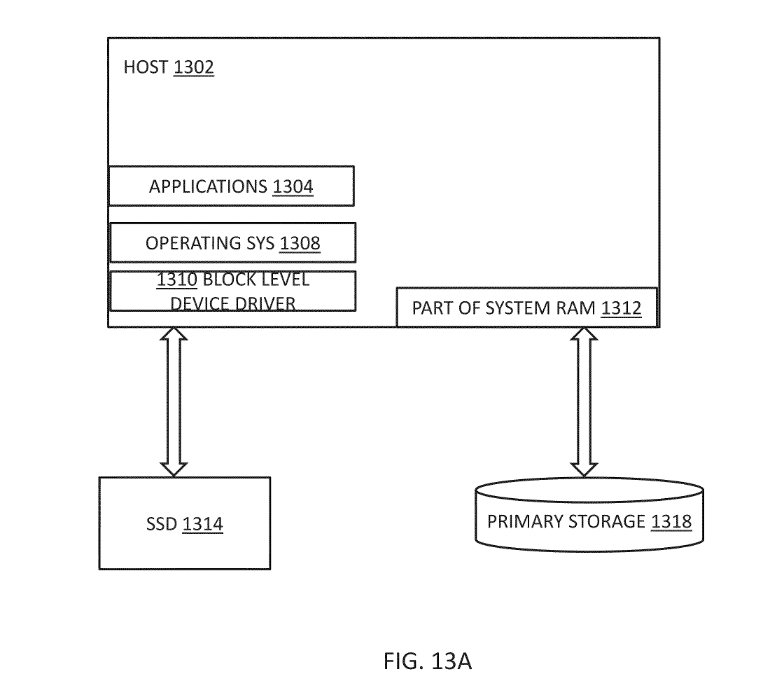

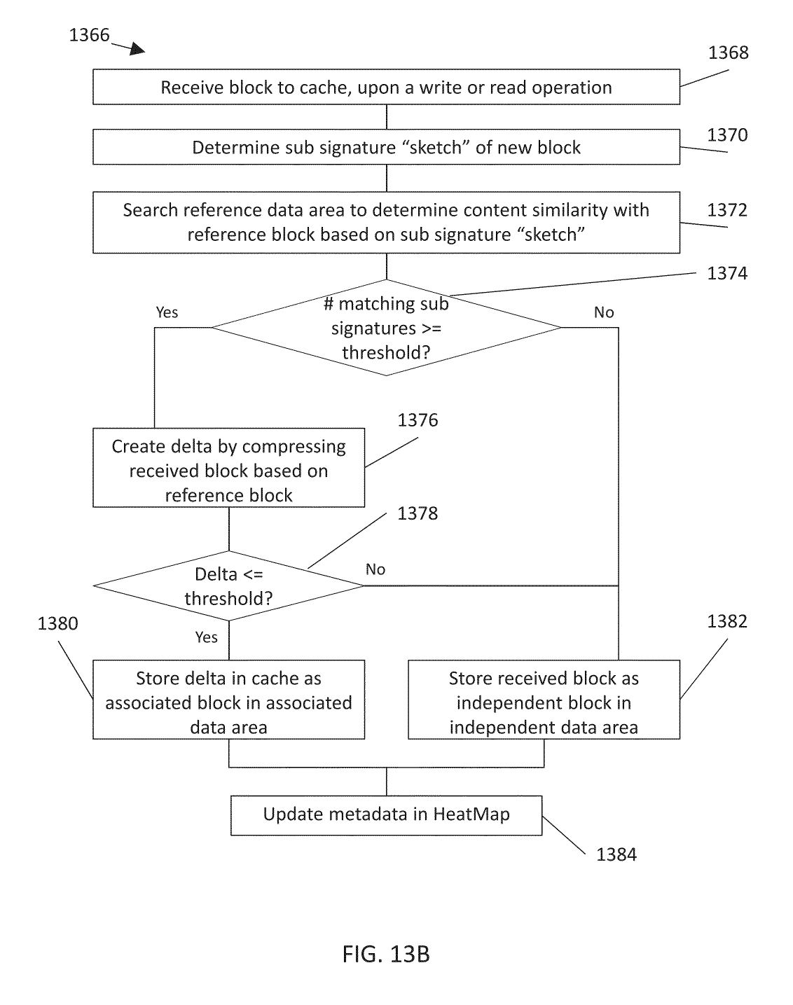

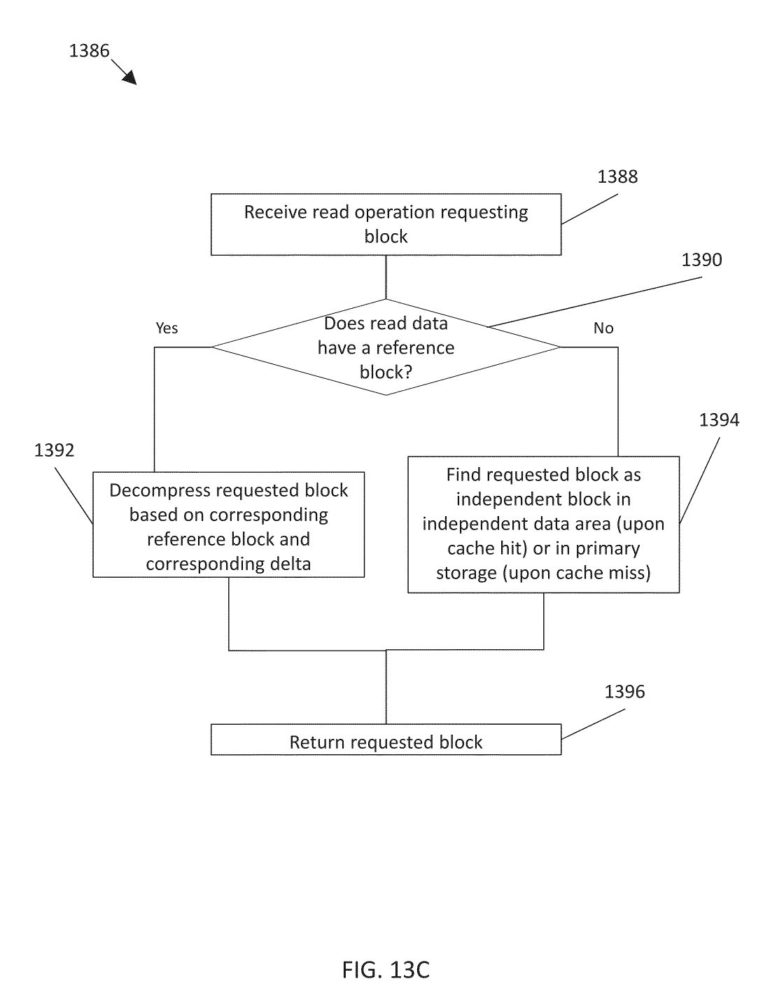

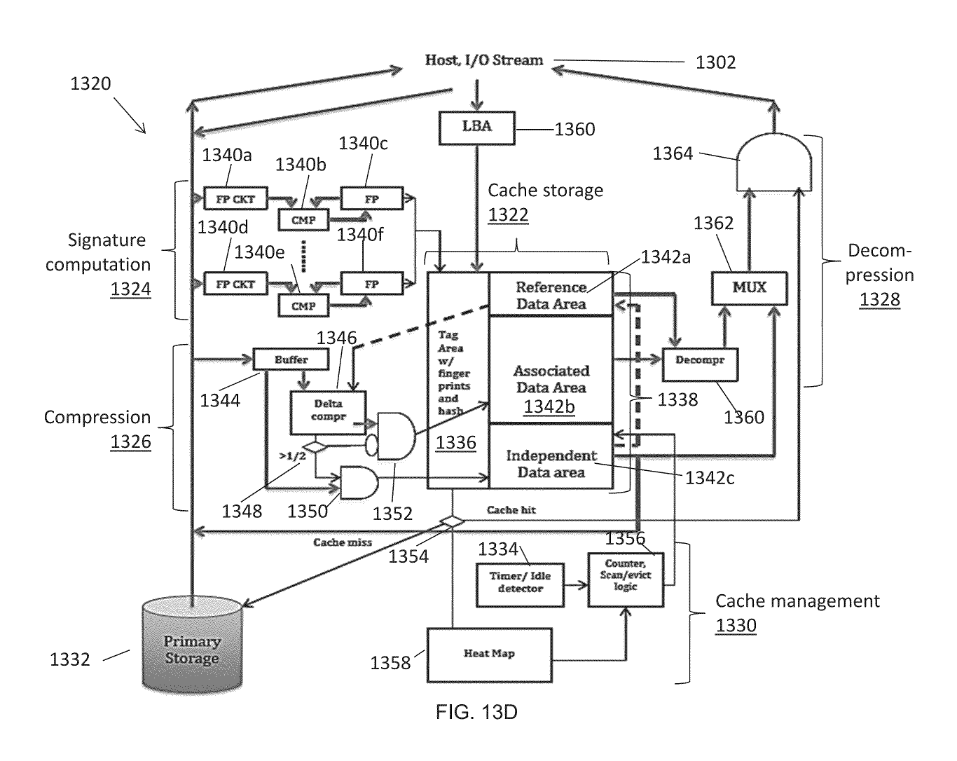

FIG. 13A depicts another example block diagram of a software-based implementation of content locality based caching, in accordance with some embodiments of the present disclosure. Software module 1310 may run entirely on host 1302. However, software module 1310 uses a part of system RAM 1312 as a DRAM buffer, and optionally uses off-the-shelf SSD 1314 if one is present. Software module 1310 may provide performance increases to accessing data stored in primary storage 1318. Furthermore, software module 1310 makes no changes to data stored on primary storage 1318. Software module 1310 runs at the device driver level such as a generic block layer, a filter driver layer, or any layer in the I/O stack. Software module 1310 controls part of host RAM 1312 and an optional SSD 1314 to buffer reference blocks, deltas, and independent blocks for efficient operations on primary storage 1318. Software module 1310 also interfaces and communicates with upper layer software modules such as OS 1308 and applications 1304 running on host 1302.

FIG. 13B illustrates an example method 1366 for caching a block in the content locality cache, in accordance with some embodiments of the present disclosure. Method 1366 can include receiving a block to cache (step 1368); determining a sub-signature “sketch” of the received block (step 1370); searching a reference data area of the content locality cache to determine similarity with a potential reference block (step 1372); determining whether the number of matching sub-signatures exceeds a threshold (step 1374); if the number of matching sub-signatures exceeds a threshold, creating a delta by compressing the received block based on an identified reference block (step 1376); determining the delta is less than a threshold (step 1378); if the delta is less than a threshold, storing the delta in the content locality cache as an associated block (step 1380); if the delta is greater than or equal to a threshold or if the number of matching sub-signature is less than a threshold, storing the received block as an independent block (step 1382); and updating metadata of the received block in a HeatMap (step 1384).

Receiving a block to cache (step 1368) can include receiving a block from a write operation or a read operation from the host. For example, a write I/O operation can include new contents for storing a new block in the content locality cache or updating an existing block in the cache. The content locality cache can also receive the block as a result of a read I/O operation, for example upon a cache miss. A cache miss can occur when a requested block for reading is not found in the cache. The content locality cache can retrieve the requested block from primary storage, return the requested contents to the host, and cache the retrieved block. Accordingly, upon a subsequent read operation requesting the contents of the same block, the subsequent read operation can result in a cache hit that speeds performance because the content locality cache is able to avoid reading the requested contents from the relatively slower primary storage.

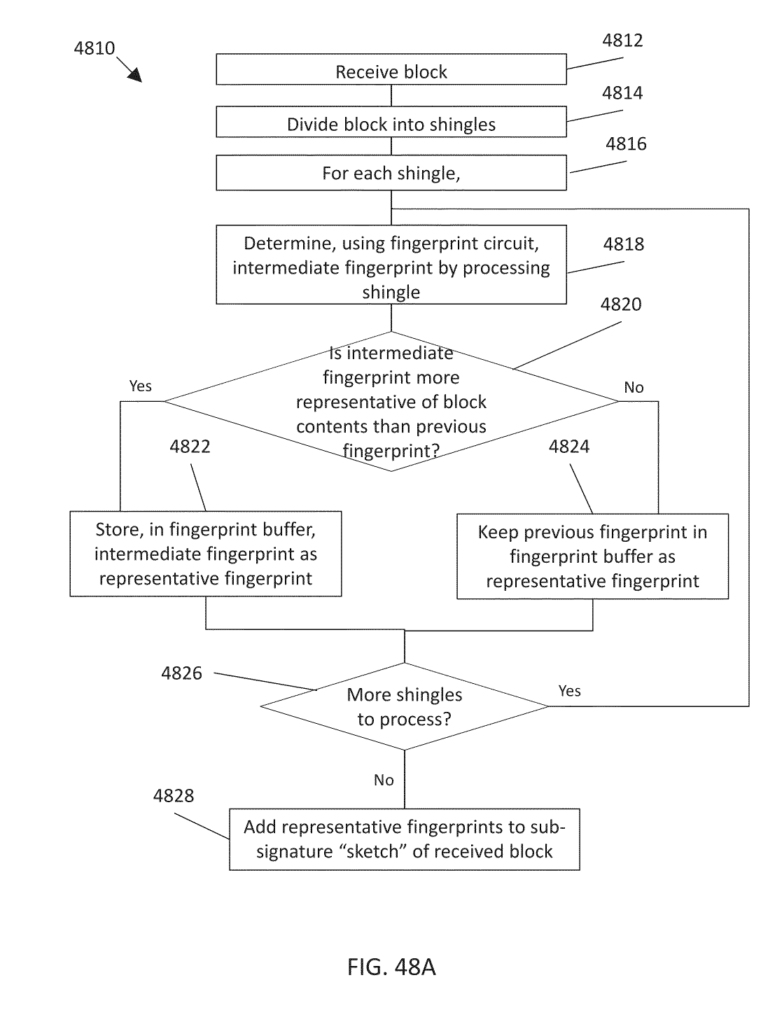

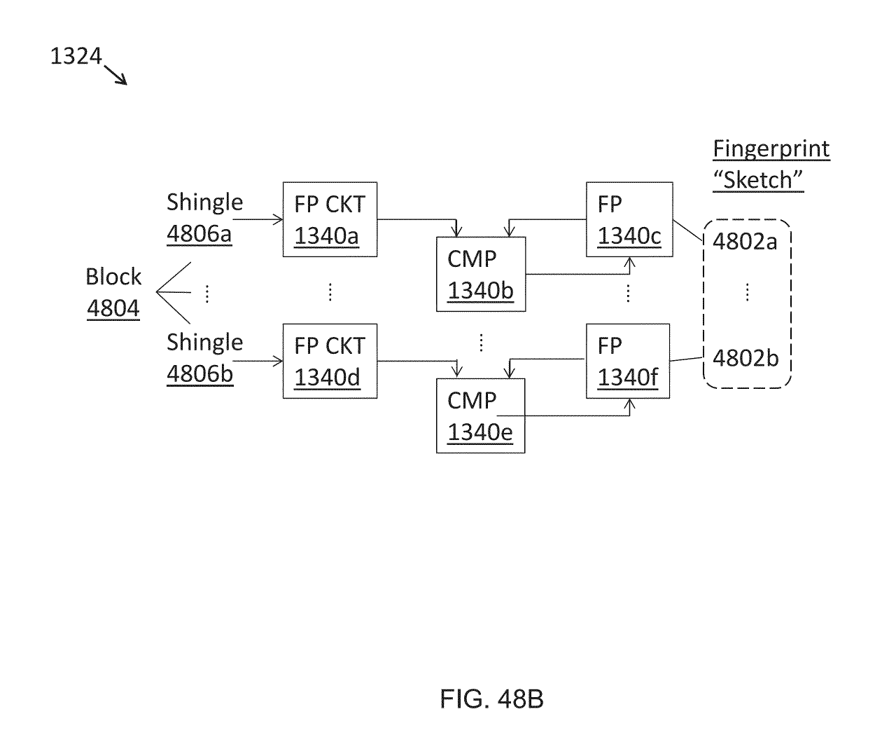

Determining a sub-signature “sketch” of the received block (step 1370) can include determining multiple signatures, sometimes referred to herein as “fingerprints,” of a block. The fingerprints can represent the contents of the received block. The fingerprints can speed detection of content similarity among blocks by providing relatively smaller units that are easier to compare algorithmically because the units are discrete. In some embodiments, the content locality cache can divide the received block into subsets, sometimes referred to herein as “shingles.” A shingle can be a subset of an overall block. For example, the size of the received block can be 4 KB, and the corresponding size of the shingle can be 8 bytes. (Accordingly, for an example block of size 4 KB, there can be 4K-7 shingles corresponding to various subsets of the block.) In some embodiments, fingerprint circuits, also referred to herein as signature computation circuits, can process shingles in parallel to identify multiple representative fingerprints or signatures of a shingle. In some embodiments, the fingerprint circuits can process the shingles using Mersenne primes, Rabin fingerprinting, or random irreducible polynomials (shown in FIGS. 48A-52B). In some embodiments, the fingerprint circuits can use intermediate fingerprints while identifying fingerprints that are representative of the contents of the block.

Method 1366 can include searching a reference data area of the content locality cache to determine content similarity of the received block, based on the sub-signature “sketch” (step 1372). For example, the content similarity can be determined by comparing sketches stored in a tag area of the content locality cache. If the number of matching sub-signatures in the sketch exceeds a threshold (step 1374: Yes), the received block can be determined to have similar content to a reference block already in the content locality cache. Accordingly, the content locality cache can create a “delta” that represents a compressed version of the received block (step 1376). The content locality cache can compare the delta with reference blocks to determine similarity. For example, if the delta is determined to differ by more than a threshold (step 1378: No), then the new data block can be characterized as an independent data block (step 1382). An example threshold can be if the delta is determined to differ by over ½ with the reference block. An independent data block refers to a block that can be cached, but the caching can be determined based on most recent use (e.g., temporal locality) or similarity of memory address (e.g., spatial locality), rather than similarity of content (e.g., content locality). Similarly, if the number of matching sub-signatures in the “sketch” is determined to be less than the threshold (step 1374: No), then the new data block can also be characterized as an independent data block (step 1382).

Updating metadata in the HeatMap (step 1384) can include, for example, updating measures of “popularity” of the received block. The popularity measure can measure an extent to which the contents of the received block are shared by other active data blocks in the content locality cache.

FIG. 13C illustrates an example method 1386 for reading a cached block from the content locality cache, in accordance with some embodiments of the present disclosure. Method 1386 includes receiving a read I/O operation that requests a block (step 1388); determining whether the requested block has a reference block (step 1390); if the requested block has a reference block, decompressing the requested block based on the corresponding reference block and a corresponding delta (step 1392); if the requested block does not have a reference block, finding the requested block as an independent block or in primary storage (step 1394); and returning the requested block (step 1396).

Method 1386 can receive a read I/O operation requesting the contents of a block (step 1388). For example, the host can send the read I/O operation to the content locality cache. Method 1386 can determine whether the requested block has a corresponding reference block (step 1390). For example, the content locality cache can compare metadata associated with the requested block with metadata associated with the cached reference blocks, associated blocks, and independent data blocks to determine whether the requested block has a corresponding reference block.

If the requested block has a corresponding reference block (step 1390: Yes), method 1386 can include decompressing the contents of the requested block based on the corresponding block and a corresponding delta (step 1392). For example, the content locality cache can determine the corresponding delta by retrieving an associated block storing the delta from an associated block area of the content locality cache. In some embodiments, method 1386 can include recreating requested content for the received block by starting from the corresponding associated block and incorporating shingles of the corresponding reference block.

If the requested block does not have a corresponding reference block (step 1390: No), method 1386 can include finding the requested block either as an independent block or in primary storage (step 1394). In some embodiments, finding the requested block can include determining whether there is a cache hit or a cache miss. Upon a cache hit, method 1386 can determine that the requested block has a corresponding independent block because step 1390: No indicates the requested block lacks a reference block. For example, method 1386 can determine that the requested block has a corresponding independent block by comparing metadata of the requested block with metadata of the independent blocks. Upon a cache miss, method 1386 can determine that the requested block can be found in primary storage, because the cache miss can indicate that the requested block may not be found in the content locality cache, either as a reference block, associated block, or independent block.

Method 1386 can proceed to return the contents of the requested block to the host (step 1396) and fulfill the received read I/O operation.

FIG. 13D illustrates an example structure 1320 of the content locality based cache, in accordance with some embodiments of the present disclosure. Structure 1320 can include cache storage 1322, content signature computation circuit 1324, compression circuit 1326, decompression circuit 1328, and cache management circuit 1330 in communication with primary storage 1332.

Host 1302 can receive an I/O operation such as a read or write I/O. The received I/O can include a memory address such as a logical block address (LBA) 1360 for storage into cache storage 1322. Cache storage 1322 can include data array 1338 and tag array 1336 associated with the cache. Signature computation circuit 1324 can perform fingerprint computations and comparisons for use in reference block identification and delta block compression. Compression circuit 1326 can perform delta compression for write I/Os and cache misses. Decompression circuit 1328 can perform data decompression for read I/Os that result in cache hits in associated blocks (whereby structure 1320 combines reference blocks with delta blocks to recreate requested data block contents). Cache management circuit 1330 can perform background flushing, replacement algorithms, and periodic scanning for classification of blocks.

Signature computation circuit 1324 can include fingerprint circuits 1340a, 1340d, comparators 1340b, 1340e, and fingerprint buffers 1340c, 1340f to store resulting fingerprints. Signature computation circuit 1324 can compute a fingerprint for each shingle of a predefined size on a data block. A shingle can represent a window, or subset, of a data block for content analysis to determine content similarity. A fingerprint can represent a content signature of a data block or a content signature of a subset of a data block. For example, a shingle can represent a window, or subset, of a data block, where the window is shifted one byte at a time to determine a relevant subset of a data block for analysis. If an example shingle size is 8 bytes and block size is 4 KB, then signature computation circuit 1324 can compute 4K-7 fingerprints using various iterations. Among the computed fingerprints, structure 1320 can select a certain number of fingerprints to represent a “sketch” of a data block. For example, signature computation circuit 1324 can store about six to eight selected fingerprints in fingerprint buffers 1340c, 1340f, or any other number, for representing an overview of the content of a data block. Signature computation circuit 1324 can compute intermediate fingerprints in the process of selecting the overall sketch of the data block.

Fingerprint circuits 1340a, 1340d can perform the intermediate computations to determine the intermediate fingerprints. In some embodiments, fingerprint circuits 1340a, 1340d can use Mersenne primes, Rabin fingerprinting, random irreducible polynomials, or other processes that can provide an overview of content of a shingle of a data block, or of a data block generally. In some embodiments, comparators 1340b, 1340e can store intermediate fingerprints for comparing against a current maximum or minimum fingerprints stored in fingerprint buffers 1340c, 1340f. If an intermediate fingerprint computed by fingerprint circuits 1340a, 1340d is determined to be greater or lower than a current maximum or current minimum fingerprint stored in fingerprint buffers 1340c, 1340f, then comparators 1340b, 1340e can replace the contents of fingerprint buffers 1340c, 1340f with the new maximum or minimum fingerprint. Structure 1320 can use the fingerprints and sketch to perform similarity detection among data blocks, by comparing respective sketches or groups of fingerprints.

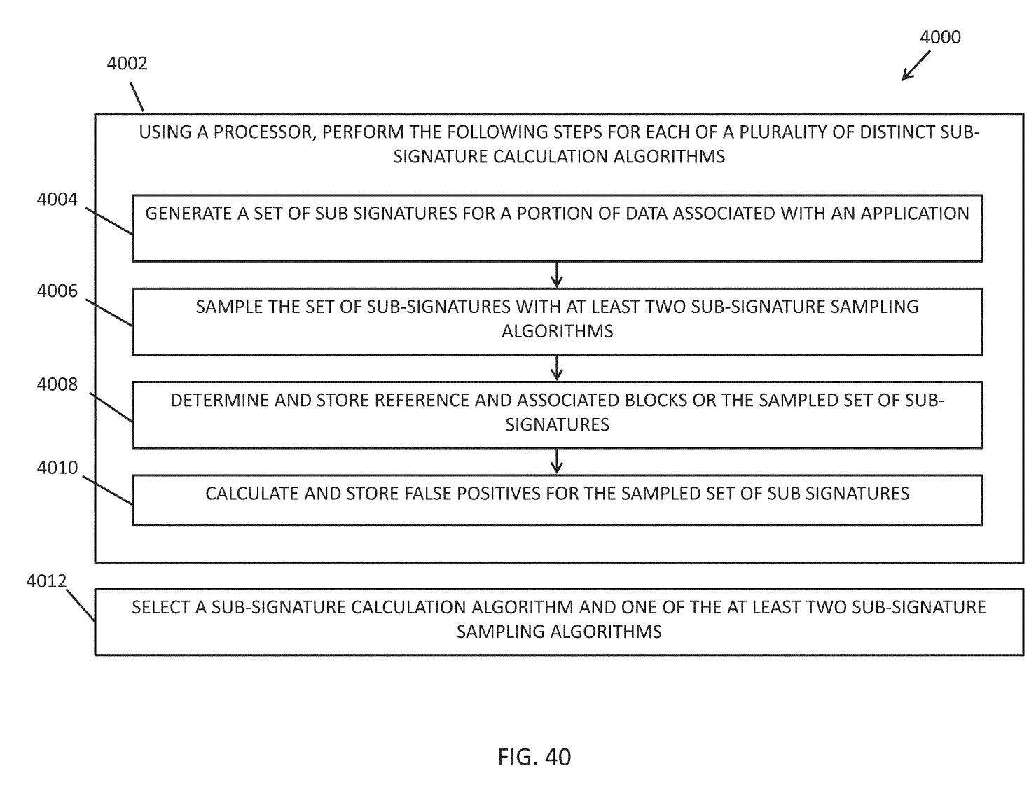

Signature computation circuit 1324 can include several different processes implemented in hardware, software, or a combination for fingerprint calculation and sampling (shown in FIGS. 40-47). The fingerprint calculation and sampling processes exhibit advantages and disadvantages in terms of computation cost, overhead, accuracy of similarity detection, and amount of false positive detections. The fingerprint calculation and sampling can vary with different I/O workloads and application characteristics. For structure 1320, computation cost and overhead can be quite different if implemented in hardware, and the present disclosure includes several design options and alternatives herein.

Cache storage 1322 can include the actual memory cells used to store cached data associated with requested blocks in the SSD cache. In some embodiments, the memory cells can include flash memory cells, PCM memory cells, or MRAM cells. Cache storage 1322 can be divided into two parts: tag array 1336 and data array 1338. Tag array 1336 can store logical block addresses (LBAs), fingerprints, and status information corresponding to each cached data block. In some embodiments, the LBA and fingerprint portions of tag array 1336 can be implemented using content addressable memory (CAM), so that structure 1320 can perform associative search upon each access. For example, upon an I/O operation, structure 1320 can search the cache associatively in tag array 1336 to find a match based on the LBA of the I/O request. If structure 1320 finds a match, a cache hit occurs. Otherwise, the I/O operation results in a cache miss. In some embodiments, structure 1320 can be based on a fully associative cache design.

In some embodiments, if the cache size is large, a set associative mapping can be implemented. In a set associative mapping, part of an LBA of interest can go through a decoder to index one of N sets. Within the indexed set, structure 1320 can perform associative search to find a matching LBA for a cache hit. In some embodiments, the fingerprint portion of tag array 1336 can also be implemented using CAM cells, so that structure 1320 can use associative search to find partially matching signatures for similar blocks. In further embodiments, the amount of partial match is a system design parameter that can be tuned to improve performance. For example, structure 1320 can use a threshold of six of eight fingerprints 1340c, 1340f in a partial match for similarity determination. A reference pointer field can store a location of a reference block associated with a data block of interest. Status bits can contain a cache status of a block of interest. Example values for the status bits may include clean, dirty, least recently used (LRU) counter value, etc., as used by cache management circuit 1330.

In some embodiments, data array 1336 can be partitioned into three parts: (1) reference data area 1342a, (2) associated block area 1342b, and (3) independent data area 1342c. In further embodiments, the size of reference data area 1342a can be selected to be small while the size of associated block area 1342b can be selected to be large. Structure 1320 can compress data using compression circuit 1326 in associated block area 1342b against reference blocks in reference data area 1342a. Independent data area 1342c contains independent blocks. Independent blocks refer to blocks that do not show content locality, but may be cached for other reasons, e.g. based on temporal locality or spatial locality. In some embodiments, the illustrated border lines that separate reference data area 1342a, associated data area 1342b, and independent data area 1342c can change dynamically. For example, the size of a respective area may change depending on I/O workload and data access locality of running applications.

Cache management circuit 1330 can include HeatMap 1358, timer 1334, and counter 1356. Cache management circuit 1330 can perform background flushing, replacement, and periodic scanning for classification of blocks. HeatMap 1358 can store fingerprints corresponding to encoded reference blocks to form a table or a directory. HeatMap 1358 can be indexed according to shingles. As described earlier, a shingle can represent a sliding window, or subset of bits, of contents of data blocks. For example, HeatMap 1358 can be indexed using hash functions based on determining Mersenne primes of each shingle. When a shingle of an incoming data block matches a shingle indexed in the directory, an associated block can store a “delta” corresponding to the incoming data block. The delta can include (1) an offset of the shingle in the reference block and (2) a matched length. Cache management circuit 1330 can also manage status bits. Status bits can contain a cache status of a block of interest. Example values for the status bits may include clean, dirty, least recently used (LRU) counter value, etc. Cache management circuit 1330 can use the status bits to perform background processes such as background flushing, replacement, and periodic scanning for classification of blocks. For example, timer 1334 can be used as an idle detector to determine when to perform the background processes. When performing the background processes, counter 1356 can use eviction logic to determine when a data block should be evicted after a certain threshold has been reached. Counter 1356 can also periodically scan data area 1338 to identify cached blocks that are candidates for reclassification. For example, counter 1356 can scan for (1) reference blocks that should be reclassified into independent blocks and/or deltas for associated blocks, (2) associated blocks that should be reclassified into reference blocks and/or independent blocks, or (3) independent blocks that should be reclassified into reference blocks and/or deltas for associated blocks.

Compression circuit 1326 can include buffer 1344, delta compression module 1346, threshold comparator 1348, and logic gates 1350, 1352. Compression circuit 1326 can perform delta compression once a new data block is determined to be sufficiently similar to a reference block in reference data area 1342a. For example, buffer 1344 can store a received data block from a write I/O from host 1302. Delta compression circuit can compare the contents of buffer 1344 with reference blocks in reference data area 1342a to determine similarity. In some embodiments, threshold comparator 1348 can determine similarity. For example, if the content of new data block is determined to differ by over ½ with the reference blocks in reference data area 1342a, then the new data block can be characterized as an independent data block. The new data block can pass to logic gate 1350, for example, a logical AND gate, for storing the new data block into independent data area 1342c. If threshold comparator 1348 determines the new data block to be sufficiently similar (e.g., with threshold less than ½), delta compression module 1346 can compress the contents of buffer 1344, for example using delta compression. Upon compression, logic gate 1352, for example, a logical AND gate, can store the newly compressed delta into an associated block in associated data area 1342b. Compression circuit 1326 can also be used during periodic scanning and block classification, to compress associated blocks against reference blocks. Structure 1320 may further store the delta together with its corresponding LBA, fingerprint, reference pointer, and cache status bits in corresponding tag area 1336.

If threshold comparator 1348 finds the delta after compression to be large, compression module 1326 can perform false positive similarity detection. An example of a large delta may be one half of the original size, if the threshold between a large delta and small delta is set to ½. For deltas that turn out to be large, compression module 1326 can store the received data block as an independent block in independent data area 1342c. For large deltas, the similarity detection and compression processes performed for the received data block may have been wasted because the processes may not result in a corresponding reference block or delta block for reference data area 1342a and/or associated data area 1342b. Accordingly, compression module 1326 can lower the number of such false detections by tuning relevant parameters. Examples of parameters for tuning may include shingle size, fingerprint size, number of fingerprint matches, sampling size, compression threshold, etc. Furthermore, structure 1320 can perform similarity detection and compression in parallel with normal I/O operations and therefore avoid adversely slowing front end I/O performance.

In some embodiments compression module 1326 can use high speed compression hardware. Examples of high-speed compression hardware include hardware for performing parallel and pipelined encoding using reference blocks to form a table or a directory stored in cache management circuit 1330, sometimes referred to herein as HeatMap 1358. HeatMap 1358 can be indexed according to shingles. A shingle represents a sliding window, or subset of bits, of contents of data blocks. For example, HeatMap 1358 can be indexed using hash functions based on determining Mersenne primes of each shingle. When a shingle of an incoming data block matches a shingle indexed in the directory, an associated block can store a “delta” corresponding to the incoming data block. The delta can include (1) an offset of the shingle in the reference block and (2) a matched length. Parallel and pipelined implementations of compression circuit 1326 can thereby achieve performance of tens or even hundreds of gigabytes per second.

Decompression circuit 1328 can include decompression module 1360, multiplexer 1362, and logic gate 1364. Decompression circuit 1328 can perform delta decompression for received read I/Os, upon a cache hit. For example, a cache hit can happen in associated block area 1338. Upon a cache hit, decompression module 1360 can reassemble a resulting data block to provide to host 1302. For example, decompression module 1360 can reassemble the resulting data block by identifying a reference block from reference data area 1342a and an associated block from associated data area 1342b. For example, decompression module 1360 can recreate requested content starting from an associated block and incorporating shingles of reference blocks. Multiplexer 1362 can also select among recreated content from decompression 1360, and an independent block stored in independent data area 1342c. Upon a cache hit, logic gate 1364, for example a logical AND gate, can provide the requested block to host 1302.

Decompression module 1360 can extract a corresponding delta from the associated block and combine the delta with the reference block. For example, decompression module 1360 can identify shingles of reference blocks by following pointers to the shingles pointed to by offsets stored in the delta-encoded associated block. Since decompression circuit 1328 can affect performance of read I/O operations, decompression circuit 1328 can be designed to be relatively fast in hardware. According to related software-based implementations, decompression can perform much faster than compression. In some embodiments decompression module 1328 can use high speed decompression hardware. As described earlier, implementations of compression circuit 1326 can achieve performance of tens or even hundreds of gigabytes per second. Decompression circuit 1328 can perform even faster. In some embodiments, decompression circuit 1328 can recreate, or reform, requested contents using associated blocks and reference blocks.

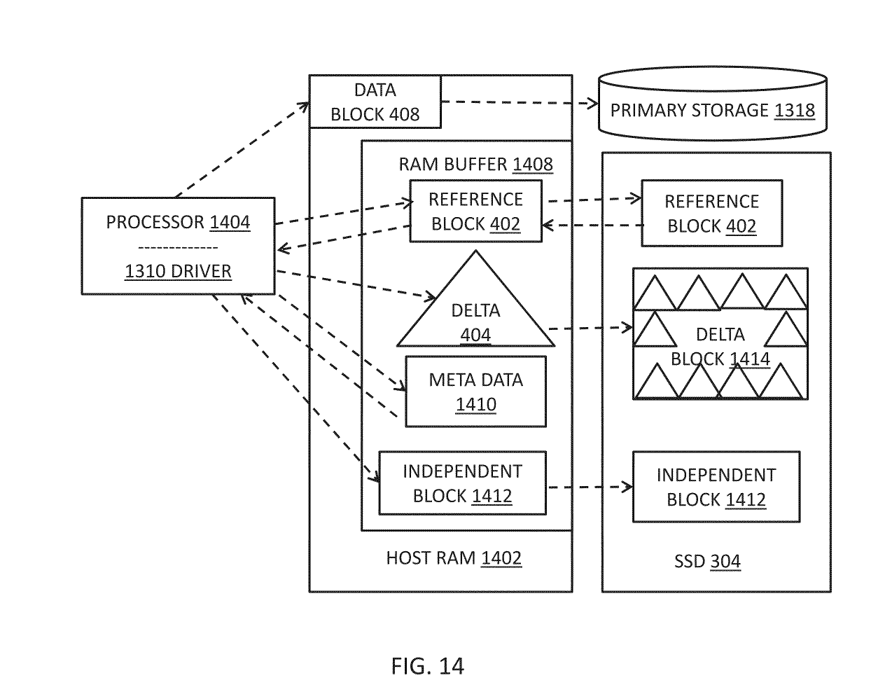

FIG. 14 illustrates an example write operation directed to primary storage using the content locality based cache, in accordance with some embodiments of the present disclosure. Host processor 1404 may instruct primary storage subsystem 1318 to perform a write of data block 408. This instruction is also delivered to software module/driver 1310 where it is determined if data block 408 has a corresponding delta 404 and reference block 402. If so, a new delta based on differences between write data block 408 and reference block 402 is calculated and written to delta buffer 1408 portion of host RAM 1402. If there is not already a corresponding delta 404 for data block 408, similarity of the data block to each of the cached reference blocks may be checked using the similarity determination techniques described herein, and reference block 402 is selected. An original delta 404 is then generated, and original delta 404 and metadata 1410 for data block 408 are generated and stored in delta buffer 1408. During the generation of the new delta or the original delta, if the resulting delta is determined to be larger than a delta size threshold, the delta compression algorithm may be terminated and independent block 1412 may instead be generated for storage in delta buffer 1408. If SSD storage 304 is available, reference blocks 402, independent blocks 1412, and/or delta blocks 1414 may be stored in SSD 304.

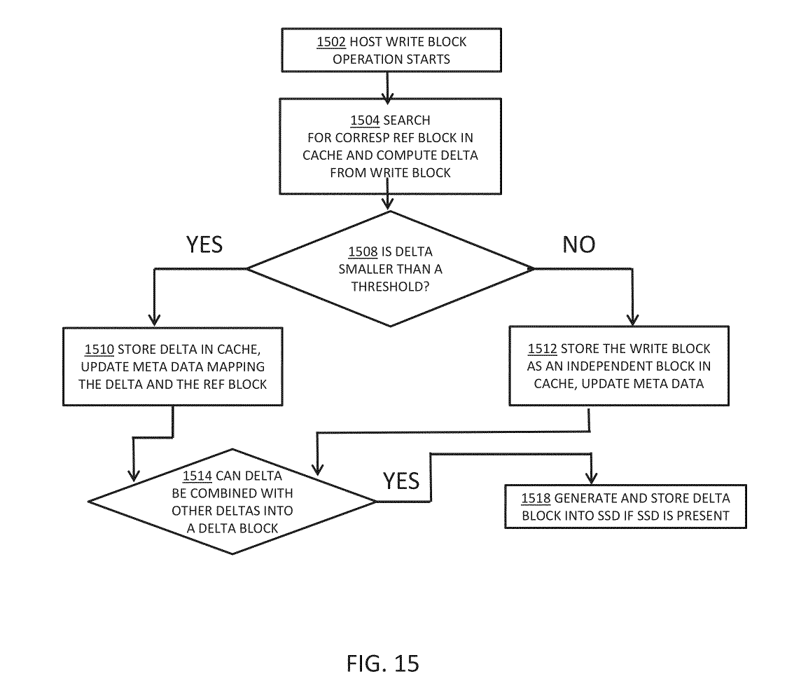

FIG. 15 illustrates a flow diagram of an example primary storage directed write operation using content locality based caching, in accordance with some embodiments of the present disclosure. A host may start a data block host write operation (step 1502). The intelligent processing unit may search for a corresponding reference block in the cache (which may include a RAM buffer and/or SSD). In some embodiments, the intelligent processing unit may be a custom ASIC, firmware, hardware, or software such as a driver. Presuming that a reference block is found, a new delta is generated (step 1504). As noted above for FIG. 14, if a reference block is not found for the write data block, an original delta may be generated based on a new reference block with the most similarity. If the generated new or the original delta is smaller than a delta size threshold (step 1508) then the intelligent processing unit stores the delta in cache and updates metadata for mapping the delta to the data block and the reference block (step 1510). If the new or original delta is larger than the delta size threshold as determined in step 1508, the intelligent processing unit stores the data block in cache as an independent block and updates metadata to facilitate retrieving the corresponding independent block (step 1512). The intelligent processing unit determines if the generated delta can be combined with other deltas into a delta block that is suitable for storing in SSD memory (step 1514). If so, the intelligent processing unit generates a delta block and stores the delta block into SSD memory (presuming that the SSD memory is available) (step 1518). In some embodiments, writing the delta blocks from the RAM buffer to SSD or primary storage may be based on an LPU/CIP algorithm described herein.

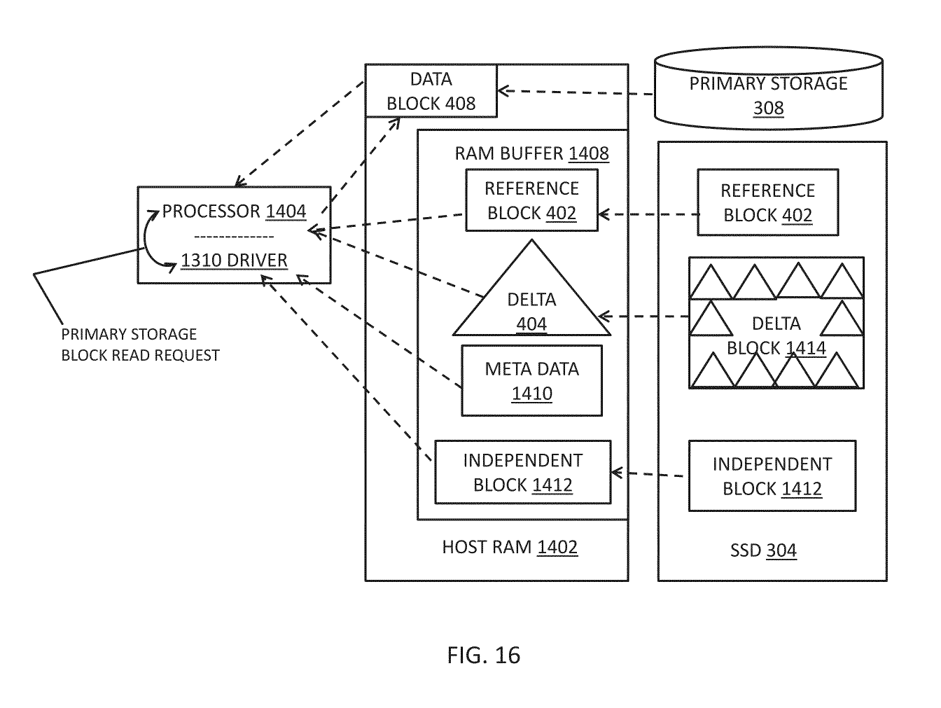

FIG. 16 illustrates an example read operation directed to primary storage using content locality based caching, in accordance with some embodiments of the present disclosure. Processor 1404 may request access of a primary storage data block 408. The request may be provided to the software module/driver 1310 for executing the similarity-based delta compression techniques described herein. Software module/driver 1310 may read metadata 1410 associated with data block 408. Metadata 1410 may indicate that delta 404 and reference block 402 are stored in cache (e.g. RAM buffer 1408 of host RAM 1402). The reference block and the delta may be combined to generate requested data block 408. Alternatively, the metadata 1410 may indicate that independent block 1412 that represents the requested data block 408 is available in the cache. Software module 1310 may access the independent data block and provide it to processor 1404. If it is determined that a delta and an independent block do not exist for requested data block 408, primary storage 308 may be called upon to deliver data block 408. If SSD storage 304 is available, reference blocks 402, delta blocks 1414, and/or independent blocks 1412 may be stored in SSD 304.

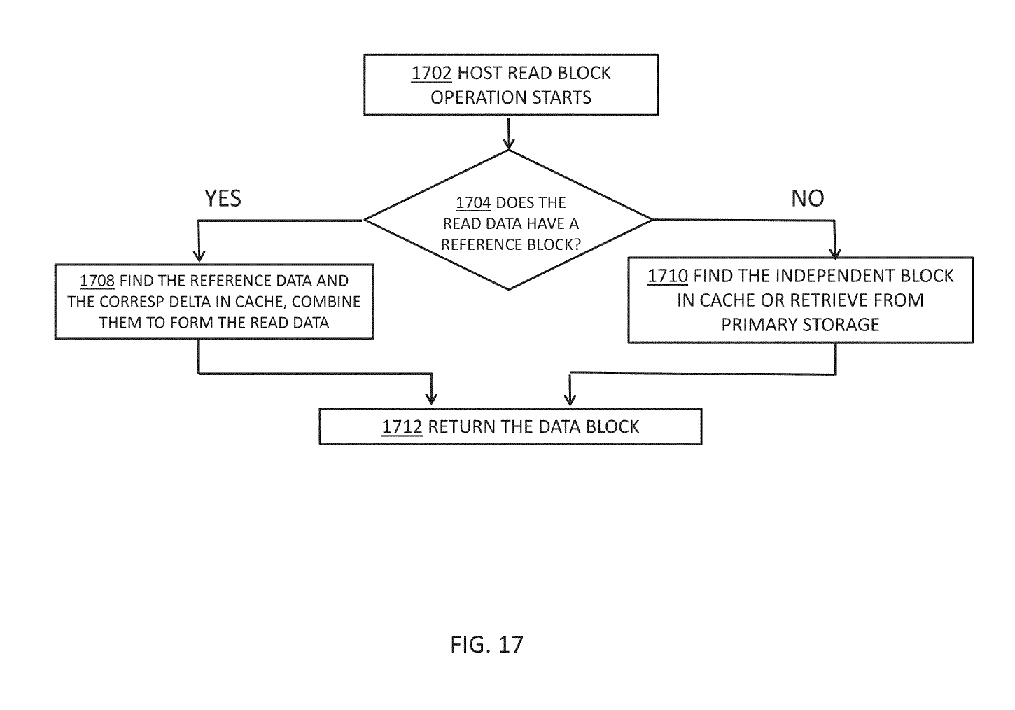

FIG. 17 illustrates a flow diagram of an example primary storage directed read operation using content locality based caching, in accordance with some embodiments of the present disclosure. A host processor may request a read data block by starting a primary storage read operation (step 1702). If software module 1310 determines that a reference block exists for the requested primary storage data block (such as by checking metadata associated with the primary storage data block) (step 1704: Yes), the corresponding reference block and delta may be read from the cache and combined to form the requested read data block (step 1708). If software module 1310 determines that a reference block does not exist for the requested primary storage data block (step 1704: No), either an independent block is ready from the cache or the primary storage is relied upon to provide the requested data block (step 1710). The requested data block is provided to the requesting processor (step 1712).

I/O scheduling for embodiments described herein may be quite different from scheduling for traditional disk storage. For example, the traditional elevator scheduling algorithm for hard drives (HDD) aims to combine disparate disk I/Os in an order that minimizes seek distances on the HDD. In contrast, content locality based caching facilitates changing I/O access scheduling to emphasize combining I/Os that may be similar to a reference block or may be represented by deltas that are contained in one delta block stored in the primary storage subsystem or a dedicated SSD storage module. To do this scheduling, an efficient metadata structure may relate LBAs of read I/Os to deltas stored in a delta block, and relate LBAs of write I/Os to reference blocks stored in SSD.

To serve I/O requests from the host, some embodiments use a sliding window mechanism similar to the mechanism used in transport control protocol/Internet protocol (TCP/IP) windowing. For example, write I/O requests inside a window may be candidates for delta compression with respect to reference blocks and may be packed into one delta block. Read I/O requests inside the window may be examined to determine all those that were packed in one delta block. The window slides forward as I/O requests are being served. Besides determining the best window size while considering both reliability and performance, some embodiments may be able to pack and unpack a batch of I/Os from the host so that a single HDD I/O operation generates many deltas.

### Reference Block Identification and Similarity Detection

Some embodiments may identifying a reference block in SSD for each I/O operation. For a write I/O, the corresponding reference block, if present, needs to be identified for delta compression. If the write I/O is a new write with no prior reference block, a new corresponding reference block may be identified that has the most similarity to the data block of the write I/O. For a read I/O, as soon as the delta corresponding to the read I/O is loaded, its corresponding reference block may be found to decompress to the original data block.

Quickly identifying reference blocks may be highly beneficial to overall I/O performance. To identify reference blocks quickly, reference blocks may be classified into categories: (1) reference blocks with LBAs identical to delta blocks, (2) data blocks resulting from virtual machine creation, and (3) newly generated data blocks with LBAs that are unassociated with the reference blocks stored in SSD.

The first category includes reference blocks that have exactly the same LBAs that deltas have. For example, these reference blocks may be data blocks originally stored in the SSD, but changes occur on these blocks during online operations such as database transactions or file changes. These changes may be stored as a packed block of deltas to minimize random writes to SSD. Because of content locality, the deltas may be expected to be small. Identifying this type of block may be based on metadata mapping of deltas to reference blocks.

The second category contains data blocks generated as results of virtual machine creations. For example, these data blocks may include copies of guest operating systems (OS), guest application software, and user data that may be largely duplicates with very small differences. Virtual machine cloning enables fast deployment of hundreds of virtual machines in a short time. Different virtual machines access their own virtual disk using virtual disk addresses while the host operating system manages the physical disk using physical disk address. For example, two virtual machines send two read requests to virtual disk addresses V1_LBAO and V2_LBAO, respectively. These two read requests may be interpreted by underlying virtual machine monitor to physical disk addresses LBAx and LBAy, respectively, which may be considered as two independent requests by a traditional storage cache. Embodiments relate and associate these virtual and physical disk addresses by retrieving virtual machine related information from each I/O request. Requests with the same virtual address may be considered to have high possibility to be similar and may be combined based on similarity. In the current example, block V1_LBAO (LBAx) is set as the reference block so content locality based caching may derive and keep the difference between V2_LBAO (LBAy) and VI_LBAO (LBAx) as a delta.

The third category consists of data blocks that may be newly generated with LBAs that are not associated with any of the reference blocks stored in SSD. For example, these data blocks may be created by file changes, file size increases, file creations, new tables, and so forth. While these new blocks may contain substantial redundant information compared to some reference blocks stored in the cache, quickly finding the corresponding reference blocks that have most similarity may allow helpful use of the delta-compression and other techniques described herein. In some embodiments, to support fast similarity detection, a similarity detection algorithm is described herein based on wavelet transforms using an intelligent processing unit, custom ASIC, firmware, hardware, or software modules. Traditionally, hashing has been used to identify identical blocks. In contrast, some embodiments may detect similarity between two data blocks by determining subsignatures that represent a combination of several hash values of subblocks. The similarity detection algorithm may further exploit modern CPU architectures.

The similarity of two blocks may be determined by the number of subsignatures that the two blocks share. A sufficient number of shared subsignatures may indicate that the two blocks are similar in content (e.g. they share many same subsignatures). However, such content similarity can be either an in-position match or an out-of-position match. In an out-of-position match, a position change is caused by content shifting (e.g., inserting a word at the beginning of a block shifts all remaining bytes down by the word). To handle both in-position matches and out-of-position matches efficiently, embodiments use a combination of regular hash computations and wavelet transformation. Hash values for every three consecutive bytes of a block may be computed to produce a one byte signature. A Haar wavelet transform may be also computed. The most frequently occurring subsignatures may be selected along with a number of coefficients of the wavelet transform for signature matching. For example, six of the most frequently occurring subsignatures and three of three wavelet transform coefficients may be selected. That is, nine signature matching elements representing a block may be compared: six sub-signatures and three coefficients of the wavelet transform. Hash values may be computed with more or fewer than three consecutive bytes. Similarly, more or fewer than six frequent sub-signatures may be selected. Likewise, more or fewer than three Haar wavelet coefficients may be selected.

The three coefficients of the wavelet transform may include one total average, and positions of two largest amplitudes. The total average coefficient value may be used to pick the best reference if multiple matches are found for the other eight signatures.

Consider an example of a 4 KB block. Embodiments first calculate the hash values of all sets of three consecutive bytes to obtain 4K−2 sub-signatures. Among these sub-signatures, the six most frequent sub-signatures may be selected together with the three coefficients of the wavelet transform to carry out the similarity detection. If the number of matches of two blocks exceeds seven, they may be considered to be similar. Based on experimental observations, this position-aware sub-signature matching mechanism can recognize not only shifting of content but also shuffling of contents.

In some embodiments, subsignatures of a data block may also be determined using sliding tokens. An example size of the token ranges from three bytes to hundreds of bytes. The token slides one byte a time from the beginning to the end of the block. Hash values of each sliding token are computed using Rabin fingerprinting, Mersenne prime modulus, random irreducible polynomials, etc. Sampling or sorting techniques may be used to select a few subsignatures of each block for similarity detection and reference selection processing.

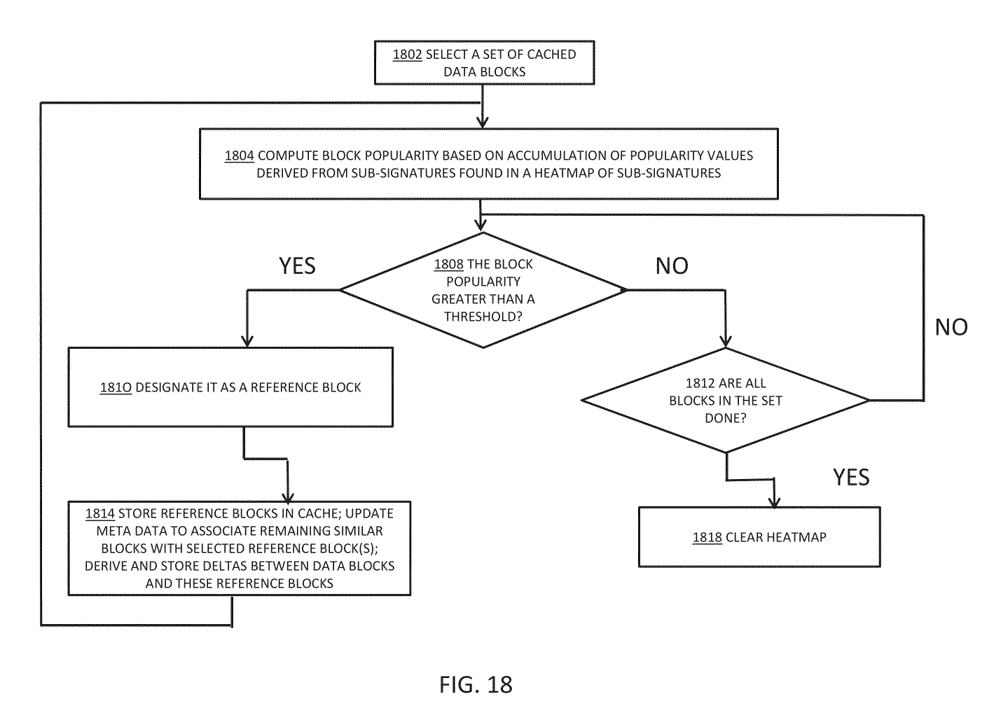

FIG. 18 shows a flowchart for an example similarity detection method for content locality based caching, in accordance with some embodiments of the present disclosure. Some embodiments may invoke the similarity detection periodically. For similarity detection upon an access to a new data block, similarity data (e.g. signatures, sub-signatures, and potentially heatmap data) of a set of reference blocks are searched to find a sufficiently similar reference block. Such a reference block may result in a delta that is less than a predefined delta size threshold. Once a suitable reference block is found, the new data block may be designated as an associated block. Also, the delta, and similarity detection-related metadata may be stored in a data structure that facilitates rapid access to delta, reference, and independent data block information.

For periodic similarity detection, the period length and set of blocks to be examined may be configured based on performance requirements and the sizes of available RAM, SSD and primary storage if available. For periodic similarity detection, after selection of a set of cached blocks (step 1802) to examine for similarity detections, popularity of each block may be computed (step 1804). Each block may then be evaluated to determine its popularity. If the popularity of a block exceeds a predefined and configurable threshold value (step 1808: Yes), the data block may be designated as a reference block (step 1810) to be stored in RAM or SSD. If the intelligent processing unit determines that the similarity value of the two blocks is less than the threshold value (step 1808: No), the process continues with other data blocks (step 1812). Designated reference blocks may be stored in the cache, and metadata about the block may be updated to allow association of remaining similar blocks for delta-compression. Finally, after comparing all data blocks in the set, the HeatMap is cleared (step 1818) to begin a new phase of sub-signature generation and block popularity accounting. The HeatMap refers to a two dimensional array of subsignature related data used for similarity detection based on stored subsignatures.

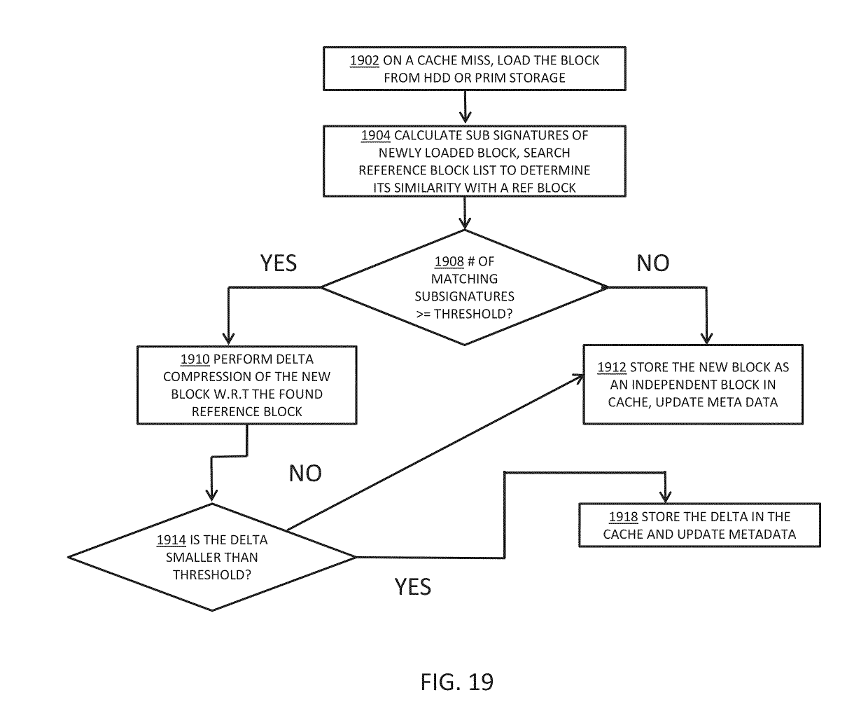

FIG. 19 illustrates a flowchart of example cache management actions upon a cache miss in content locality based caching, in accordance with some embodiments of the present disclosure. The cache management actions may be taken upon a new access to a data block not currently known to the cache management system (e.g. a data block resulting from a cache miss). The intelligent processing unit loads a data block indicated by a cache miss from primary storage (step 1902). In some embodiments, the primary storage may include mass storage, SAN, and the like. The intelligent processing unit proceeds to calculate sub-signatures of the newly loaded data block (step 1904). The sub-signatures are used in a search of the current reference blocks, to look for reference blocks that include sub-signatures that match the calculated sub-signatures. The number of matching sub-signatures is compared to a delta-compression similarity threshold (step 1908). If the number of matching sub-signatures exceeds the similarity threshold (step 1908: Yes), a candidate reference block is identified for data compression (step 1910). If the number of matching sub-signatures does not exceed the similarity threshold (step 1908: No), the candidate reference block is stored as an independent block (step 1912).

In some embodiments, the data compression (step 1910) includes delta compression techniques. The delta compression techniques may perform delta compression of the newly loaded block to determine the degree of similarity between the newly loaded block and the identified reference block (step 1910). The degree of similarity is tested by comparing the size of the delta generated through delta-compression against a maximum difference threshold (step 1914). If the delta-compression results in a delta that is at least a small as a delta size threshold (step 1914: Yes), the newly loaded block can be represented by a combination of the delta and a reference block. The intelligent processing unit therefore stores the derived delta is stored in the cache system memory and updates cache management meta-data (step 1918).

If the delta-compression derived difference is larger than the delta size threshold (step 1914: No), then the block may be sufficiently different to warrant being maintained as an independent block (step 1912). In some embodiments, the newly loaded block may be stored as an independent block (i.e., a block that is not represented by a combination of deltas with respect to a reference block), and cache meta-data is updated (step 1912).

Embodiments may attempt to store reference blocks in SSD that do not change frequently and that share similarities with many other data blocks. Guidelines for determining what data to store in SSD and how often to update SSD may be established. Such guidelines may tradeoff size, cost, available SSD memory, application factors, processor speed(s), and the like. An initial design guideline may allow storing as base data (e.g., in SSD or RAM) the entire software stack including OS and application software, as well as all active user data. This may be feasible with today's large-volume and less expensive NAND flash memories coupled with the fact that only a small percentage of file system data are typically accessed over a week. Data blocks of the software stack and base data may be reference blocks in SSD. Run time changes to these reference blocks may be stored in compressed form in delta blocks in HDD. These changes include changes on file data, database tables, software changes, virtual machine images, and the like. Such changes may be incremental so they can be very effectively compacted in delta blocks. As changes keep occurring, incremental drift may get larger and larger. To maintain efficiency, data stored in the SSD may be updated to avoid large incremental drift. Each update may result in changes in SSD and HDD as well as associated metadata.

The next design decision may be block size of reference blocks and delta blocks. For example, larger reference blocks may reduce meta-data overhead and may allow more deltas to be covered by one reference block. However, if reference block size is too large, the large size places a burden on the intelligent processing unit for computation and caching. Similarly, large delta blocks allow more deltas to be packed in, and potentially high I/O efficiency because one disk operation generates more I/Os (note that each delta in a packed delta block represents one I/O block). On the other hand, it may be a challenge whether I/Os generated by the host can take full advantage of this large amount of deltas in one delta block.

Another trade-off may be whether to allow deltas packed in one delta block to refer to a single reference block or multiple reference blocks in SSD. Using one reference block to match all deltas in one delta block allows compression/decompression of all deltas in the delta block to be done with one SSD read. On the other hand, it may be preferable that deltas compacted in one delta block belong to I/O blocks that may be accessed by the host in a short time frame (i.e., temporal locality) so that one HDD operation can satisfy more I/Os that may be in one batch. These I/O blocks in the batch may not necessarily be similar to exactly one reference block for compression purposes. As a result, multiple SSD reads may be necessary to decompress different deltas stored in one delta block. Furthermore, random read speed of SSD is so fast that it may be affordable to carry out reference block reads in this manner.

Some embodiments may include a DRAM buffer that temporarily stores I/O data blocks including reference blocks and delta blocks that may be accessed by host I/O requests. This DRAM may buffer the following types of data blocks: (1) compressed deltas, (2) data blocks for read I/Os after decompression, (3) reference blocks from SSD, and (4) data blocks of write I/Os. Management of the DRAM buffer may involve several interesting trade-offs. The first interesting tradeoff may be whether compressed deltas are cached for memory efficiency, or whether decompressed data blocks are cached to facilitate high performance read I/Os. If compressed deltas are cached, the DRAM can store a large number of deltas corresponding to many I/O blocks. However, upon each read I/O, on-the-fly computation may be necessary to decompress the delta to its original block. If decompressed data blocks are cached, these blocks may be readily available to read I/Os but the number of blocks that can be cached is smaller than caching deltas.

The second interesting tradeoff may be the space allocation of the DRAM buffer to the four types of blocks. Caching large number of reference blocks can speed up the process of identifying a reference block, deriving deltas upon write I/Os, and decompressing a delta to its original data block. However, read speed of reference blocks in SSD may already be very high and hence the benefit of caching such reference blocks may be limited. Caching a large number of data blocks for write I/Os, on the other hand, helps with packing more deltas in one delta block but raise reliability issues. Static allocation of cache space to different types of data blocks may be simple but may not be able to achieve optimal cache utilization. Dynamic allocation, on the other hand, may utilize the cache more effectively but incurs more overhead.

The third interesting tradeoff may be fast write of deltas to SSD/primary storage versus delayed writes for packing large number of deltas in one delta block. For reliability purposes, it may be preferable to perform a write to SSD/primary storage as soon as possible whereas for performance purposes it may be preferable to pack as many deltas in one block as possible before executing an SSD/primary storage write operation.

The computation time of Rabin fingerprint hash values is measured for large data blocks on intelligent processing units such as multi-core GPU/CPUs. A Rabin fingerprint is helpful in identifying reference blocks in SSD. The times it takes to compute hash values of a data block with size of 4 KB to 32 KB may be in the range of a few to tens of microseconds. In some embodiments, three of the most time-consuming processing parts have been implemented on the intelligent processing unit.

The first part implemented on the intelligent processing unit is signature generation for data blocks. In some embodiments, signature generation includes hashing calculations, sub-signature sampling, the Haar wavelet transform, and final selection of representative sub-signatures. As described previously, groups of consecutive bytes may be hashed to derive a distribution of sub-signatures. This operation can be done in parallel by calculating all hash values at the same time using multi threads. Sampling and selection may be done using random sample, sorting based on histogram, or min wise independent selection.

The second part implemented on the intelligent processing unit is periodic Kmean computations to identify similarities among unrelated data blocks. Such similarity detection can be simplified as a problem of finding k centers in a set of points. The remaining points may be partitioned into k clusters so that a total within a cluster sum of squares (TWCSS) is minimized according to known TWCSS calculation algorithms. Multiple threads may be able to calculate the TWCSS for all possible partitioning solutions at the same time. The results may be synchronized at the end of the execution, and the resulting clustering identifies similarities among unrelated data blocks. In an experimental prototype implementation, Kmean computation was invoked periodically to identify reference blocks to be stored in the cache.

The third part implemented on the intelligent processing unit is delta compression and decompression. In some embodiments a ZDelta compression algorithm or LZO compression algorithm may be used. However, optimization of the delta codec is within the scope of content locality based caching and may benefit from fine tuning

### Performance Comparison

In order to see whether embodiments may be practically feasible and provide anticipated performance benefits, an experimental proof-of-concept prototype was developed using an open source kernel virtual machine (KVM). The prototype represents a partial realization, using a software module, of content locality based caching. The system is referred to as I-CASH (I-CASH is a short name Intelligently Coupled Array of SSD and HDD).

The functions that the prototype has implemented include identifying reference blocks in a virtual machine environment and using Kmean similarity detections periodically, deriving deltas using ZDelta algorithm for write I/Os, serving read I/Os by combining deltas with reference blocks, and managing interactions between SSD and HDD. The current prototype carries out computations using the host CPU and uses a part of system RAM as the DRAM buffer of the I-CASH. A GPU was not used for computation tasks in the prototype. It is believed that the performance evaluation using this preliminary prototype thereby presents a conservative result.

In order to capture both block level I/O request information and virtual machine related information, the prototype module may be implemented in the virtual machine monitor. The I/O function of the KVM depends on QEMU that is able to emulate many virtual devices including virtual disk drive. The QEMU driver in a guest virtual machine captures disk I/O requests and passes them to the KVM kernel module. The KVM kernel module then forwards the requests to QEMU application and returns the results to the virtual machine after the requests are complete. The I/O requests captured by the QEMU driver are block-level requests of the guest virtual machine. Each of these requests contains the virtual disk address and data length. The corresponding virtual machine information may be maintained in the QEMU application part. The embodiment of the prototype may be implemented at the QEMU application level and may therefore be able to catch not only the virtual disk address and the length of an I/O request but also the information of which virtual machine generates this request. The most significant byte of the 64-bit virtual disk address may be used as the identifier of the virtual machine so that the requests from different virtual machines can be managed in one queue. If two virtual machines are built based on the same OS and application, two I/O requests may be candidates for similarity detection if the lower 56 bits of their addresses are identical.

The prototype software module maintains a queue of disk blocks that can be one of three types: reference blocks, delta blocks, and independent blocks. It dynamically manages these three types of data blocks stored in the SSD and HDD. When a block is selected as a reference, its data may be stored in the SSD and later changes to this block may be redirected to the delta storage consisting of the DRAM buffer and the HDD. In the current implementation, the DRAM is part of the system RAM with size being 32 MB. An independent block has no reference and contains data that can be stored either in the SSD or in the delta storage. To make an embodiment work more effectively, a threshold may be chosen for delta blocks such that delta derivation is not performed if the delta size exceeds the threshold value and hence the data is stored as independent block. The threshold length of delta determines the number of similar blocks that can be detected during similarity detection phase. Increasing the threshold may increase the number of detected similar blocks but may also result in large deltas limiting the number of deltas that can be compacted in a delta block. Based on experimental observations, 768 bytes are used as the threshold for the delta length in the prototype.

Similarity detection to identify reference blocks is done in two separate cases in the prototype implementation. The first case is when a block is first loaded into an embodiment's queue and the embodiment searches for the same virtual address among the existing blocks in the queue. The second case is periodical scanning after every 20,000 I/Os. At each scanning phase, the embodiment first builds a similarity matrix to describe the similarities between block pairs. The similarity matrix is processed by the Kmean algorithm to find a set of minimal deltas that are less than the threshold. One block of each such pair is selected as a reference block. The association between newly found reference blocks and their respective delta blocks is reorganized at the end of each scanning phase.

A prototype may be installed on a KVM of a Linux operating system running on a PC server that is a Dell PowerEdge T410 with 1.8 GHz Xeon CPU, 2 GB RAM, and 160 GB SATA drive. This PC server acted as the primary server. An SSD drive (OCZ Z-Drive p84 PCI-Express 250 GB) was installed on the primary server. Another PC server, the secondary server, was a Dell Precision 690 with 1.6 GHz Xeon CPU, 2 GB RAM and 400 G Seagate SATA drive. The secondary server was used as the workload generator for some of the benchmarks. The two servers were interconnected using a gigabit Ethernet switch. The operating system on both the primary server and the secondary server was Ubuntu 8.10. Multiple virtual machines using the same OS were built to execute a variety of benchmarks.

For performance comparison purposes, a baseline system was also installed on the primary PC server. One difference between the base line system and a system implementing a content locality cache is the way the SSD and HDD are managed. In the baseline system, the SSD is used as an LRU disk cache on top of the HDD. In present prototype, on the other hand, the SSD stores reference data blocks and HDD stores deltas as described previously.

Appropriate workloads may be important for performance evaluations. It should be noted that evaluating the performance of embodiments is unique in the sense that I/O address traces are not sufficient because deltas are content-dependent. That is, the workload should have data contents in addition to address traces. Because of this uniqueness, none of the available I/O traces is applicable to the performance evaluations. Therefore, seven standard I/O benchmarks that are available to the research community have been collected as shown in Table 1.

TABLE 1
Standard benchmarks used in performance of prototype I-CASH

| Abbreviation | Name | Description |
|---|---|---|
| RU | RUBiS | e-Commerce web server workload |
| TP | TPC-C | Database server workload |
| SM | SPECmail2009 | Mail server workload |
| SB | SPECwebBank | Online banking |
| SE | SPECwebEcommerce | Online store selling computers |
| SS | SPECwebSupport | Vendor support website |
| SF | SPECsfs2008 | NFS file server |

The first benchmark, RUBiS, is a prototype that simulates an e-commerce server performing auction operations such as selling, browsing, and bidding similar to eBay. To run this benchmark, each virtual machine on the server has installed Apache, Mysql, PHP, and RUBiS client. The database is initialized using the sample database provided by RUBiS. Five virtual machines are generated to run RUBiS using the default settings of 240 clients and 15 minutes running time.

TPC-C is a benchmark modeling operations of real-time transactions. It simulates the execution of a set of distributed and on-line transactions (OLTP) on a number of warehouses. These transactions perform the basic database operations such as inserts, deletes, updates and so on. Five virtual machines are created to run TPCC-UVA implementation on the Postgres database with 2 warehouses, 10 clients, and 60 minutes running time.

In addition to RUBiS and TPC-C, five data intensive SPEC benchmarks developed by the Standard Performance Evaluation Corporation (SPEC) have also been set up. SPECMail measures the ability of a system to act as an enterprise mail server using the Internet standard protocols SMTP and IMAP4. It uses folders and message MIME structures that include both traditional office documents and a variety of rich media contents for multiple users. Postfix was installed as the SMTP service, Dovecot as the IMAP service, and SPECmail2009 on 5 virtual machines. SPECmail2009 is configured to use 20 clients and 15 minutes running time. SPECweb2009 provides the capability of measuring both SSL and non-SSL request/response performance of a web server. Three different workloads are designed to better characterize the breadth of web server workload. The SPECwebBank is developed based on the real data collected from online banking web servers. In an experiment, one workload generator emulates the arrivals and activities of 20 clients to each virtual web server under test. Each virtual server is installed with Apache and PHP support. The secondary PC server works as a backend application and database server to communicate with each virtual server on the primary PC server. The SPECwebEcommerce simulates a web server that sells computer systems allowing end users to search, browse, customize, and purchase computer products. The SPECwebSupport simulates the workload of a vendor's support web site. Users are able to search for products, browse available products, filter a list of available downloads based upon certain criteria, and download files. Twenty clients are set up to test each virtual server for both SPECwebEcommerce and SPECwebSuppor for 15 minutes. The last SPEC benchmark, SPECsfs, is used to evaluate the performance of an NFS or CIFS file server. Typical file server workloads such as LOOKUP, READ, WRITE, CREATE, and REMOVE are simulated. The benchmark results summarize the server's capability in terms of the number of operations that can be processed per second and the I/O response time. Five virtual machines are setup and each virtual NFS server exports a directory to 10 clients to be tested for 10 minutes.

Using the preliminary prototype and the experimental settings, a set of experiments have been carried out running the benchmarks to measure the I/O performance of embodiments as compared to a baseline system. The first experiment is to evaluate speedups of embodiments compared to the baseline system. For this purpose, all the benchmarks were executed on both embodiments and on the baseline system.

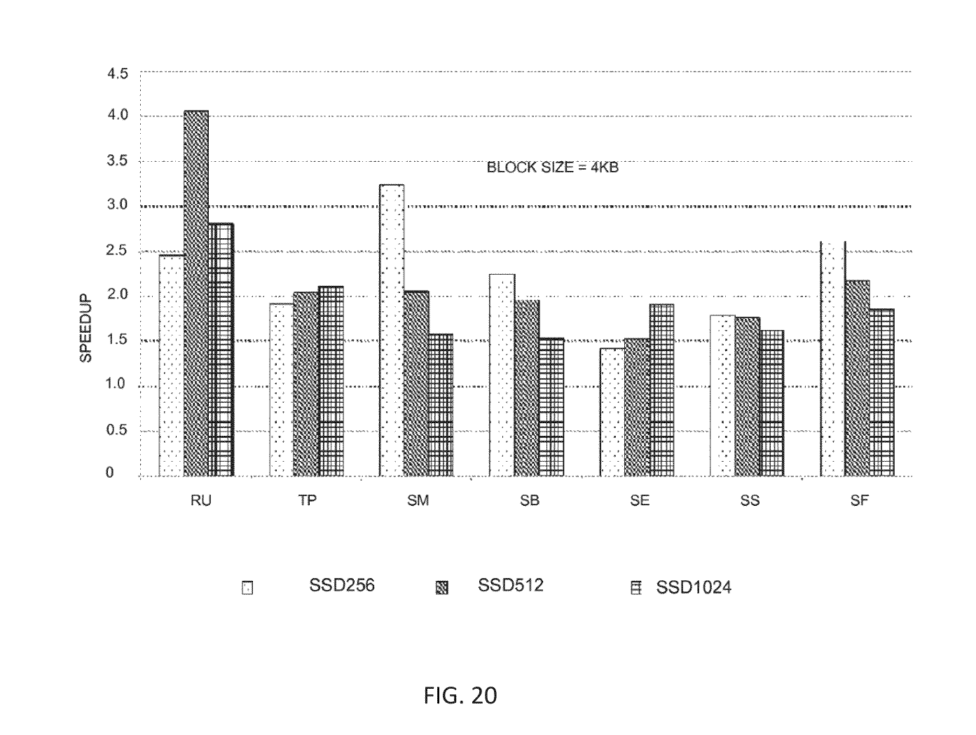

FIG. 20 shows the measured speedups for benchmarks in the prototype, in accordance with some embodiments of the present disclosure. From this figure, it is observed that for 5 out of 8 benchmarks the methods and systems described herein improve the overall I/O performance of the baseline system by a factor of 2 or more with the highest speedup being a factor of 4. In the experiment, 3 different SSD sizes were considered: 256 MB, 512 MB, and 1 GB. It is interesting to observe from this figure that the speedup does not show monotonic change with respect to SSD size. For some benchmarks, large SSD gives better speedups while for others large SSD gives lower speedups. This variation indicates a potential dependence on the dynamics of workloads and data content as discussed above.

While I/O performance generally increases with the increase of SSD cache size for the baseline system, the performance change of the tested embodiment depends on many other factors in addition to SSD size. For example, even though there is a large SSD to hold more reference blocks, the actual performance of the tested embodiment may fluctuate slightly depending on whether or not the system is able to derive a large amount of small deltas to pair with those reference blocks in the SSD, which is largely workload dependent. Nevertheless, the tested embodiment performs constantly better than the baseline system with performance improvement ranging from 50% to a factor of 4 as shown in FIG. 20.

The speedups shown in FIG. 20 are measured using 4 KB block size for reference blocks to be stored in the SSD. This block size is also the basic unit for delta derivations and delta packing to form delta blocks to be stored in the HDD. As discussed in the previous section, in some embodiments reference block size is a design parameter that affects delta computation and number of deltas packed in a delta block.

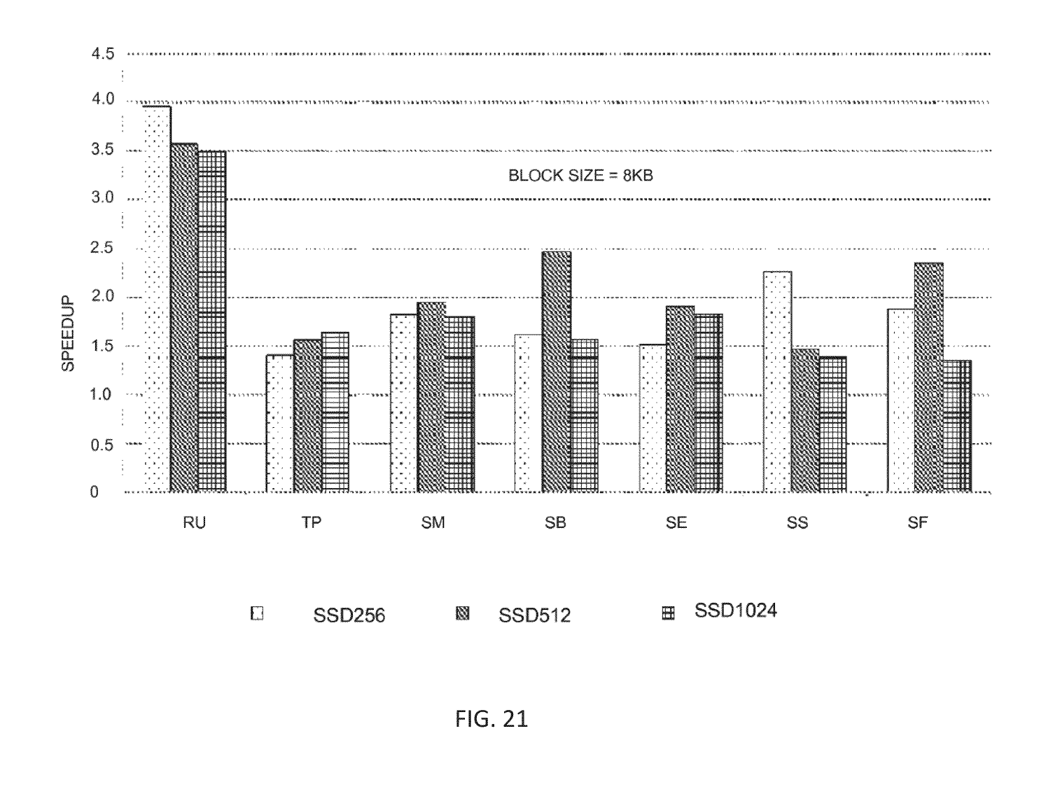

FIG. 21 shows speedups measured using a similar experiment but with an 8 KB block size in the prototype, in accordance with some embodiments of the present disclosure. Comparing FIG. 21 with FIG. 20, very small differences were noticed on overall speedup when an 8 KB block size is compared to a 4 KB block size. Intuitively, large block size should give better performance than small block size because of the large number of deltas that can be packed in a delta block stored in the HDD. On the other hand, large block size increases the computation cost for delta derivations. It may be expected that the situation may change if a dedicated high speed GPU/CPU, custom ASIC, firmware, or other custom hardware is used for such computations.

To isolate the effect of computation times, the total number of HDD operations of the tested embodiment and that of the baseline system were measured. The I/O reductions of the tested embodiment were then calculated as compared to the baseline by dividing the number of HDD operations of the baseline system by the number of HDD operations of the tested embodiment.

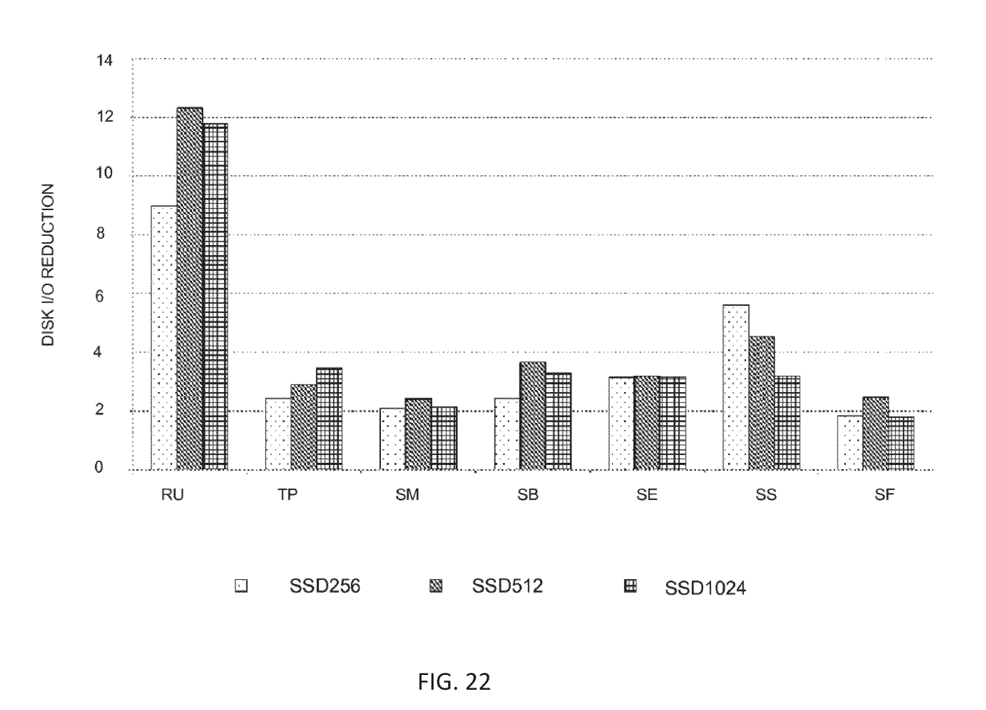

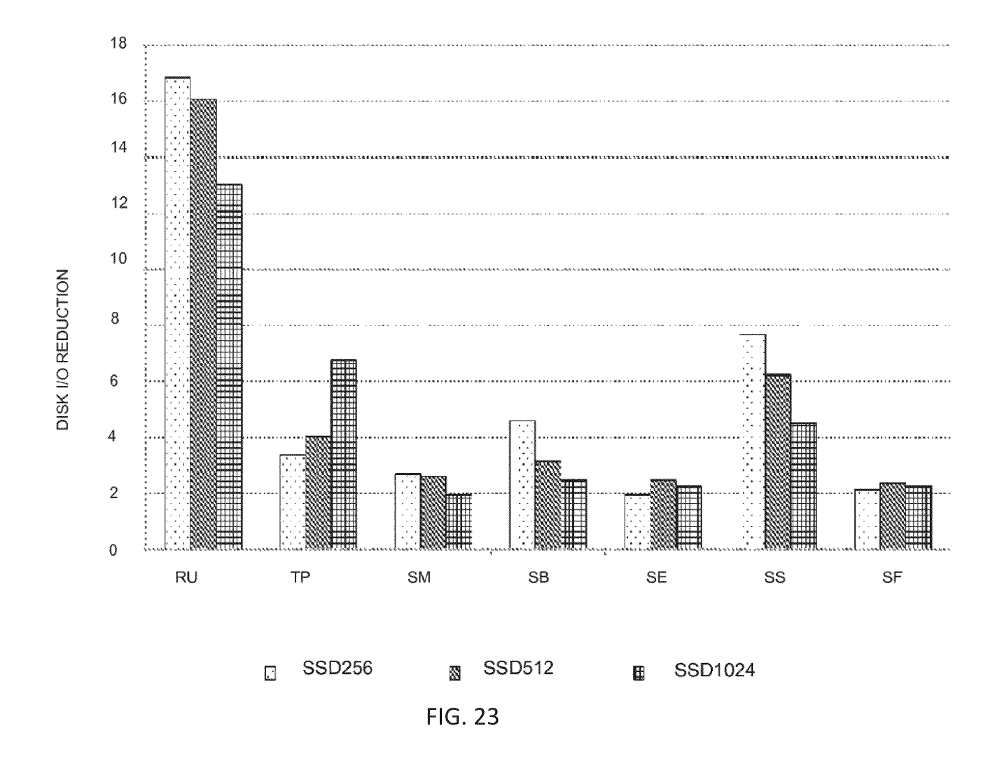

FIGS. 22 and 23 show I/O reductions for all benchmarks with block size being 4 KB and 8 KB, respectively, in the prototype, in accordance with some embodiments of the present disclosure. It may be deduced from these figures that the tested embodiment reduces the number of HDD operations to half at least for all benchmarks. This factor of two I/O reduction did not directly double performance in terms of overall I/O performance. This can be attributed to the computation overhead of the tested embodiment since the current prototype is implemented in software and consumes system resources for delta computations. This observation can be further evidenced by comparing FIG. 22 with FIG. 23 where the only difference is block size. With larger block size, the HDD disk I/O reduction is greater than smaller block size because more deltas may be packed in one delta block stored in the HDD. However, the overall performance differences between these two block sizes, as shown in FIGS. 20 and 15, are not as noticeable as I/O reductions.

From FIGS. 20-23 it is noticed that RUBiS benchmark performs the best on the tested embodiment for all cases. To understand why this benchmark shows such superb performance, the I/O traces of the benchmarks were analyzed. Analyzing the I/O traces unveiled that RUBiS benchmark has 90% of blocks that are repeatedly accessed for at least 2 times and 70% of blocks that are accessed for at least 3 times. This highly repetitive access pattern is not found in other 6 benchmarks. For example, 40% of blocks are accessed only once in the SPECmail benchmark run.

Because of time constraint, benchmark running time was limited in the experiments. It might have been that the repetitive access pattern may show after a sufficiently long running time since such behavior is observed in real world I/O traces such as SPC-1.

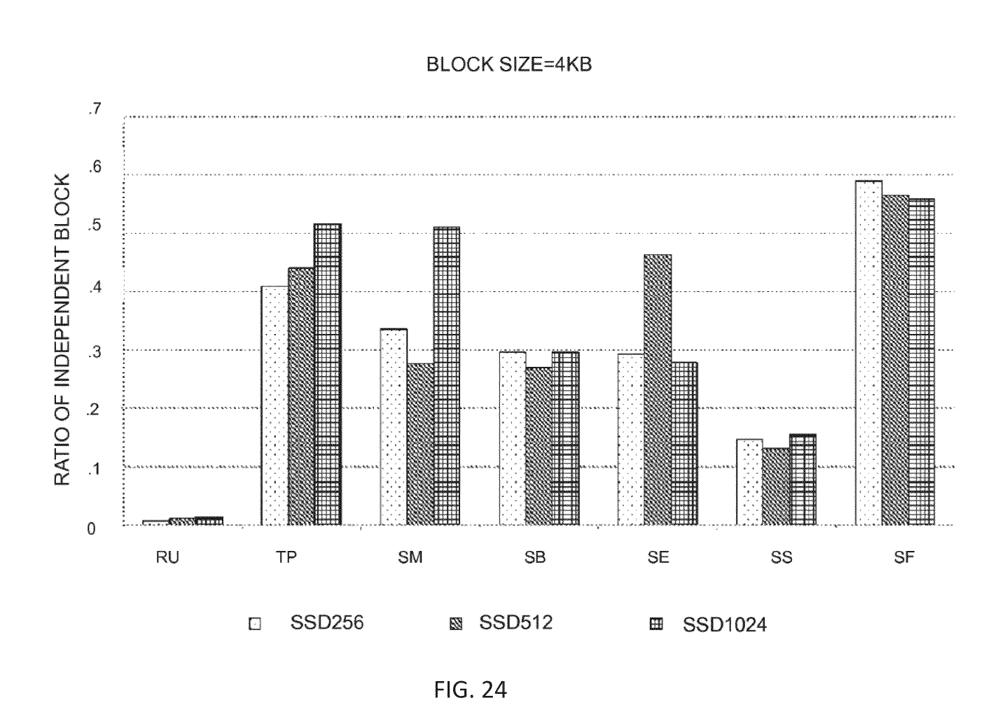

FIG. 24 illustrates the percentage of independent blocks found in the experiments, in accordance with some embodiments of the present disclosure. Besides I/O access patterns that affect performance of the tested embodiment, another factor impacting that performance is the percentage of I/O blocks that can find their reference blocks in SSD and can be compressed to small deltas with respect to their corresponding reference blocks. Recall that independent blocks are the I/O blocks that are stored in the traditional way because the tested embodiment may not find related reference blocks that produce a delta smaller than the predefined threshold. From FIG. 24 it is observed that the tested embodiment is able to find over 50% of I/O blocks for delta compression except for SPECsfs.

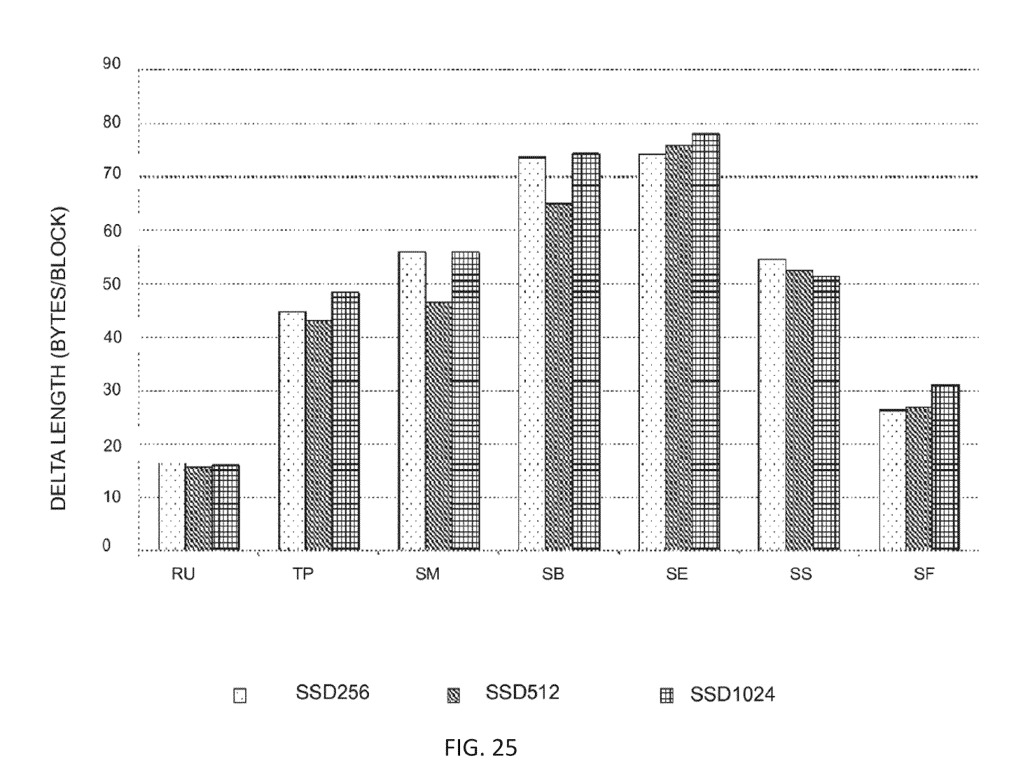

FIG. 25 illustrates average delta sizes of the delta compression for all the benchmarks, in accordance with some embodiments of the present disclosure. In general, the smaller the delta, the better the tested embodiment performed. Consistent with the performance results shown in FIGS. 18-22, RUBiS benchmark has the largest percentage of blocks that can be compressed and the least delta size as shown in FIGS. 24, 25. As a result, it shows the best I/O performance overall.

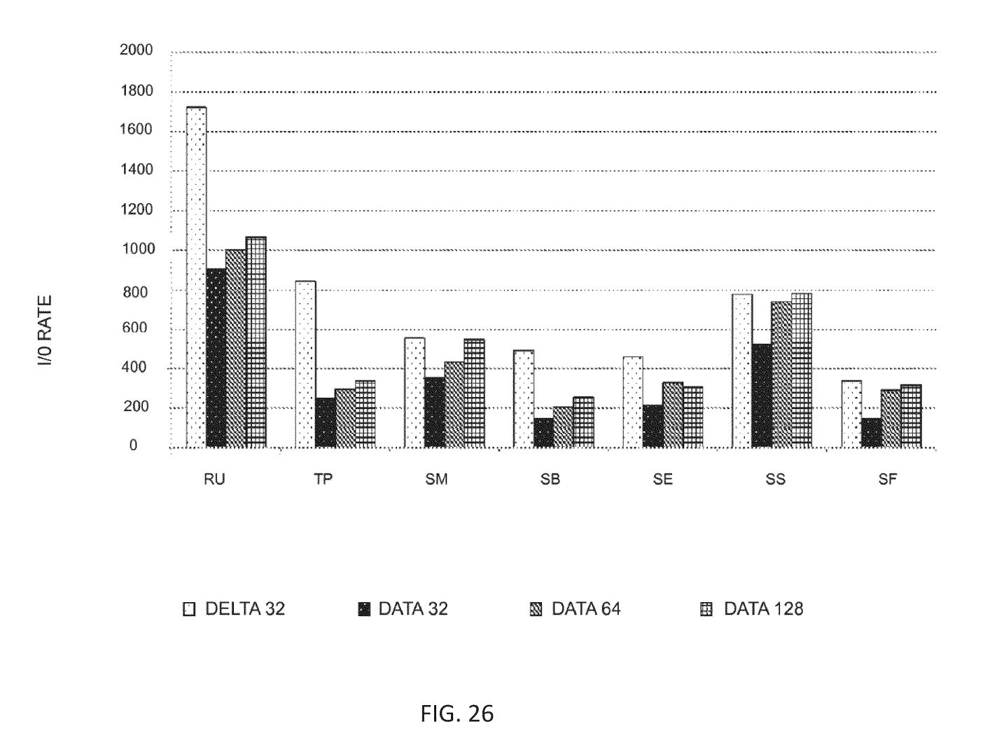

FIG. 26 illustrates measured performance results for four different cases, in accordance with some embodiments of the present disclosure. The cases include: (1) a 32 MB cache to store deltas, (2) a 32 MB cache to store data, (3) a 64 MB cache to store data, and (4) a 128 MB cache to store data. The prototype of the tested embodiment uses a part of system RAM (32 MB) as the DRAM buffer that was supposed to be on a hardware controller board. As discussed previously, there are tradeoffs in managing this DRAM buffer regarding what to cache in the buffer. To quantitatively evaluate the performance impacts of caching different types of data, the I/O rate of the benchmarks was measured by changing the cache contents. As shown in FIG. 26, caching deltas is better than caching data themselves, even though additional computations may be required. For the RUBiS benchmark which shows strong content locality, using 128 MB RAM to cache data performs worse than using 32 MB to cache deltas. Accordingly, FIG. 26 shows a benefit of the tested embodiment.

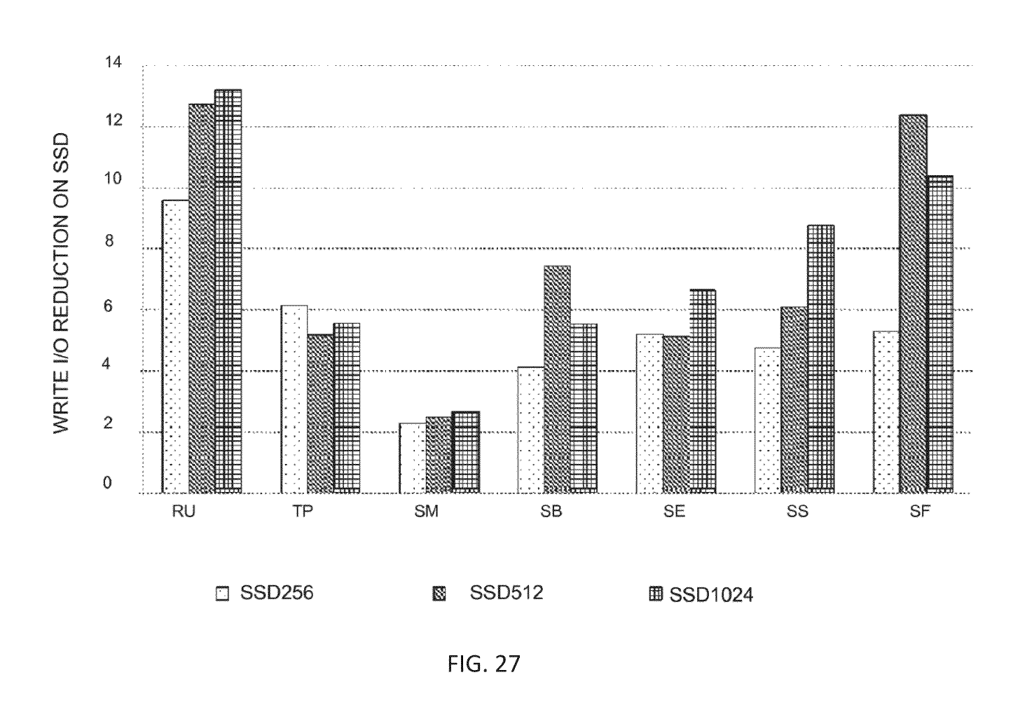

FIG. 27 illustrates a ratio of the number of SSD writes of the baseline system to the number of writes of the I-CASH prototype, in accordance with some embodiments of the present disclosure. Average write I/O reductions of the tested embodiment were compared to the baseline system. Recall that the preliminary prototype does not strictly disallow random writes to SSD as would have been done by a hardware implementation of the tested embodiment. Some independent blocks that do not have reference blocks with deltas smaller than the threshold value (768 byte in the current implementation) may be written directly to the SSD if there is space available. Nevertheless, random writes to SSD may still be substantially smaller than the baseline system. The write reduction ranges from a factor of two to an order of magnitude. Such write I/O reductions imply prolonged life time of the SSD as discussed previously.

The data storage architecture has been presented exploiting the two emerging semiconductor technologies, flash memory SSD and multi-core GPU/CPU. In some embodiments, the intelligent processing unit may include one or more custom ASICs, firmware, other custom hardware, or custom software modules such as device drivers. The disk I/O architecture may include intelligently coupling an array of SSDs and HDDs such that read I/Os are done mostly in SSD and write I/Os to SSD are minimized and done in batches by packing deltas derived with respect to the reference blocks.

By making use of the computing performance of modern GPUs/CPUs and exploiting regularity and content locality of I/O data blocks, some embodiments replace mechanical operations in HDDs with high speed computations. A preliminary prototype realizing partial functionality of the methods and systems described herein has been built on Linux OS to provide a proof-of-concept. Performance evaluation experiments using standard I/O intensive benchmarks have shown great performance potential with up to 4 times performance improvement over systems that use SSD as a storage cache. It is expected that embodiments may dramatically improve data storage performance with fine-tuned implementations and greatly prolong the life time of SSDs that are otherwise wearing quickly with random write operations.

Furthermore, the content locality cache may exploit ever increasing content locality found in a variety of primary storage systems to minimize disk I/O operations that are still a significant bottleneck in computer system performance. A new cache replacement algorithm called Least Popularly Used (LPU) may dynamically identify the reference blocks that may not only have the most access frequency and recency but also may contain information that may be shared or resembled by other blocks being accessed. The LPU algorithms may also leverage methods and systems of caching reference blocks and small deltas to effectively service most disk I/O operations by combining a reference block with a corresponding delta inside the cache as opposed to going to the slow primary storage (e.g. a hard disk). The cache replacement algorithm (LPU) may also be based on a statistical analysis of frequency spectrum of both I/O addresses (e.g. LBAs) and I/O content. Applying a LPU algorithm may also increase a hit ratio of CPU-direct buffer caches greatly for a given cache size through application of content locality considerations in the buffer cache management algorithm. Therefore, embodiments of an LPU algorithm may significantly improve diverse primary storage architectures (RAID, SAN, virtualized storage, and the like) by combining LPU techniques with the various RAM/SSD/HHD cache embodiments described herein. In addition, applying aspects of LPU algorithms to buffer cache management may significantly improve hit ratios without changing or expanding buffer cache memory or hardware.

### Fingerprint Subsignature Comparison and HeatMap

In order to allow any of the caches described herein and elsewhere to take advantage of data access frequency, recency, and information content characteristics, the systems and methods may determine and track both access behavior and content signatures of data blocks being cached. For example, each cache block may be divided into S logical sub-blocks. A sub-signature may be calculated for each of the S sub-blocks. A two dimensional array of sub-signature related data, sometimes referred to herein as a HeatMap, may be maintained in embodiments of an LPU algorithm. The HeatMap may enable determining popularity of the cached data based on aspects of locality (e.g. content locality, temporal locality, spatial locality, and the like).

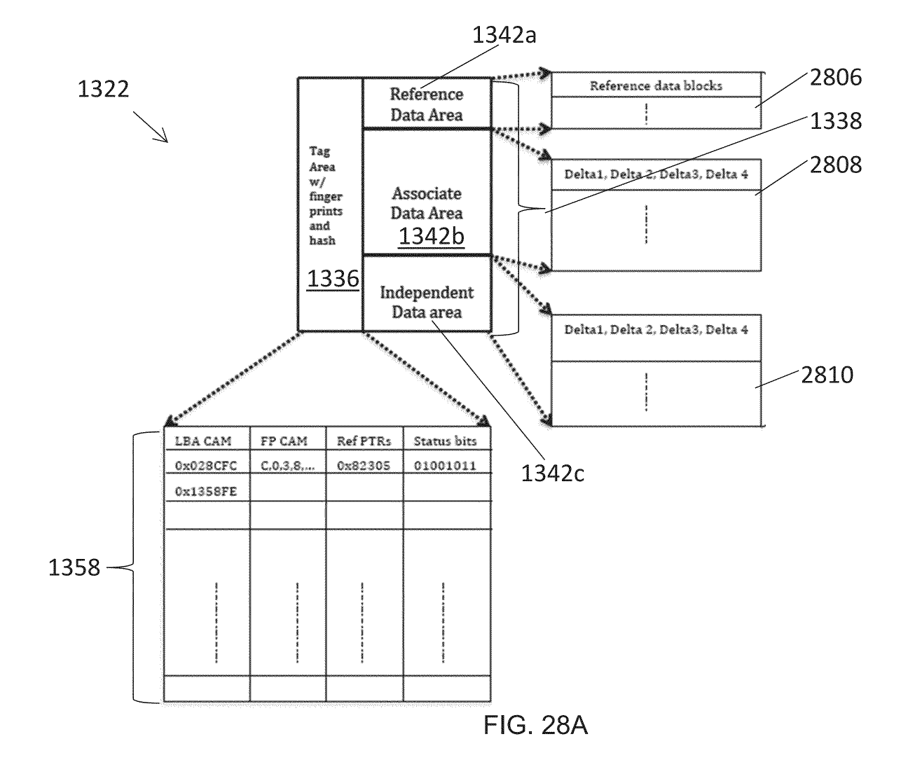

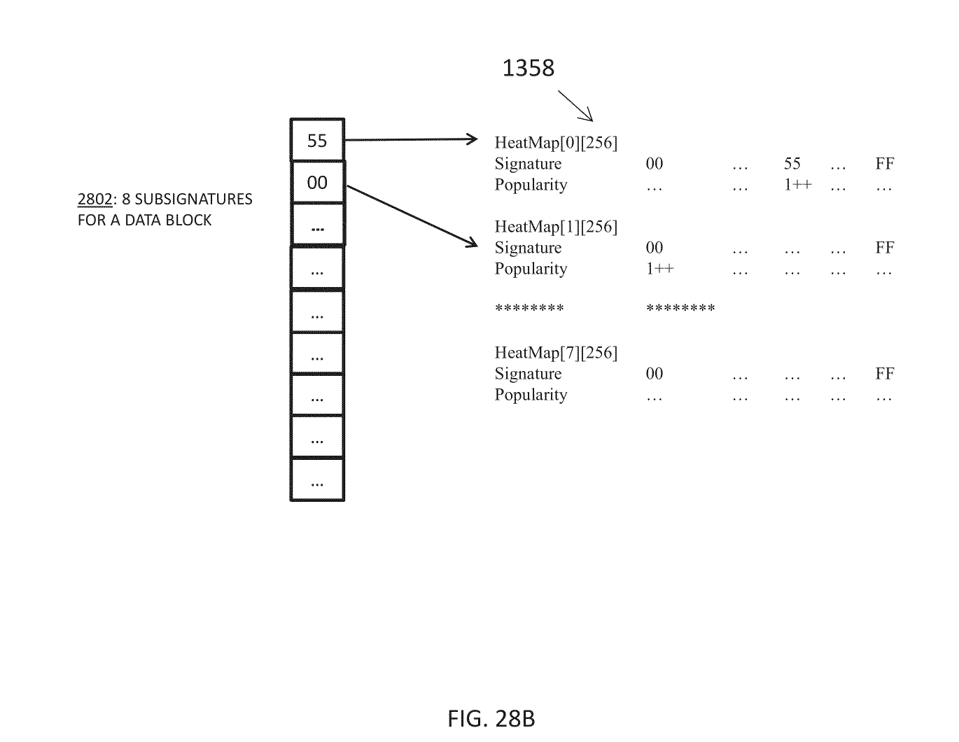

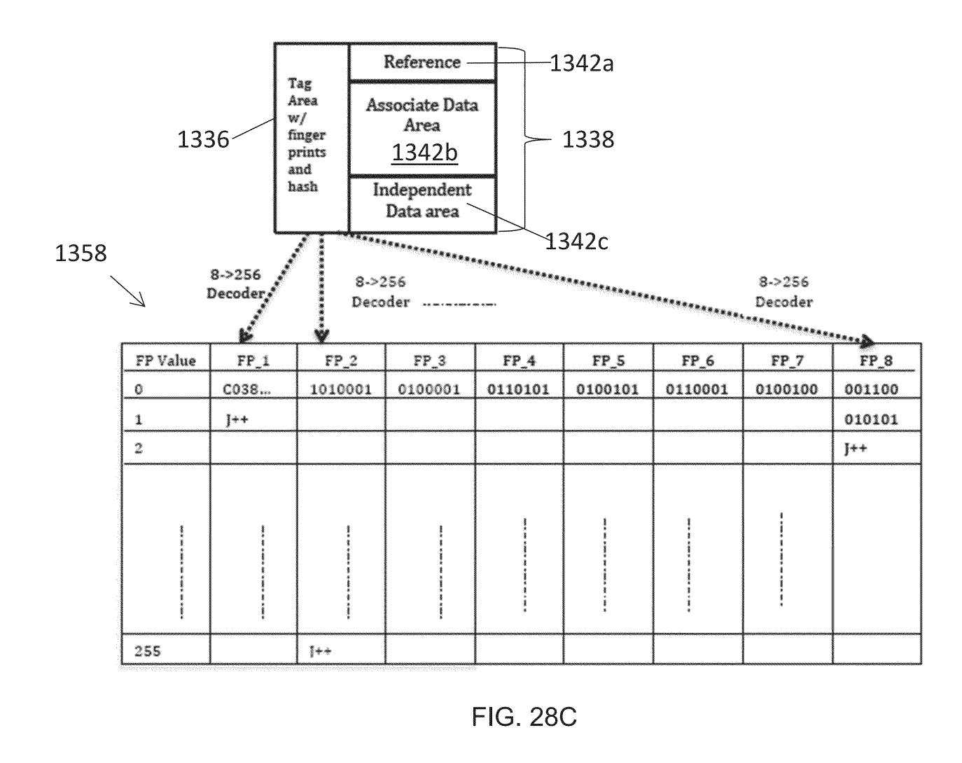

FIG. 28A illustrates a block diagram of an example tag array 1336 and data array 1338 in the content locality based cache, in accordance with some embodiments of the present disclosure. Tag array 1336 includes HeatMap 1358. HeatMap 1358 represents a more detailed example illustration of the contents of tag array 1336. In some embodiments, tag array 1336 can be implemented using content addressable memory (CAM). Tag array 1336 can be addressed based on a logical block address (LBA), or based on a sub-block signature of a fingerprint corresponding to a data block. The present description may also refer interchangeably to sub-block signatures as a subsignature or a subfield of a corresponding fingerprint. Data array 1338 can include reference data area 1342a, associated data area 1342b, and independent data area 1342c. Reference data area 1342a can store reference blocks. Associated data area 1342b can store delta blocks that, when combined with reference blocks from reference data area 1342a, recreate cached contents. Independent data area 1342c can store independent blocks that exhibit temporal locality and/or spatial locality, but do not reference other reference blocks or delta blocks. In some embodiments, tag array 1336 and data array 1338 can use NAND gate flash memory, PCM, or MRAM for storing corresponding contents.

FIG. 28B illustrates examples of sub-block signatures and HeatMap 1358 used in the content locality based cache, in accordance with some embodiments of the present disclosure. Heatmap 1358 can have S rows and Vs columns, where Vs is the total number of possible signature values for a sub-block. For example, if the sub-signature is 8 bits, Vs=256. Each entry in Heatmap 1358 can keep a popularity value. The popularity value can be defined as the number of accesses of the sub-block matching the corresponding signature value. In this example, each data block 2802 can be divided into eight sub-blocks, and eight corresponding signature values are created. In this example, sub-signatures 55 and 0 are shown. When a data block is accessed that contains a sub-signature of 55 for its first logical sub block, the popularity value corresponding to column number 55 of the 1st row can be incremented. Similarly, if a second sub block sub-signature of a data block is 0, then column number 0 of second row can also be incremented. In this way, HeatMap 1358 can track popularity values of all sub-signatures of sub-blocks.

An alternate embodiment of HeatMap 1358 may be organized as a two dimensional array that has columns that correspond to the number of possible signature values and rows that correspond to a number of times that each possible signature value has been accessed during a predetermined period of time.

To illustrate how HeatMap 1358 can be organized and maintained as I/O requests are issued, consider an example where each cache block is divided into two sub-blocks and each sub-signature has only four possible values, i.e. Vs=4. The HeatMap of this example is shown in Table 2 below for a sequence of I/O requests accessing data blocks at addresses LBA1, LBA2, LBA3, and LBA4, respectively. In this example, all of the possible contents of sub-blocks are depicted as A, B, C, and D and the corresponding signature for each sub-block is a, b, c, and d respectively. A two dimensional embodiment of HeatMap 1358 in this case contains two rows corresponding to two sub-blocks of each data block and four columns corresponding to the four possible signature values. As shown in Table 2, all entries of Heatmap 1358 are initialized to {(0, 0, 0, 0), (0, 0, 0, 0)}. Whenever a data block is accessed, the popularities of corresponding sub-signatures in HeatMap 1358 are incremented. For instance, the first block has logical block address (LBA) of LBA1 with content (A, B) and corresponding signatures (a, b) for two sub-blocks. As a result of the I/O request, two popularity values in HeatMap 1358 are incremented corresponding to the two sub-signatures, and HeatMap 1358 becomes {(1, 0, 0, 0), (0, 1, 0, 0)} as shown in Table 2. After 4 requests of various data blocks, HeatMap 1358 becomes {(2, 1, 1, 0), (0, 1, 0, 3)} based on the accumulation of sub-signature occurrences.

TABLE 2
Buildup of an example HeatMap. Each block may
have 2 sub-blocks represented by 2 sub-signatures,
each having 4 possible values Vₛ = 4

| | | | HeatMap[0] | HeatMap[1] |
|---|---|---|---|---|
| I/O sequence | Content | Signature | a b c d | a b c d |
| | | Initialized | 0 0 0 0 | 0 0 0 0 |
| LBA1 | A B | a b | 1 0 0 0 | 0 1 0 0 |
| LBA2 | C D | c d | 1 0 1 0 | 0 1 0 1 |
| LBA3 | A D | a d | 2 0 1 0 | 0 1 0 2 |
| LBA4 | B D | b d | 2 1 1 0 | 0 1 0 3 |

The computation overhead to generate and maintain HeatMap 1358 may be substantially reduced over other data similarity counting techniques. Also, although hashing may be a computation efficient technique to detect identical blocks, it may also lower the chance of finding a similarity because a single byte change results in a totally different hash value. Therefore, hashing by itself may not help in finding more similarities. On the other hand, an LPU algorithm may calculate the secure hash value (e.g. SHA-1) of a data block to determine if a block is identical to another.

In an alternate example of a two-dimensional HeatMap 1358, taking a set of 4 KB blocks divided into 512B sub-blocks with 8 bits sub-signature for each sub-block, HeatMap 1358 with 8 rows corresponding to 8 sub-blocks (8=4K/512) and 256 columns corresponding to all of the possible 8-bit signatures for a sub-block can be used. When a block is read or written, its 8 one-byte sub-signatures may be retrieved and the 8 values of corresponding entries in HeatMap 1358 (also referred to herein as popularity values) may be increased by one. Use of these frequency spectrum aspects of content may differentiate the LPU algorithms from conventional caching algorithms. As noted above, embodiments of the LPU algorithm may capture both temporal locality and content locality of data being accessed by a host processor. If a block of the same address is accessed twice, the increase of a corresponding popularity value in HeatMap 1358 may reflect temporal locality. On the other hand, if two similar blocks with different addresses are each accessed once, HeatMap 1358 can identify the content locality of these two blocks. For example, the popularity values of matching sub-signatures in the two blocks may be incremented in HeatMap 1358. In this way, popularity may be determined based on frequency and recency of a signature associated with active I/O operations. In an example, if a signature is shared by many active I/O blocks, then the signature is popular. In some embodiments, block popularity may be based on block and sub-block signature popularity. A block that contains many popular signatures may be classified as reference block and therefore may be cached and used with the various delta generation and caching techniques described herein. Because many other active I/O blocks may share content with this reference block, the net result is a higher cache hit ratio and more efficient delta compression with respect to many other associated blocks that share such popular sub-signatures.

In some embodiments, to capture the dynamic nature of content locality at runtime, the LPU algorithms may enable scanning cached blocks after a programmable number of I/O requests. This number of I/O requests may define a scanning window. At the end of each scanning window, the LPU algorithm may examine the popularity values in Heatmap 1358 and choose the most popular blocks as reference blocks. An objective of selecting a reference block is to identify a cached data block that may contain most frequently accessed sub-blocks so that many frequently accessed blocks share content with it. The reference block may be selected such that the number of remaining blocks that have small differences (deltas) from the reference block may be maximized. In this way, more I/O requests may be served by combining the reference block with small deltas. Once HeatMap 1358 has been examined at the end of the scanning window, the HeatMap values may be reset to enable variations of popularity over time to influence the LPU algorithm and determination of reference blocks in the cache.

Table 3 illustrates an example calculation of popularity values and cache space consumption using different choices of a reference block for the example of Table 2. The popularity value of a data block may be the sum of all its sub-block popularity values in HeatMap 1358. As shown in Table 3 below, the most popular block is the data block at address LBA3 with content (A, D). Its popularity value is 5. Therefore, block (A, D) may be chosen as the reference block. Once the reference block is selected, the LPU algorithm uses delta-coding to eliminate data redundancy. The result shows that using the most popular block (A, D) as the reference, cache space usage is minimum—about 2.5 cache blocks assuming near-perfect delta encoding. In contrast, without considering content locality, a conventional Least Recently Used caching algorithm would need 4 cache blocks to keep the same hit ratio. The space saved by applying an LPU algorithm may be used to cache even more data.

TABLE 3
Example selection of a reference block. Popularities of all
blocks may be calculated according to a HeatMap of Table 2

| | | | | Reference | | | |
|---|---|---|---|---|---|---|---|
| LBAs | Block | Popularity | LRU | A B | C D | A D | B D |
| LBA1 | A B | 2 + 1 = 3 | A B | A B | A B | _ B | A B |
| LBA2 | C D | 1 + 3 = 4 | C D | C D | C D | C _{—} | C _{—} |
| LBA3 | A D | 2 + 3 = 5 | A D | _ D | A _{—} | A D | A _{—} |
| LBA4 | B D | 1 + 3 = 4 | B D | B D | B _{—} | B _{—} | B D |
| | | Cache space | 4 | 3.5 | 3 | 2.5 | 3 |

FIG. 28C illustrates another example implementation of HeatMap 1358 for use in the content locality based cache, in accordance with some embodiments of the present disclosure. The content locality based cache can include tag array 1336 and data array 1338. Tag array 1336 can include HeatMap 1358.

HeatMap 1358 supports cache management of the content locality based cache. In some embodiments, as described above, HeatMap 1358 can store a frequency and recency of fingerprints that are read and written during I/O operations. If a fingerprint is touched frequently and recently during I/O operations, the content represented by the fingerprint may be considered to be popular. The content locality based cache can determine content locality based on identifying content considered to be popular. If the sketch of a data block contains mostly popular fingerprints, the data block may considered to be popular. The popularity value of data blocks may be used in the cache algorithm. To quantify the popularity of data blocks, HeatMap 1358 can track popularity value for each fingerprint. For example, with a fingerprint of 8 bits, there are 256=2⁸ possible fingerprint values. Accordingly, HeatMap 1358 illustrates an example 8×256 table for 8 fingerprints per sketch. When the content locality based cache processes a received I/O operation, the sketch or the 8 fingerprints of the block may be used to update HeatMap 1358. For example, the 8 fingerprints may be processed using an 8-to-256 decoder to increment the popularity value of the corresponding table entry. As time passes, the higher the popularity value, the hotter the corresponding data content may be considered to be. The hotter the corresponding data content, the more the corresponding data content should stay in the cache to increase a chance of a cache hit. Eventually, the popularity value may reach a maximum that can be represented by the length of each entry. In some embodiments, at that time or after each scanning cycle, all entries in the HeatMap can be decremented by a fixed value to preserve relative popularities among the entries. In further embodiments, HeatMap 1358 may also be reset to all 0's upon the start of a new application program or completion of one application.

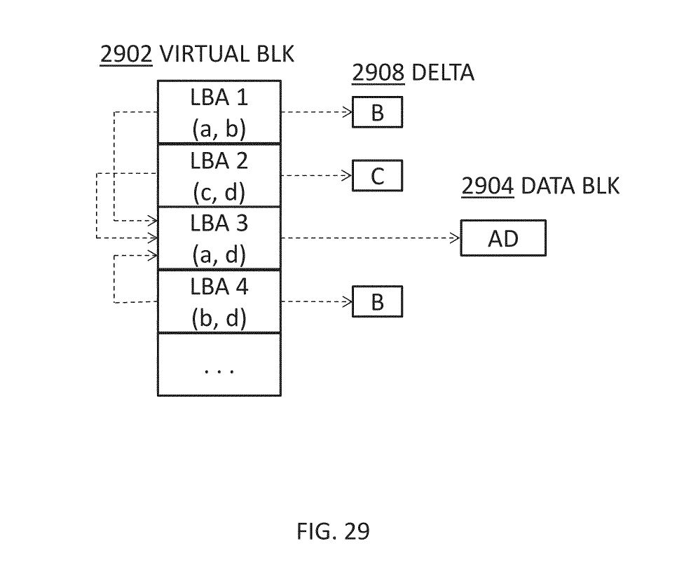

FIG. 29 shows example cache data content after selecting block (A, D) as a reference block in content locality based caching, in accordance with some embodiments of the present disclosure. The LPU method facilitates dividing a cache into three parts: (1) a virtual block list 2902, (2) data blocks 2904, and (3) delta blocks 2908. Virtual block list 2902, referred to as an LPU queue, may store information of cached disk blocks with each entry referencing and/or containing metadata, such as the address, the signature, the pointer to the reference block, the type of block (reference, delta, independent) and the pointer to delta blocks for the corresponding cached data block. However, in some embodiments virtual block list 2902 may be configured to store pointers to virtual blocks rather than include the virtual block data, thereby allowing a large number of virtual blocks to be managed similarly to an LRU queue. The data pointer of a virtual block may be NULL if the disk block represented by this virtual block has been evicted. Some embodiments may manage delta blocks 2908 in 64-byte chunks. A virtual block list entry may reference one or more delta blocks, because incremental changes may have been made to the data addressed by virtual block LBAx. As long as a virtual block list entry references sufficient delta blocks, a virtual block list entry may be retained in the list even if its data block is evicted. In other embodiments, as long as there is sufficient room in the delta block 2908 part of the cache, a virtual block list entry may continue to be used to reference delta blocks even if the data block associated with the virtual block list entry has been evicted from the cache because the data block can be constructed from the various referenced delta blocks and a corresponding reference block.

A virtual block list (VBL) may be used with the LPU algorithm for read and for write requests. Generally upon either a read or write request, the LBA is looked up in the VBL. If the LBA is found, then the type of block is determined from metadata in the corresponding VBL entry. Subsequent actions are generally based on the type of block and the type of request (read or write).

For a read operation, the following actions may be available:
Type=Independent—retrieve the data based on the LBA pointer in the VBL
VBLType=Unmodified Reference—retrieve the data based on the LBA pointer in the VBL
Type=Delta or Reference that has been modified—retrieve the delta and the reference block and generate the requested data

For a write operation, the following actions may be available
Type=Independent—generate a delta and update metadata in the VBL entry that indicates this is a changed block with a delta
VBLType=Reference—generate a delta and update metadata in the VBL entry that indicates this is a changed reference block with a delta
Type=Delta—generate a new delta and update metadata in the VBL entry or change the type to Independent if the delta is too large

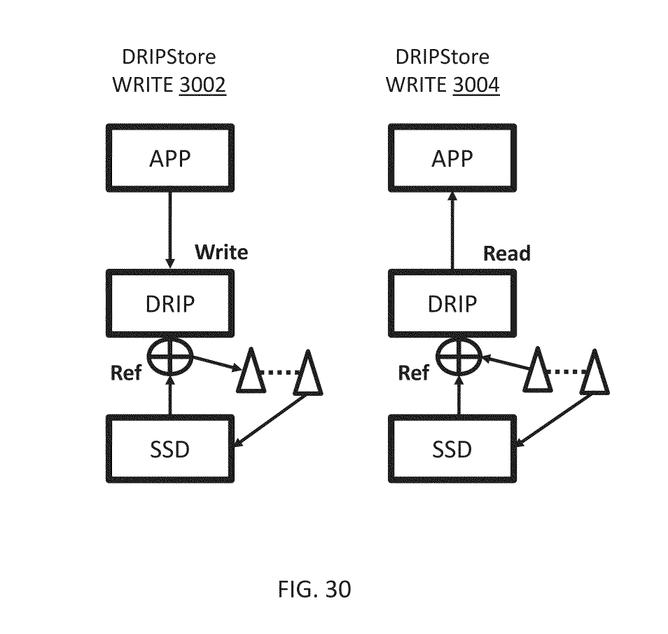

FIG. 30 illustrates an example classification of cached pages into different categories for content locality based caching, in accordance with some embodiments of the present disclosure. For example, cached pages may be classified into three different categories: (1) Delta pages, (2) Reference pages, and (3) Independent pages. When these three categories are targeted for SSD Storage a technique called DRIPStore may enable making best use of high read performance of an SSD while also minimizing SSD write operations. FIG. 30 illustrates a pair of block diagrams showing a read and write process associated with the DRIPStore technique described herein (that may also exploit content locality in optimizing SSD storage design). A reference page category for DRIPStore may be defined as described elsewhere herein and/or may comprise pages that are popular at least because the differences of their content to many other pages can be described by generally small deltas. A delta page category for DRIPStore may be defined as a compacted block of many small deltas and as described elsewhere herein. An independent page category for DRIPStore may comprise the remaining pages that may not share enough similarity with reference pages. Such pages may be called independent pages. A DRIPStore approach may treat pages categorized as Reference pages as read-only which is suitable for storage in RAM and SSD. A DRIPStore approach may also attempt to minimize writes to the SSD by writing only compacted delta pages to SSD or to another portion of cache memory, rather than writing individual deltas to SSD. Each compacted delta page may hold a log or other description of many deltas. Because of potentially strong content access regularity and/or content locality that may exist in data blocks, a compacted or packed delta page may contain metadata describing a potentially large number of small deltas with respect to reference pages, thereby reducing write operations in the SSD greatly. Embodiments of a DRIPStore method may perform similarity detection, delta derivations upon I/O writes, combining delta with reference pages upon I/O reads, and other necessary functions for interfacing the storage to the host OS.

In some embodiments, a delta that may be stored in a delta page may be derived at run time representing the difference between the data page of an active I/O operation and its corresponding reference page stored in RAM or SSD 304 (shown in FIGS. 3A, 3B). Referring now to DRIPStore write flow 3002 of FIG. 30, upon an I/O write, a DRIPStore process may identify a reference page in SSD 304 that corresponds to the desired I/O write page and may compute the delta with respect to the reference page. Similarly in a DRIPSTORE read flow 3004, upon an I/O read, the data block that corresponds to the desired I/O read page may be returned by combining a delta for the I/O read page with its corresponding reference page. Since deltas may be small due to data I/O regularity and content locality, the deltas may be stored in a compact form and consolidated in to a packed delta page so that one write to SSD 304 may satisfy tens or even hundreds of desired write I/Os. A goal of applying DRIPStore may be to convert the majority of primary storage write I/Os to I/O operations involving mainly SSD 304 reads and delta computations. Therefore, DRIPStore may take full advantage of a fast read performance of SSD 304 and may avoid comparatively poor erase/write performance. Further, at least partly because of 1) high speed read performance of reference pages stored in the RAM and the SSD 304, 2) a potentially large number of small deltas packed in one delta page, and 3) high performance CPUs/GPUs, custom ASICs, firmware, or custom hardware, embodiments of DRIPStore may be expected to improve SSD I/O performance greatly.

In further embodiments, a component of the DRIPStore design may be to identify reference pages. To identify reference pages quickly, some embodiments may further divide reference pages into at least two different categories: (1) reference pages that may have exactly the same LBAs as deltas, and (2) data blocks that may be newly generated and may have LBAs that do not match a current reference page stored in SSD 304. The first reference page category may contain reference pages that may have exactly the same LBAs as deltas. An example of a reference page in this first category is a data block that has been modified since it was designated as a reference block; therefore while the reference block may still be useful to the caching system, the physical data to be stored in primary storage requires this reference page to be combined with a delta page. The second category may consist of data blocks that may be newly generated and may have LBAs that do not match any one of the reference pages stored in SSD 304.

To facilitate similarity detection of blocks and/or reference blocks, for each data block, the DRIPStore process described herein may compute block sub-signatures. Generally, a one byte or a few bytes signature may be computed from several sequential bytes of data in data block 408 (shown in FIGS. 4A, 4B). Two pages may be considered similar if they share a minimum number of sub-signatures. However, content similarity between two data blocks may be an in-position match or an out-of-position match. An out-of-position match may be caused by content shifting (e.g. inserting a word at the beginning of a block shifts all remaining bytes down by the word). To efficiently handle both in-position matches and out-of-position matches, a DRIPStore process may use a combination of sub-signatures (e.g. such as those described elsewhere herein) and a histogram of a data page/block. Hash values for every k consecutive bytes of a page may be computed to produce 1-byte or a few bytes sub-signatures. Considering a conventional byte size of eight bits, there are 256=2⁸ possible values for each sub-signature if the sub-signature size is 1-byte. A histogram of all 1-byte hash values in a data page may be summarized into 256 bars corresponding to these possible values of sub-signatures. If sub-signatures include more or less than eight bits, the number of possible values of reach sub-signature may be greater or fewer than 256. From this histogram, one may determine the frequency of occurrences of each sub-signature value in the block. Subsequently, the most frequently occurring sub-signatures may be used to find matches with the most frequent sub-signatures of other pages. The total number of occurrences of each sub-signature in the histogram may be accumulated across all blocks considered, resulting in a list of the degrees of sharing of each sub-signature among all the blocks considered. These degrees of sharing may be used as weights to compute a final popularity value. The block or blocks with the largest popularity value(s) may be selected as one or more reference pages.

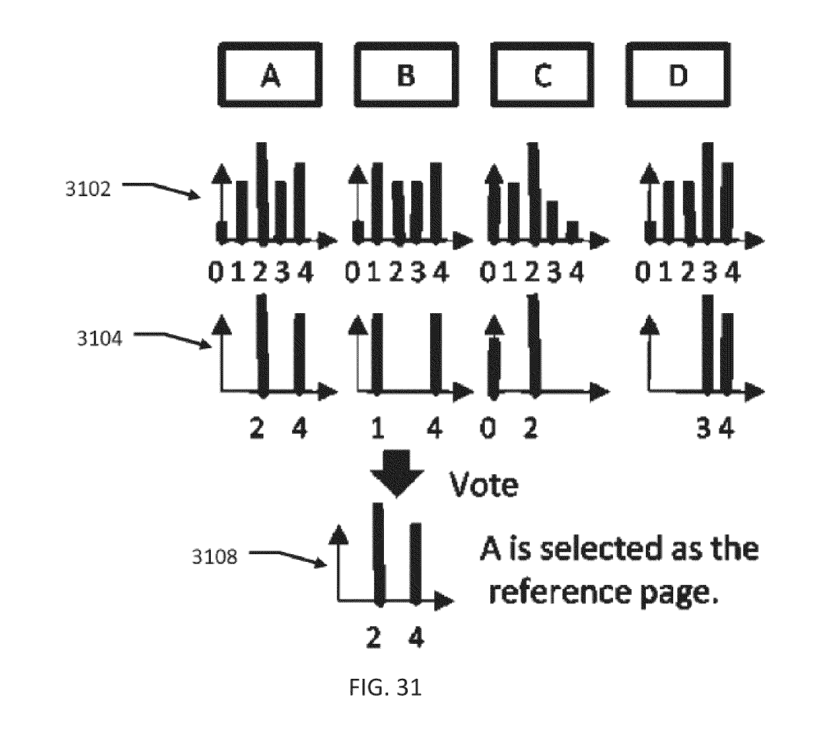

FIG. 31 illustrates an example reference page selection process for content locality based caching, in accordance with some embodiments of the present disclosure. FIG. 31 includes block histogram 3102, block histogram subset 3104, and selected reference page 3108. To see how similarity detection works, consider the following example. Four blocks may be considered to determine which one should be the reference page. Further, for simplicity of explanation, each sub-signature may be any one of 5 different values: 0, 1, 2, 3, and 4. After computing all sub-signatures in each of the 4 blocks, A, B, C, and D, a block histogram 3102 may be derived for each block A, B, C, and D, respectively. Note that there are only 5 bars in each histogram corresponding to the five possible signature values, 0, 1, 2, 3, and 4, respectively. In data block A, the most frequent sub-signature is 2 and the second most frequent is 4. Similarly, in the example the two most frequent sub-signatures in block B may be 1 and 4. In some embodiments, from these four block histograms 3102, the two most frequent sub-signatures for each data block may be picked to create block histogram subset 3104. Block histogram subset 3104 illustrates that among the 4 data blocks, sub-signature 4 appears three times (degree of sharing is 3), sub-signature 2 appears two times (degree of sharing is 2), and sub-signature 0, 1, and 3 appear one time each (degree of sharing is 1). After deriving these degrees of sharing, popularity of each block may be computed by accumulating the degrees of sharing matching each of the sub-signatures in the block diagram subset 3104. In this example, the popularity of block A is 2+3=5 because the degree of sharing of sub-signature 2 is 2 and the degree of sharing of sub-signature 4 is 3. Both signatures 2 and 4 appeared in the block histogram subset 3104 for block A. Similarly, the popularity of block B is 1+3=4, the popularity of block C is 1+2=3, and the popularity of block D is 1+3=4. Block A has the highest popularity value which is 5 and therefore is selected as the reference page depicted in 3108. Blocks B, C, and D all share some sub-signatures with block A, implying that A is resembled by all other three blocks and these three blocks may be compressed with delta coding using block A as reference data.

An exemplary implementation of DRIPStore may compute 1-byte sub-signatures of every 3 consecutive bytes in a data block, i.e. k=3. The DRIPStore process may then select the 8 most frequent sub-signatures for signature matching, i.e. f=8. In an example, for a 4 KB block, the DRIPStore process may first calculate the hash values of all 3 consecutive bytes to obtain 4K−2 sub-signatures. If the number of matches between a block and the reference exceeds 6, this block may be associated with the reference. Based on experimental observations, this sub-signature with position mechanism may recognize not only shifting of content but also shuffling of contents.

The data blocks to be examined for similarity detection may be determined based on performance and overhead considerations. Content locality may exist in a storage system both statically and dynamically. Accordingly, in some embodiments data redundancy may be identified in one of two ways: (1) periodic scanning, and (2) identifying similar blocks online based on cache contents. First, a scanning thread may be used to scan the storage device periodically. A static scan may be easy to implement since data may be fixed and the scan may achieve a good compression ratio by searching for the best reference blocks. However, a static scan may read data from different storage devices and the similar blocks found may not necessarily have tight correlation other than content similarity. The DRIPStore algorithm described herein may take a second approach which may identify similar blocks online from the data blocks already loaded in a cache. For a write I/O, a corresponding reference block for delta compression may be found. If the write I/O were a new write with no prior reference block, a new reference block may be identified for that write I/O. For a read I/O, as soon as the delta corresponding to the read I/O may be loaded, a reference block may be found to decompress to the original data block.

### Cache Management

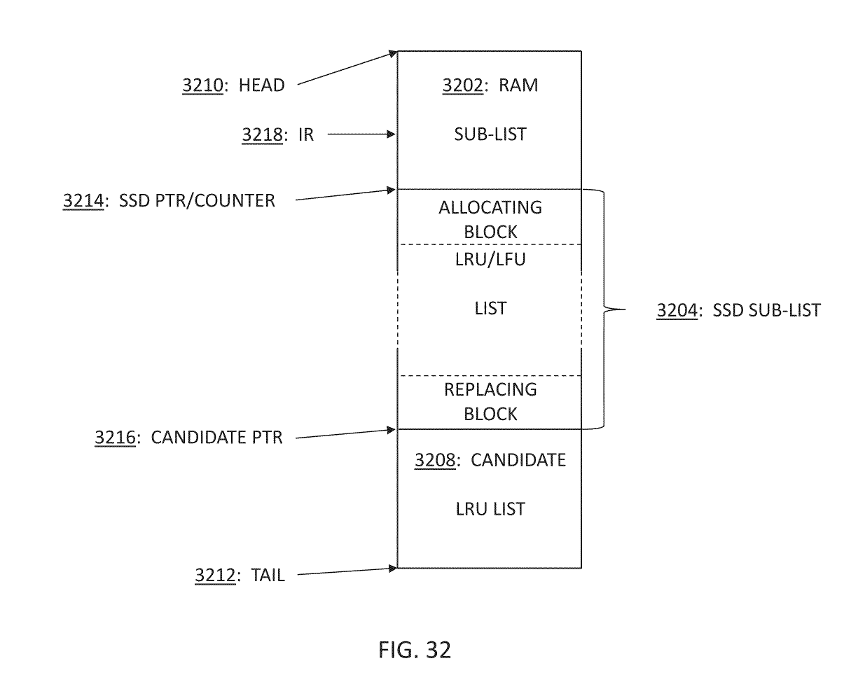

FIG. 32 illustrates an example cache management algorithm for content locality based cache, in accordance with some embodiments of the present disclosure. Some embodiments include an alternative cache management algorithm that may take advantage of the delta compression and other methods described herein. The cache management algorithm may be referred to as conservative insertion and promotion (CIP). FIG. 32 illustrates a block diagram of example CIP list 3200. The CIP cache management algorithm may keep an ordered list of cached data pages similar to the LRU list in traditional cache designs. This ordered list of cached pages may be referred to as CIP-List 3200 in FIG. 32. However, instead of ordering CIP-List 3200 based on access recency, the CIP may conservatively insert a newly referenced page toward the lower end of CIP-List 3200. The CIP may also gradually promote the page in the CIP-List 3200 based on re-reference occurrence metrics. An aspect of the CIP cache replacement algorithm may be to maintain CIP-List 3200 that may include RAM sub-list 3202, SSD sub-list 3204, and a candidate sub-list 3208 as shown in FIG. 32. Upon the first reference to a page, the reference may be inserted in candidate sub-list 3208 and may gradually be promoted to SSD sub-list 3204 and RAM sub-list 3202 as re-references to the page occur. As a result of such conservative insertion and promotion, the CIP cache management algorithm may filter out sweep accesses to sequential data without negatively impacting the cached data while conservatively caching random accesses with higher locality. CIP-List 3200 may implicitly keep access frequency information of each cached page without large overhead of keeping and updating frequency counters. In addition, the CIP may clearly separate read I/Os from write I/Os by sending a batch of read only I/Os or write only I/Os to an SSD NCQ (native command queue) or SQ (submission queue) to maximize the internal parallelism and pipelining operations typically found with SSD storage devices 304 (shown in FIGS. 3A, 3B).

In some embodiments, CIP-List 3200 may be a linked list that may contain metadata associated with cached pages such as pointers and LBAs. Typically, each node in the list may need tens of bytes, resulting in less than 1% space overhead for page size of 4 KB. In addition to a head pointer 3210 and a tail pointer 3212 of the linked list, the CIP adds a SSD pointer 3214 to point at the top of the SSD sub-list 3204 and the candidate pointer 3216 to point at the top of candidate sub-list 3208, respectively.

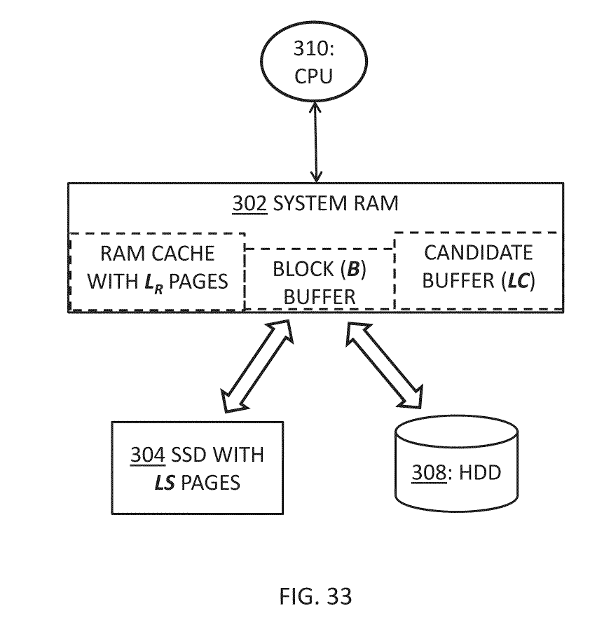

FIG. 33 illustrates an example block diagram of the system including the RAM layout for RAM cache, in accordance with some embodiments of the present disclosure. With reference also to FIG. 32, in an example variable L_{R} may indicate an amount of RAM controlled by RAM sub-list 3202, LS may be the amount of the SSD controlled by SSD sub-list 3204, and LC may be the amount of storage controlled by candidate sub-list 3208. Further, variable B may be the block size of SSD 304 in terms of number of pages. The size of the RAM that the CIP may manage may be computed as L_{R}+LC+B.

There may be three types of replacements in the CIP algorithm. A first replacement may include replacing a page from RAM sub-list 3202 to SSD sub-list 3204. A second replacement may include replacing a page from SSD sub-list 3204 to HDD 308. A third replacement may include replacing a candidate page from candidate sub-list 3208 to HDD 308. These replacements may happen at or near the bottom of each sub-list, similar to the LRU list. That is, the higher position a page is in CIP-List 3200, the more important the page may be and the less likely that it may be replaced. The CIP algorithm may conservatively insert a missed page at the lower part of CIP-List 3200 and may let the missed page move up gradually as re-references to the page occur. This may facilitate managing a multi-level cache that may consider recency, frequency, inter-reference interval times, and bulk replacements in SSD 304.

In embodiments, page reference recency information may be used for managing the cache for many different workloads. This may be why an LRU algorithm has been popular and used in many cache designs. The CIP algorithm may maintain the advantages of LRU design by implementing candidate sub-list 3208, RAM sub-list, or SSD sub-list as a LRU list. Candidate sub-list 3208 may contain pages that may be brought into RAM upon misses or it may contain only metadata of pages that have been missed once or only a few times even though the data is not yet cached. Upon a miss, the metadata of the missed page may be inserted at or near the top of candidate sub-list 3208 and may be given an opportunity to show its importance to stay in the candidate-list until the LCth miss before it may be replaced. If it gets re-referenced during this time, it may be promoted to the top or at least near the top of RAM sub-list 3202. Pages at the bottom of the RAM sub-list are accumulated to form a batch to be written to SSD 304 at which time their metadata is placed in SSD sub-list 3204. The number of re-references, maximum time required between re-references, and other aspects that may impact a decision to promote a page within CIP-list 3200 may be tunable. In this way a page may get promoted if it is re-referenced only twice within a predetermined period of time or it may require several re-references within an alternate predetermined period of time to be tagged for promotion. A promotion algorithm may also depend on block size versus I/O access size so that even when an 8K block is accessed twice due to the I/O access size being 4K, a 4K page stored in the Candidate sub-list may not be promoted upon the second access to the candidate block to retrieve the second 4K page of the 8K block. Since SSD 304 favors batch writes, the SSD write may be delayed until B such pages have been accumulated on top of SSD sub-list 3208. During this waiting period, if the page is re-referenced again, it may be promoted to RAM sub-list 3202 because inter-reference interval time of this page is small showing the importance of the page indicates that it should be cached in the RAM. Therefore, CIP-List 3200 may automatically maintain both recency and inter-reference recency information of cached pages taking advantages of both LRU and LIRS cache replacement algorithms.

In some embodiments, to take into account reference frequency information in managing cache replacement, a new page to be cached in the RAM cache may be inserted at lower part (IR) 3218 of RAM sub-list 3202 and may get promoted one position up in the list upon each reference or upon a configurable number of references. Similarly, in SSD sub-list 3204, any reference (or configurable number of references) may promote the referenced page up by one position (or a configurable number of positions) in CIP-List 3200. As a result of such insertion and promotion policy, the relative position of a page in CIP-List 3200 may approximate the reference frequency of the page. Frequently referenced pages may be unlikely to be evicted from the cache because they may be high up in CIP-List 3200. For RAM sub-list 3202, IR 3218 may be a tunable parameter that may determine how long a newly inserted page may stay in the cache without being re-referenced. For example, if IR 3218 is at the top of CIP-List 3200, it is equivalent to LRU. If IR 3218 is at the bottom of CIP-List 3200, the page may be replaced upon next miss unless it is re-referenced before the next cache miss. Generally, IR 3218 may point at the lower half of RAM sub-list 3202 so that a new page may need to earn enough promotion credits (e.g. have a high reference frequency) to move to the top and yet it may be given enough opportunity to show its importance before it is evicted. For SSD sub-list 3204, insertion may always happen at the top of CIP-List 3200 where B pages may be accumulated to be written into SSD 304 in batches. Once the recently added B pages are written into SSD 304, their importance may depend on their reference frequency since each time a page is referenced its position in the CIP list may be promoted further up the list. The pages at the bottom of the list may not have been referenced for a very long time and hence may become candidates for replacement when SSD 304 is full. The CIP algorithm may try to replace these pages in batches to optimize SSD 304 performance.

In addition to being able to taking into account recency, frequency, and inter-reference recency, the CIP algorithm may help avoid the impact of mass storage scans and other types of mass storage sweep accesses on cached data and may be able to automatically filter out large sequential accesses so that they may not be cached in SSD 304. This may be done by candidate sub-list 3208. Pages in a scan access sequence may not make to the RAM sub-list or SSD sub-list 3204 if they are not re-referenced and therefore may be replaced from the candidate buffer before they can be cached in the RAM or SSD 304. Pages belonging to a large sequential scan accesses may be detected by comparing the LBA of a node in the candidate list and the LBAs of current/subsequent I/Os and using a threshold counter. In embodiments, for cache hits, the algorithm may work in the following manner. If the referenced page, p, is in RAM sub-list 3202 of the CIP-List 3200, p may be promoted by one position up if it is not already at the top of CIP-List 3200. Upon a read reference to page p that may be in SSD sub-list 3204 of CIP-List 3200, p may be promoted by one position up if it is not already among the top of B+1 pages in SSD sub-list 3204. If p is one of the top B+1 pages in SSD sub-list 3204, p may be inserted at the IR position of RAM sub-list 3202. Further, if the size of RAM sub-list 3202 is LR at time of the insertion, the page at the bottom of RAM sub-list 3202 may be demoted to the top of SSD sub-list 3204 and its corresponding data page may be moved from the RAM cache to the block buffer to make room for the newly inserted page. The block counter in the SSD pointer may be incremented. If the counter reaches B, SSD_Write may be performed.

Upon a write reference to page p that is in SSD sub-list 3204 of CIP-List 3200, p may be removed from SSD sub-list 3204 and inserted at IR 3218 position of RAM sub-list 3202. If the size of RAM sub-list 3202 is LR at time of the insertion, the page at the bottom of RAM sub-list 3202 may be demoted to the top of SSD sub-list 3204 and its corresponding data page may be moved from the RAM cache to the block buffer to make room for the newly inserted page. The block counter in the SSD pointer may be incremented. If the counter reaches B, SSD_Write may be performed. In addition, if the referenced page, p, is in candidate sub-list 3208 of CIP-List 3200, p may be inserted at the top of SSD sub-list 3204 and the corresponding data page may be moved from the candidate buffer to the block buffer. The counter in the SSD pointer may be incremented. If the counter reaches B, SSD_Write may be performed.

In another embodiment, for cache misses, the algorithm may work in the following manner. If RAM cache is not full, the missed page p may be inserted at the top of RAM sub-list 3202 and the corresponding data page is cached in the RAM cache. If RAM cache is full, the missed page p may be inserted at the top of candidate sub-list 3208 and the corresponding data page may be buffered in the candidate buffer or not cached at all. If the candidate buffer is full, the bottom page in candidate sub-list 3208 may be replaced to make room for the new page.

An SSD_Write may proceed as follows. If SSD is full, i.e. SSD sub-list 3204 size equals LS, the CIP algorithm may destage the bottom B pages in SSD sub-list 3204 to HDD 308. Only dirty destaged pages need to be read from SSD 304 and written to HDD 308. Next, the CIP algorithm may perform SSD writes to move all dirty data pages in the block buffer to SSD 304 followed by clearing the block buffer and the block counter in the SSD pointer of the CIP-List.

Similarly, some embodiments may use a linked list or a simple table (i.e., array structure) for the candidate list. The table may be hashed by using LBAs. Each entry may keep a counter to count a number of cache misses that have occurred since the entry was added to the candidate list so that the corresponding data may be promoted to be cached once its counter exceeds a threshold. Exceeding such a threshold may indicate that data in the cache is stale and therefore performance may be improved by promoting candidate data to the cache to replace stale data. Each entry may also be configured with a timer that impacts a re-reference counter for the entry. The re-reference counter may be reset to 0 once the time interval, determined by the timer, between two consecutive accesses (successive re-references) to the same block exceeds a predetermined value. This interval between references may be calculated on each I/O access to the same block by subtracting the current I/O access time-of-day and previously stored access time-of-day value in the corresponding table entry.

Each sub-list of CIP-list 3200 may include some overlapping pages. In an example, some of the pages in the RAM-list may also exist in the SSD list because a page in the SSD may have been promoted to the RAM and the page in SSD may be unaffected until other pages are promoted to the SSD-sublist. This may not pose any significant problem because a RAM list may be checked for presence of a page before an SSD list is checked.

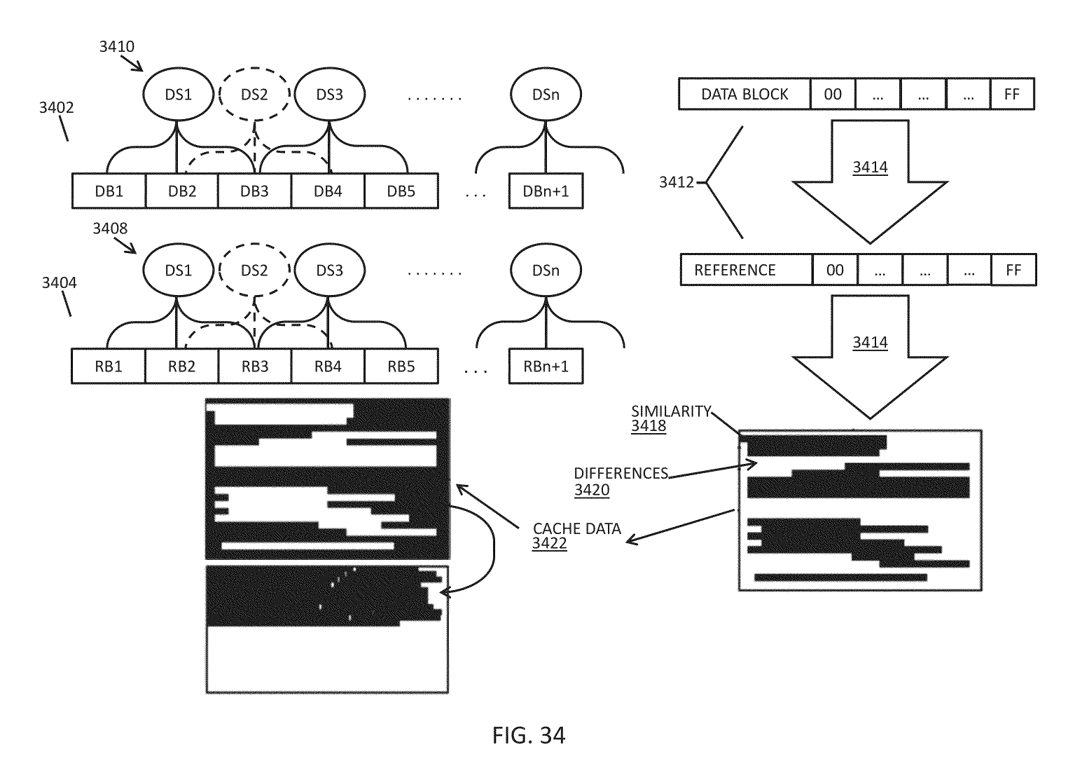

FIG. 34 illustrates a block diagram of example compression/de-duplication in content locality based caching, in accordance with some embodiments of the present disclosure. The compression/deduplication may run in a cache subsystem of a data storage system that facilitates line-speed, software-based, low CPU-overhead, block level, pre-cache similarity-based delta compression is presented. Signatures as described herein may be computed for at least one data block 3402 (DBn) and at least one reference block 3404 (RBn). Both reference block signatures 3408 (RSx) and data block signatures 3410 (DSx) may computed based on three or more adjacent bytes in the respective block. A plurality of data block signatures (DSx) and reference block signatures (RSx) may be generated and aggregated 3412 to facilitate comparison 3414. Various techniques for aggregation are described herein and any such technique may be applicable. Comparing reference block signatures (RSx) with data block signatures (DSx) may result in determining data in the data block 3402 that is similar to the reference block (Similarity 3418). From this determination of similarity, differences 3420 may also be determined and those differences 3420 may be made available or storing in a cache as cache data 3422. This cache data 3422 may be packed into a packed cache block 3424 prior to being stored in a data cache.

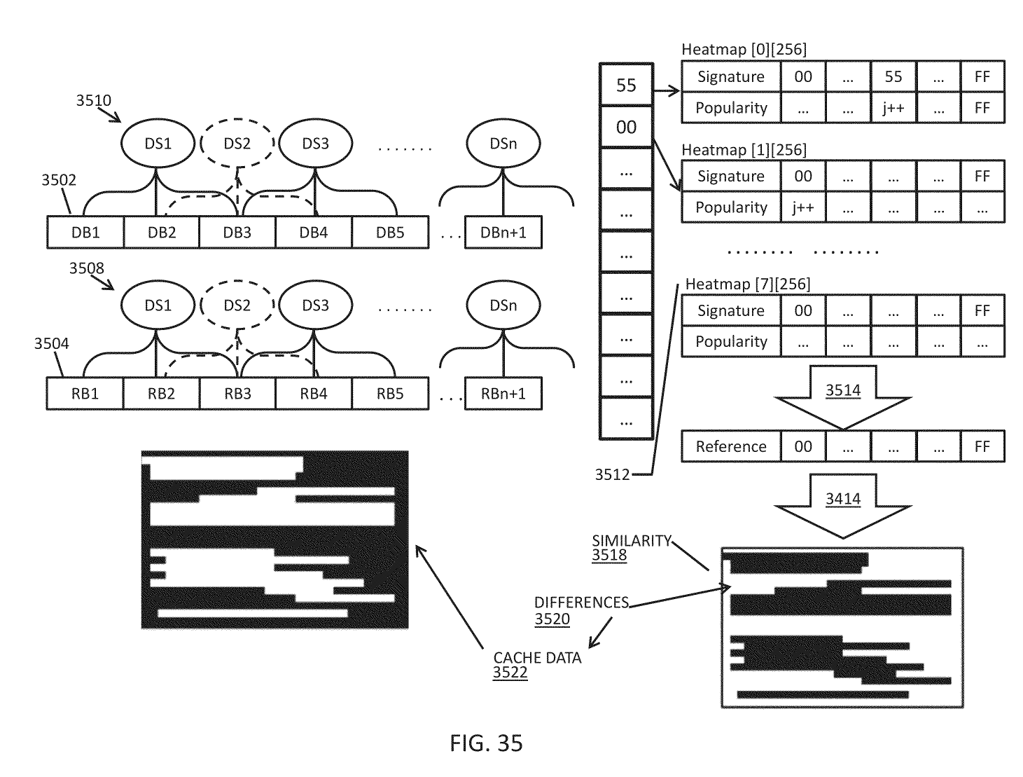

FIG. 35 illustrates a block diagram of another example compression/de-duplication in content locality based caching, in accordance with some embodiments of the present disclosure. The method of compression/de-duplication in a cache subsystem of a data storage system facilitates line-speed, software-based, low CPU-overhead, block level, pre-cache similarity-based delta compression. In contrast to FIG. 34, FIG. 35 illustrates use of HeatMap 3512 to assist in compression and deduplication. Signatures as described herein are computed for at least one data block 3502 (DBn) and at least one reference block 3504 (RBn). For example, both reference block signatures 3508 (RSx) and data block signatures 3510 (DSx) may be computed based on three or more adjacent bytes in the respective block. A plurality of data block signatures (DSx) and reference block signatures (RSx) are generated and aggregated using HeatMap 3512 as described herein to facilitate calculating popularities of signatures 3514. The popularity value of each signature may be updated upon each I/O. Accumulating popularity values of data block signatures (DSx) based on HeatMap 3512 may facilitate determining which data block 3502 has sufficient popularity to be used as a reference block (similarity 3518). Likewise through determination of similarity, differences 3520 may also be determined and differences 3520 may be made available or storing in a cache as cache data 3522. Cache data 3522 may be packed into a packed cache block 3524 prior to being stored in a data cache.

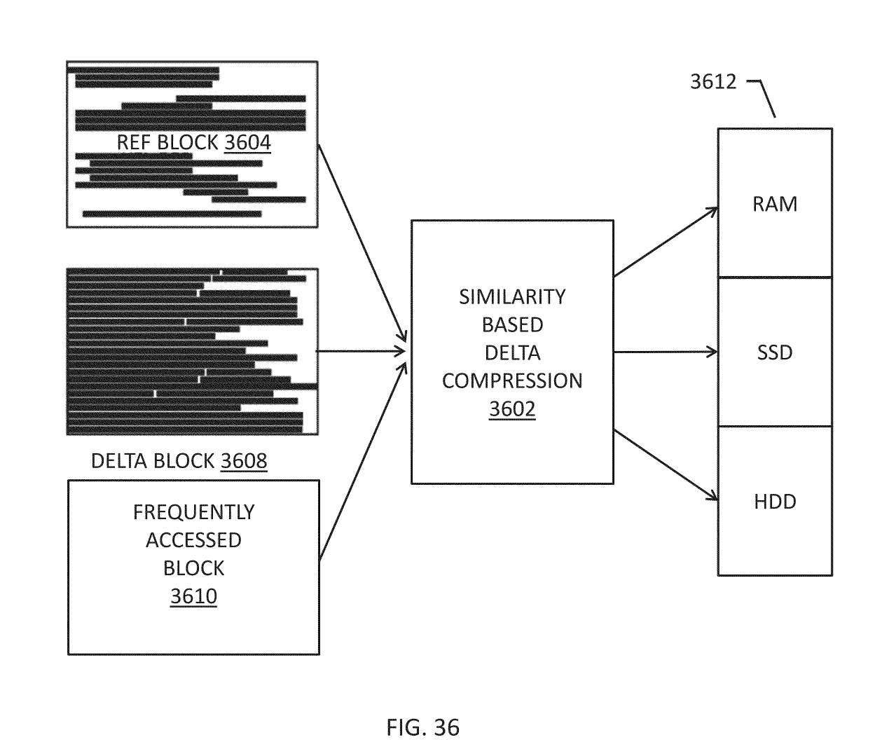

FIG. 36 illustrates a block diagram of example storage of data in a cache memory of a data storage system that is capable of similarity-based delta compression 3602, in accordance with some embodiments of the present disclosure. A cache system that is capable of similarity-based delta compression 3602, such as by way of example those depicted in FIGS. 34 and 35 may choose among a plurality of types of data blocks to determine data to be stored in a cache memory system 3612. For example, the similarity-based delta compression capable cache system 3602 may receive any number of reference blocks 3604, packed delta blocks 3608, frequently accessed blocks 3610, or other types of data for caching. The system may apply the various techniques described herein to determine a location for storing the received data. The various techniques include without limitation, signature based comparison, similarity-based delta compression, content locality, temporal locality, spatial locality, signature popularity, block popularity, sub-signature frequency, sub-signature popularity, conservative insertion and promotion, location of similar data blocks, type of data block, and the like. Based on the determination of a location for storing the received data, the system 3602 may store any of the received reference blocks, packed delta blocks, and frequently accessed blocks in any portion of the cache memory 3612.

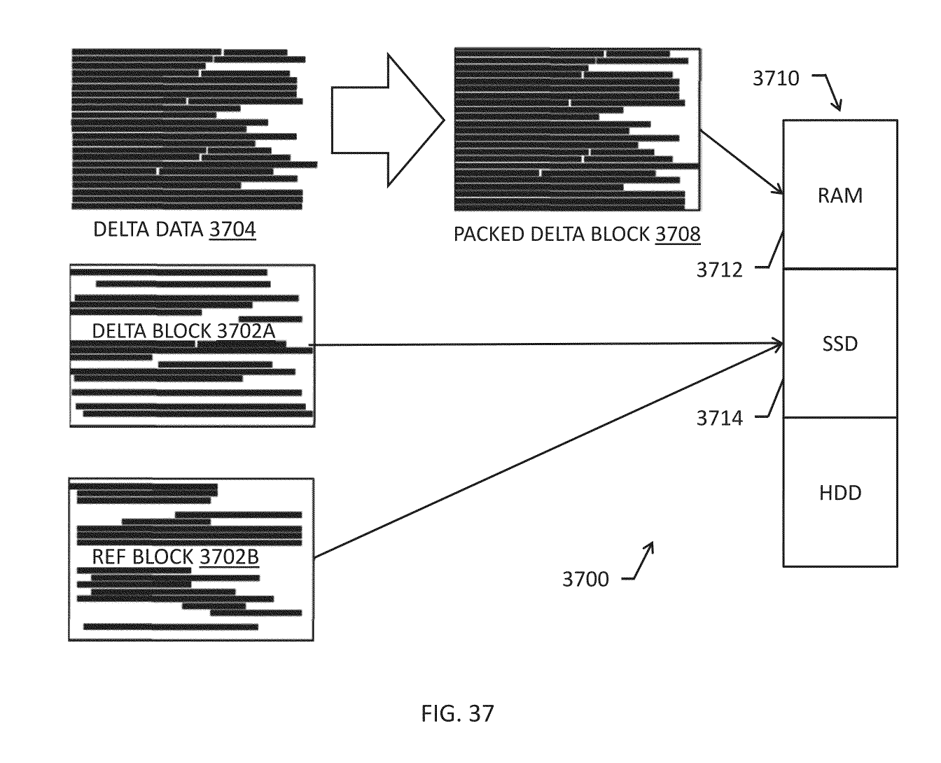

FIG. 37 illustrates a block diagram of example differentiated data storage in a cache memory system 3700 that comprises at least two different types of memory, in accordance with some embodiments of the present disclosure. Data placement of reference blocks 3702 and difference data 3704 representing differences between reference blocks 3702 and data blocks may be determined. For example, reference blocks 3702 may be received and stored in first portion 3714 of a cache data storage system 3710. Difference data 3704 representing differences between reference blocks 3702 and data blocks may be provided to cache system 3700 as a packed delta block 3708 for storage in second portion 3712 of cache memory 3710 that does not comprise SSD memory. Although FIG. 37 depicts first portion 3714 as SSD type memory, first portion 3714 may be SSD, RAM, HDD, or any other type of memory suitable for high performance caching. Also, although FIG. 37 depicts second portion 3712 as RAM type memory, second portion 3712 may be RAM, HDD or any other type of memory that is suitable for high performance caching except for SSD type memory.

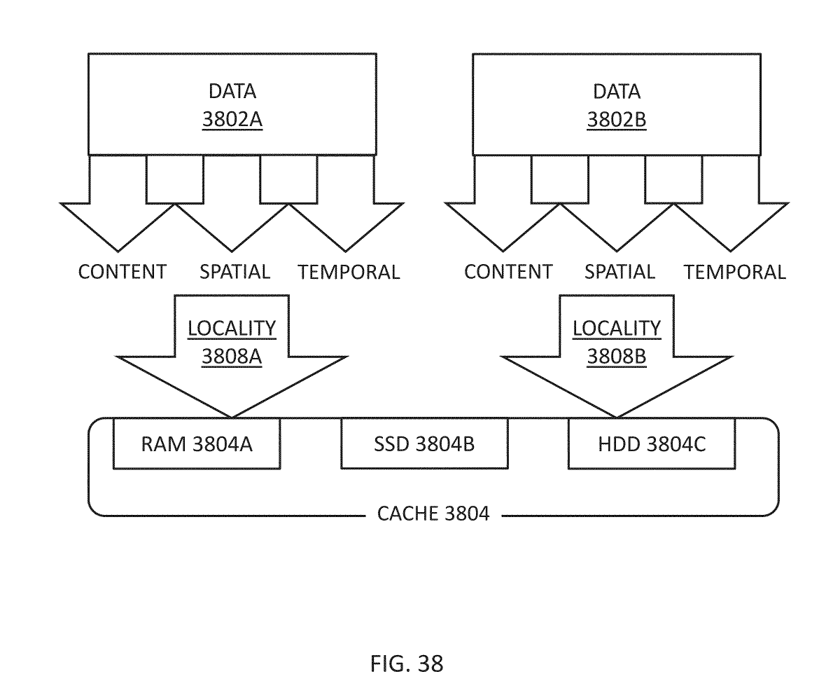

FIG. 38 illustrates a block diagram of example caching based on data content locality, spatial locality, or data temporal locality, in accordance with some embodiments of the present disclosure. Data may be presented to a cache system that is capable of determining content locality, spatial locality and/or temporal locality of the data. Based on the determined content locality, spatial locality and/or the determined temporal locality, data may be placed in various portions of a cache memory system, such as HDD portion, SSD portion, RAM portion, and the like. For example, data 3802A and data 3802B may be presented to a cache memory system that is capable of determining content, spatial and/or temporal locality of the data. Determined content, spatial, and/or temporal locality 3808A of data 3802A may indicate that data 3802A may be suitable for being stored in RAM portion 3804A of a cache 3804. Likewise, determined content spatial, and/or temporal locality 3808B of data 3802B may indicate that data 3802B may be suitable for being stored in an SSD portion 2904B of a cache 3804. Determination of which portion of cache 3804 to use for storing data 3802A or 3802B may be based on the methods and systems described herein for spatial, temporal and/or content locality-based caching. Further, in an example, data that has any combination of high spatial, temporal or content locality may be stored in RAM or SSD, whereas data that has average spatial, temporal and content locality may be stored in SSD, HDD or another portion of cache 3804 or may not be stored in the cache 3804 at all. Although content, spatial, and temporal locality are used to indicate which portion of a cache is suitable for storing data, other techniques described herein may also be used to indicate which portion of a cache is suitable for storing data.

### Sub-Signature Algorithm Selection

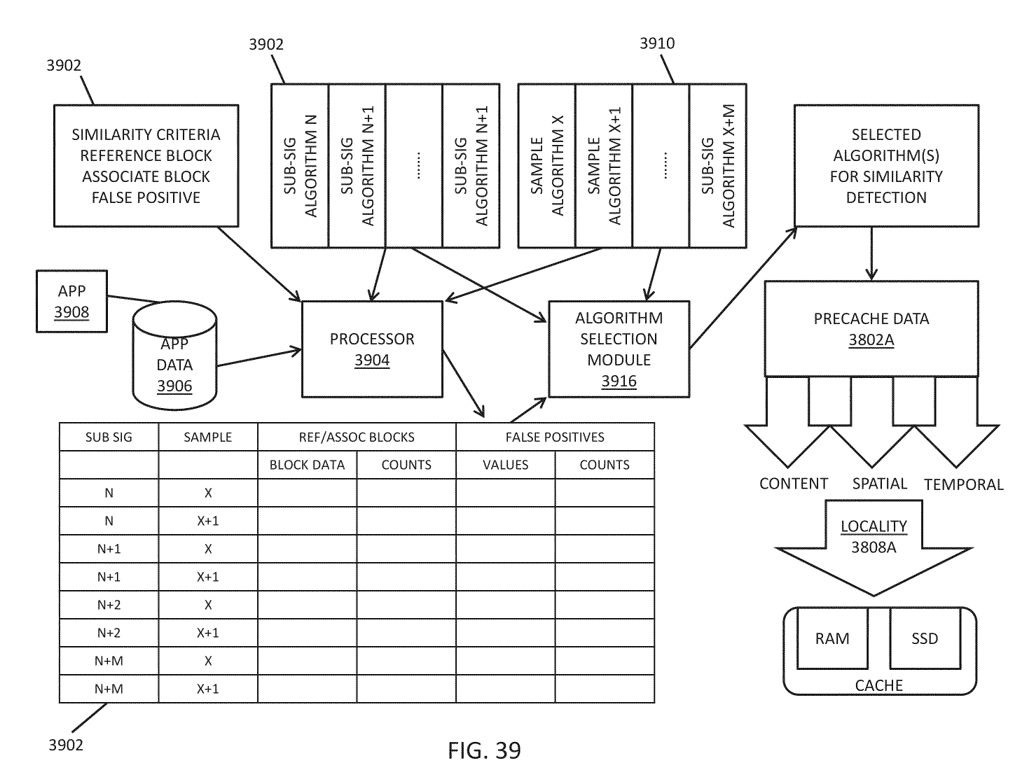

FIG. 39 illustrates a block diagram of example similarity detection of data, such as data associated with an application, in accordance with some embodiments of the present disclosure. In an example, a plurality of distinct sub-signature calculation algorithms such as a sub-sig algorithm N, a sub-sig algorithm N+1 up to and including a sub-sig algorithm N+M (collectively referred to as a sub-sig algorithms 3902) may be presented to processor 3904. Processor 3904 may be configured to generate a set of sub-signatures for the data for each of the distinct sub-signatures calculation algorithms for data 3906 that may be associated with application 3908. Further, a plurality of sampling algorithms 3910 may be accessed by processor 3904 to sample each of the sets of sub-signatures with two or more sub-signature sampling algorithms. In an example, each set of sub-signatures may be sampled using two sub-signature sampling algorithms, namely, sub-signature algorithm X and sub-signature algorithm X+1. Processor 3904 may be configured with similarity-detection criteria 3916 to determine and store in a processor accessible memory 3912 reference blocks and associated blocks for each of the sampled sets of sub-signatures. Further, processor 3904 may calculate and store in a processor accessible memory based on the similarity-detection criteria 3916 false positives for each of the sampled sets of sub-signatures. In response to the aforementioned steps performed using processor 3904, an algorithm selection module 3916 may be configured to select a sub-signature calculation algorithm from the plurality of distinct sub-set signature calculation algorithms and one of the at least two sub-signature sampling algorithms. The selected sub-signature calculation algorithm and the selected sub-signature sampling algorithm may produce (1) the largest number of reference and associated blocks and/or (2) the smallest number of false positives for performing similarity detection of data, such as data that is associated with the application.

The methods for sub-signature related algorithm selection described herein may calculate a plurality of sub-signatures for each distinct sub-signature calculation algorithm (e.g. sub-sig N, sub-sig N+1, sub-sig N+2 and sub-sig N+M 3902) for a portion of data 3906 associated with application 3908. In an example, distinctly calculated sub-signatures may be sampled using at least two distinct sub-signature sampling algorithms 3910. Further, counts of reference blocks and associated blocks for each of the sampled sets of distinctly calculated sub-signatures may be determined and stored in the processor accessible memory 3912. For further facilitating similarity-based detection, counts of false positives for each of the sampled sets of distinctly calculated sub-signatures may be calculated and stored in the processor accessible memory 3912. The stored counts (reference and associated, and false positives) may be analyzed to result in selecting a distinct combination of a sub-signature calculation and a sampling algorithm. The selected sub-signature sampling algorithms produces at least one of the largest count of reference and associated blocks and the smallest count of false positives for performing similarity detection of data associated with the application.

FIG. 40 illustrates a flowchart of an example method 4000 of performing similarity detection of data associated with an application, in accordance with some embodiments of the present disclosure. In an example, at loop 4002, method 4000 may use a processor to perform following steps for each of a plurality of distinct sub-signature calculation algorithms. Method 4000 may use the processor to generate a set of sub-signatures for data associated with an application using a first of the plurality of sub-signature calculation algorithms (step 4004). Method 4000 may use the processor to sample the set of sub-signatures with at least two sub-signature sampling algorithms (step 4006). Method 4000 may use the processor to determine and store in a processor accessible memory reference and associated blocks for the sampled set of sub-signatures (step 4008). Method 4000 may use the processor to calculate and store in a processor accessible memory false positives for the sampled set of sub-signatures (step 4010). Method 4000 at loop 4002 may repeat steps 4004 through 4010 for each distinct sub-signature calculation algorithm in the plurality of distinct sub-signature calculation algorithms. At 4012, method 4000 may select a sub-signature calculation algorithm from the plurality of distinct sub-set signature calculation algorithms and one of the at least two sub-signature sampling algorithms that produce (1) the largest number of reference and associated blocks and/or (2) the smallest number of false positives for performing similarity detection of data associated with the application.

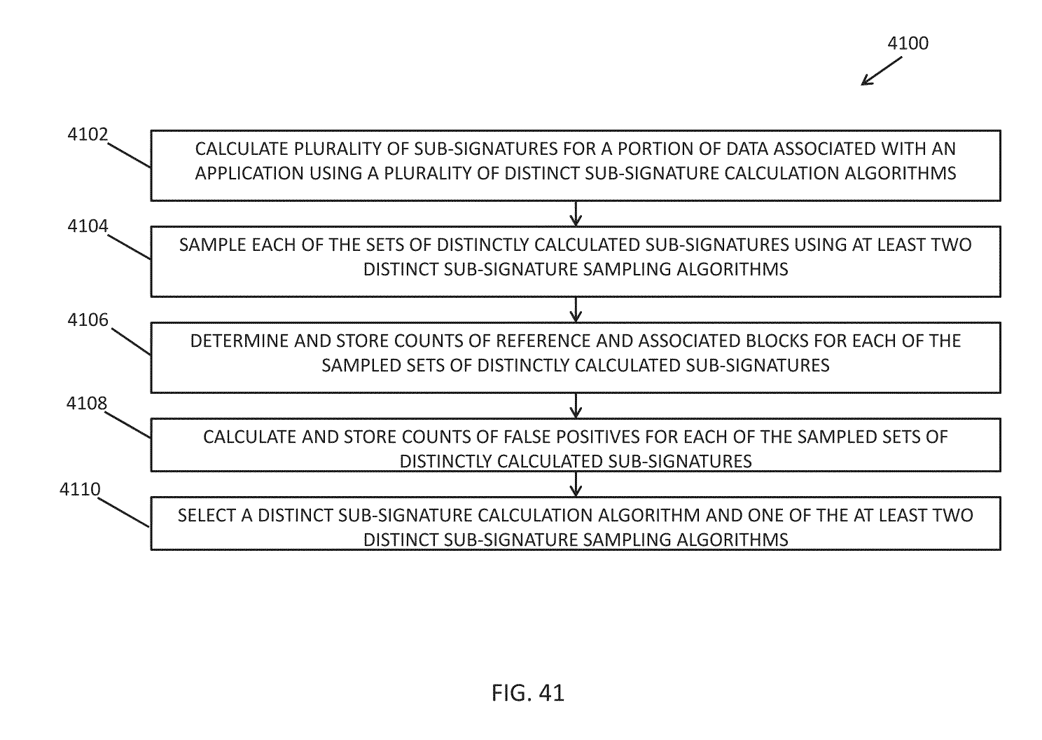

FIG. 41 illustrates a flowchart of another example method 4100 of performing similarity detection of data associated with an application, in accordance with some embodiments of the present disclosure. Method 4100 may calculate a plurality of sub-signatures for a portion of data associated with an application using a plurality of distinct sub-signature calculation algorithms (step 4102). As a result, sets of distinctly calculated sub-signatures may be generated. Method 4100 may sample each of the sets of distinctly calculated sub-signatures using at least two distinct sub-signature sampling algorithms (step 4104). Method 4100 may determine and store in a processor accessible memory counts of reference and associated blocks for each of the sampled sets of distinctly calculated sub-signatures (step 4106). Method 4100 may calculate and store in a processor accessible memory counts of false positives for each of the sampled sets of distinctly calculated sub-signatures (step 4108). Method 4100 may select a distinct sub-signature calculation algorithm and one of the at least two distinct sub-signature sampling algorithms (step 4110). The selected sub-signature calculation algorithm and selected sub-signature sampling algorithms may produce (1) the largest count of reference and associated blocks and/or (2) the smallest count of false positives for performing similarity detection of data associated with the application.

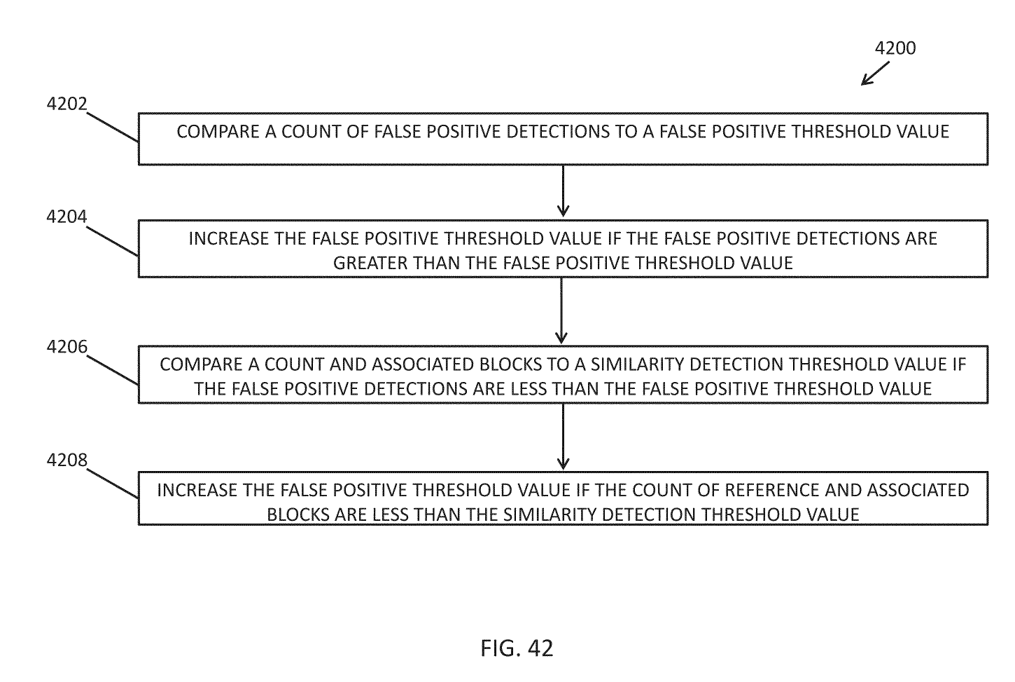

FIG. 42 illustrates a flowchart of an example method 4200 of dynamically setting a similarity threshold based on false positive, reference block, and associated block detection performance, in accordance with some embodiments of the present disclosure. Method 4200 may compare a count of false positive detections that are generated by a similarity detection algorithm to a false positive threshold value (step 4202). Method 4200 may increase the false positive threshold value if the false positive detections are greater than the false positive threshold value (step 4204). If the false positive detections are less than the false positive threshold value, method 4200 may compare a count of reference and associated blocks identified by the similarity detection algorithm to a similarity detection threshold value (step 4206). If the count of reference and associated blocks are less than the similarity detection threshold value, method 4200 may increase the false positive threshold value (step 4208).

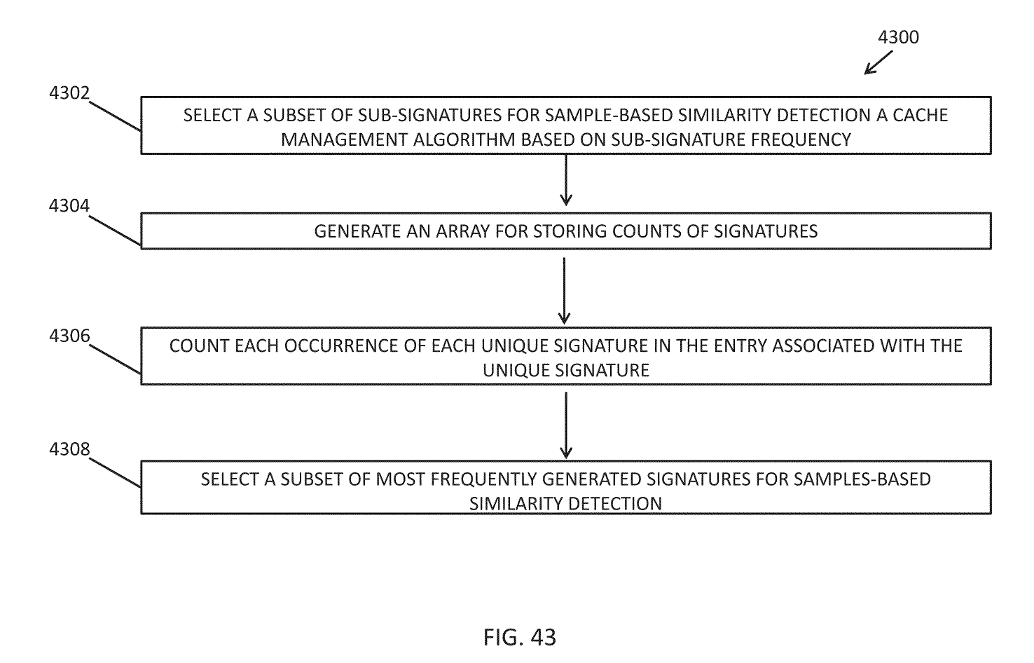

FIG. 43 illustrates a flowchart of an example method 4300 of selecting a subset of most frequently generated signatures, in accordance with some embodiments of the present disclosure. For example, method 4300 may select a subset of sub-signatures for sample-based similarity detection in a cache management algorithm based on a sub-signature frequency (step 4302). Method 4300 may generate an array for storing counts of signatures, wherein each entry in the array is identifiable by a unique signature (step 4304). Method 4300 may count each occurrence of each unique signature in the entry associated with the unique signature, such as while calculating signatures in a similarity detection algorithm, such as for a cache management algorithm (step 4306). Method 4300 may select a subset of most frequently generated signatures for sample-based similarity detection, wherein selection is based on count of signature occurrence in the array (step 4308).

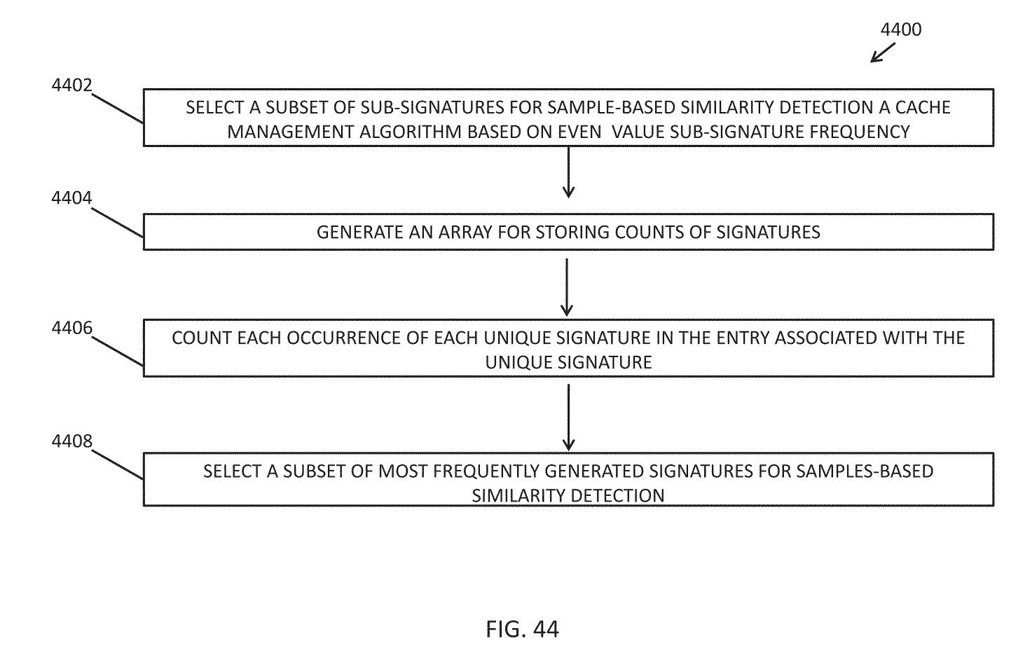

FIG. 44 illustrates a flowchart of an example method 4400 of selecting a subset of most frequently generated even signatures, in accordance with some embodiments of the present disclosure. For example, method 4400 may include selecting a subset of sub-signatures for sample-based similarity detection in a cache management algorithm based on even value sub-signature frequency (step 4402). Method 4400 may generate an array for storing counts of signatures, wherein each entry in the array is identifiable by a unique signature (step 4404). Method 4400 may count each occurrence of each unique even signature in the entry associated with the unique signature (e.g., while calculating signatures in a cache management similarity detection algorithm) (step 4406). Method 4400 may select a subset of most frequently generated even signatures for sample-based similarity detection, wherein selection is based on count of signature occurrence in the array (step 4408).

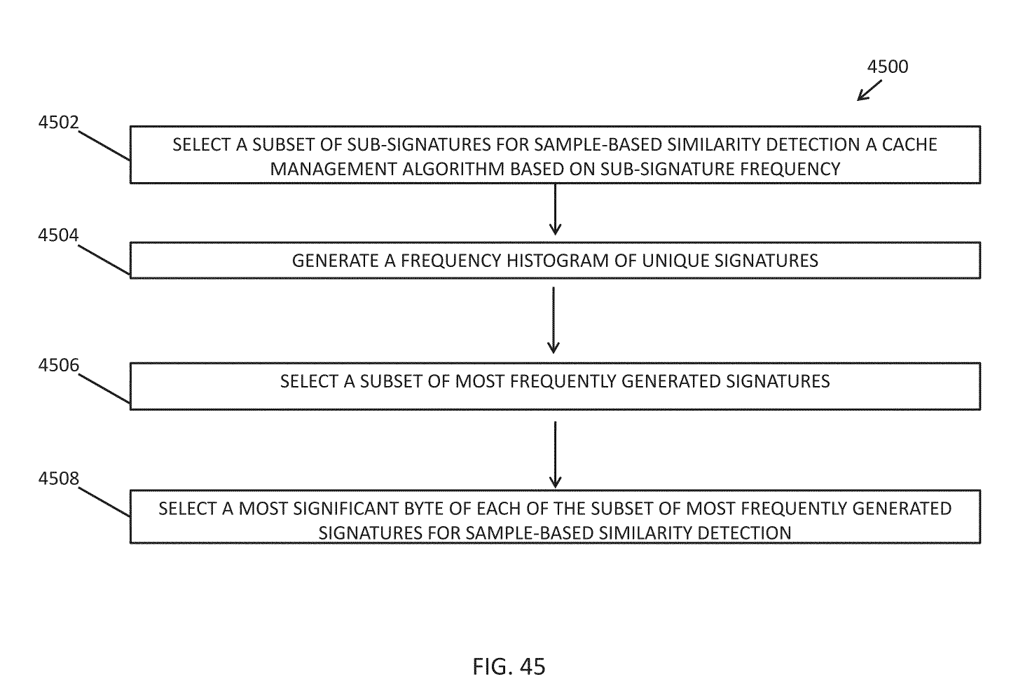

FIG. 45 illustrates a flowchart of an example method 4500 of selecting a most significant byte of each of the subset of most frequently generated signatures, in accordance with some embodiments of the present disclosure. Method 4500 may include selecting a subset of sub-signatures for sample-based similarity detection in a cache management algorithm based on sub-signature frequency (step 4502). Method 4500 may generate a frequency histogram of unique signatures while calculating the signatures in a cache management similarity detection algorithm (step 4504). Method 4500 may select a subset of most frequently generated signatures, wherein selection is based on the frequency histogram (step 4506). Method 4500 may select the most significant byte of each of the subset of most frequently generated signatures for sample-based similarity detection (step 4508).

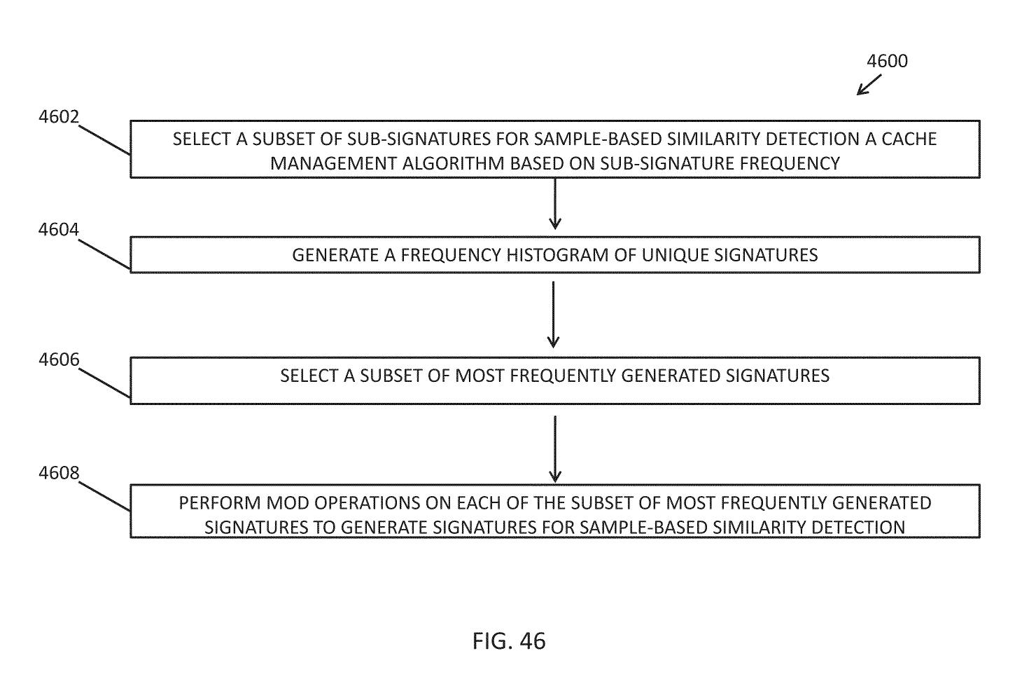

FIG. 46 illustrates a flowchart of an example method 4600 of performing mod operations on the most frequently generated signatures for sample-based similarity detection, in accordance with some embodiments of the present disclosure. For example, method 4600 may include selecting a subset of sub-signatures for sample-based similarity detection in a cache management algorithm based on sub-signature frequency (step 4602). Method 4600 may generate a frequency histogram of unique signatures while calculating the signatures in a cache management similarity detection algorithm (step 4604). Method 4600 may select a subset of most frequently generated signatures, wherein selection is based on the frequency histogram (step 4606). Method 4600 may perform mod operations on each of the subset of most frequently generated signatures to generate signatures for sample-based similarity detection (step 4608).

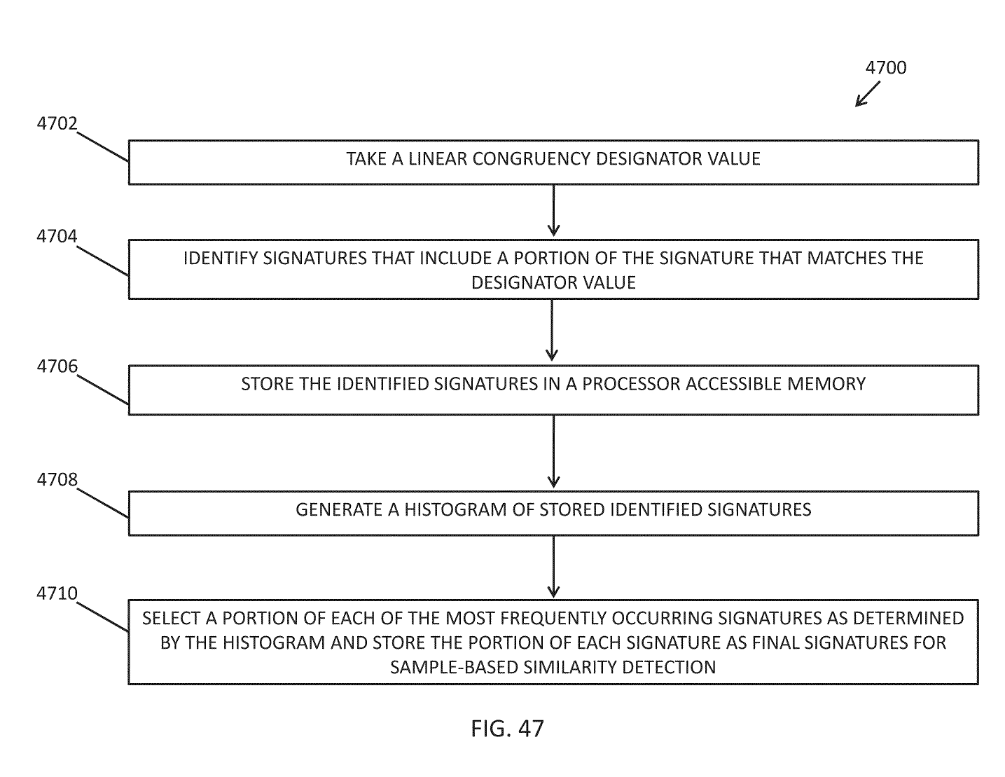

FIG. 47 illustrates a flowchart of an example method 4700 of selecting a subset of sub-signatures for sample-based similarity detection in a cache management algorithm, in accordance with some embodiments of the present disclosure. Some embodiments may match a portion of each signature to a linear congruency designator. Method 4700 may include taking a linear congruency designator value (step 4702). Method 4700 may identify signatures that include a portion of the signature that matches the designator value while calculating signatures in a cache management similarity detection algorithm (step 4704). Method 4700 may store the identified signatures in a processor accessible memory (step 4706). Method 4700 may generate a histogram of stored identified signatures (step 4708). Method 4700 may select a portion of each of the most frequently occurring signatures as determined by the histogram and store the portion of each signature as final signatures for sample-based similarity detection (step 4710).

The techniques described herein for efficient signature and sub-signature calculation, signature sampling methods, algorithm comparison and selection techniques, and the like may be employed in a variety of environments, including in various cache management methods and systems. Several such cache management methods and systems are described herein and may include content/spatial/temporal locality-based similarity detection and delta compression, conservative insertion and promotion of cachable data blocks, popularity-based techniques (e.g. Least Popularly Used), DRIPStore, HeatMap-based signature popularity techniques, data virtualization, and other similarity, compression, cache management, and SSD management techniques, methods, and systems as described herein. The techniques described herein for efficient signature and sub-signature calculation, signature sampling methods, algorithm comparison and selection techniques, and the like may replace or supplement similar techniques described herein as being used in various cache management-related embodiments.

### Signature Computation and Sampling for Similarity Detection

Embodiments of methods and systems for fast, accurate similarity detection described herein, particularly as depicted in FIGS. 39-52 are now described.

Features of a similarity detection algorithm can include: (i) taking on the order of 10 microseconds; (ii) comprehensively detecting a high percentage of possible similar blocks; (iii) generating a minimal number of false positive detections, because each false positive detection can waste computing resources and possibly delay I/O operations that the cache management techniques are designed to speed-up.

Finding resemblance of two or more files/documents/data streams facilitates compressing the files, such as by using delta encoding. Similarity detection of two files/documents/data streams (herein “compression target”) may be done by representing each document using a set of shingles. Shingles may be derived by sliding a window of θ bytes (also referred to herein as a shingle size) from the beginning to the end of the compression target one byte at a time. If the compression target contains β bytes (e.g. 4 KB to 64 KB), the methods process a total of β−θ+1 shingles. The degree of similarity between the two compression targets may then be determined based on the number of shingles shared by the two compression targets.

Comparing all processed shingles of the two compression targets may result in accurate similarity detection. However, the computation cost for this comparison may also be high. Therefore, it may be important to determine how many shingles to compare, and how to select a subset of shingles to compare without loss of accuracy. This determination may be similar to a sampling problem, which may be addressed by the design and selection of efficient similarity detection algorithms as described herein.

An initial issue to address is how big the shingle size should be, determining θ which may be a trade-off between accuracy and efficiency. If θ is the size of a machine word, then similarity detection becomes a word to word comparison of the two compression targets, implying low efficiency. If θ is too large, on the other hand, it may be easy to miss many similar data blocks in the compression target with small changes, such as one word insertion or one byte overwrite. A common range for θ may be in the range of tens of bytes to hundreds of bytes.

To increase storage and computation efficiency, a computed fingerprint (e.g., signature, hash, and the like) of a processed shingle may be compared, instead of comparing each processed shingle. Fingerprint generation may result in a probability that two different shingles will generate the same signature being extremely small, so that the chances of signature collision become very small or even negligible in practice.

A similarity detection algorithm may be thought of as including a few steps such as: determining shingle size, calculating signatures of the shingles, selecting a sample of signatures (e.g. a sketch), and finally comparing the corresponding signatures of the two compression targets to determine the degree of similarity. A similarity detection algorithm described herein may be referred to as FASD, for fast/adaptive similarity detection. A key observation is that compression target data actively accessed by applications shows content locality (regularity and similar pattern) during a short time frame (typically daily or hourly). The FASD algorithm employs algorithm selection techniques to adapt to these active data patterns to provide highly efficient and accurate similarity detection. FASD facilitates selecting best-fit shingling and signature computation algorithms and a best fit sampling and finalization algorithms of signature candidates to be used for similarity detection of at least the remaining portion of the compression target data.

Referring again to FIGS. 39-41, the present disclosure now describes several shingling and signature computation techniques for a compression target portion comprising β bytes. To offer options for various types of content locality patterns that may be found in application related compression targets while ensuring fast and accurate signature computation for low false positive detection, presented herein are five distinct algorithms for signature computation, each algorithm having different performance characteristics. Therefore, depending on the compression target, one signature computation algorithm may perform better (e.g., with higher accuracy) than another. In an example, when an application starts processing compression target data, a quick test on application data may determine which signature detection algorithm to be used for the application. This may be referred to herein as a calibration process. Each distinct signature computation algorithm is referred herein as a “subroutine” and is uniquely identified by a subroutine ID (e.g. “subroutine 1”).

Subroutine 1: Use a shingle size of 3 bytes to calculate β-2 1-byte signatures. Each signature may be an addition of 3 bytes. Leveraging the register structure of some common processors (e.g. based on x86 architecture), 128 byte additions can be processed in parallel so that all β-2 signatures can be done very quickly by parallel additions and register shifts.

Subroutine 2: Use a shingle size of 8 bytes to calculate β-7 1-byte signatures. Each signature may be one byte checksum of the corresponding 8 bytes. Making use of the hardware support in common processors for generating a CRC checksum, the checksums can be calculated very quickly. Notice that a CRC generating polynomial is not necessarily irreducible, because it usually requires generating polynomial to have (x+1) as a factor in order to detect all odd number bits errors.

Subroutine 3: Use a shingle size of 4, 8, or more bytes to calculate signatures of length 19 or 31 by doing mod operations using Mersenne primes as a modulus to calculate signatures with high speed and low collision probability. An example of subroutine 3 that assumes a shingle size of 8B, fingerprint length of 19 bits, and 4 KB block is now presented:

Choose a Mersenne prime, say 19 bits: P=2¹⁹−1=0x7FFFF;

Calculate the remainder dividing the first 8B, A=[b₁:b₂:b₃ . . . b₈], of the data block by 0x7FFFF. To avoid division that would take over 40 cycles, subroutine 3 may perform addition instead. Subroutine 3 first partitions an 8B string (64 bits) into 19-bit pieces starting from the least significant bits resulting in [A₁:A₂:A₃:A₄], where A₁ has only 7 bits.

A=A₁*2⁵⁷+A₂*2³⁸+A₃*2¹⁹+A₄

since

A₁*2⁵⁷ mod(2¹⁹−1)=A₁, A₂*2³⁸ mod (2¹⁹−1)=A₂, and A₃*2¹⁹ mod(2¹⁹−1)=A₃, note that 2¹⁹ⁱ mod(2¹⁹−1)=1 holds always.

The result is the first signature

$$\begin{matrix}{S}_{1} = A mod ( {2}^{19} - 1 ) \\ = {A}_{1} * {2}^{57} + {A}_{2} * {2}^{38} + {A}_{3} * {2}^{19} + {A}_{4} mod ( {2}^{19} - 1 ) \\ = {A}_{1} + {A}_{2} + {A}_{3} + {A}_{4} mod ( {2}^{19} - 1 ) \\ = {A}_{1} + {A}_{2} + {A}_{3} + {A}_{4} ,\end{matrix}$$

with the carry bit wrapped around and added to the LSB of the sum.

Suppose the 8B shingle (64 bits) is stored in two 32-bit data registers denoted D_{H} and D_{L} for higher order word and lower order word, respectively. A result is the computation of the above equation involves only shifts and additions, which are faster to execute on a processor than other operations that are more complicated and may require more computation time:

S₁=D_{L}&P+D_{L}>>19+(D_{H}&0x3F)<<13+(D_{H}>>6&P)+D_{H}>>25 Equation (1)

For the remaining P-6 signatures, subroutine 3 may include:

$$\begin{matrix}\begin{matrix}{S}_{i + 1} = [ {b}_{i + 1} \text{:} {b}_{i + 2} \text{:} {b}_{i + 3 } … {b}_{i + 8} ] mod P , for i = 1 , 2 , … , β - 6 \\ = [ {b}_{i + 1} {2}^{56} ⊕ {b}_{i + 2} {2}^{48} ⊕ {b}_{i + 3} {2}^{40} … {b}_{i + 7} {2}^{8} ⊕ {b}_{i + 8} ] mod P ; \\ Note \text{:} ‘ ⊕ ’ symbol represents bit \text{-} wise XOR \\ = [ \begin{matrix}{b}_{i} {2}^{64} ⊕ {b}_{i} {2}^{64} ⊕ {b}_{i + 1} {2}^{56} ⊕ {b}_{i + 2} {2}^{48} ⊕ \\ {b}_{i + 3} {2}^{40} … {b}_{i + 7} {2}^{8} ⊕ {b}_{i + 8}\end{matrix} ] mod P \\ = [ {b}_{i} {2}^{64} ⊕ {S}_{i} {2}^{8} ⊕ {b}_{i + 8} ] mod P \\ = ( {b}_{i} {2}^{64} mod P ) ⊕ ( {S}_{i} {2}^{8} mod P ) ⊕ {b}_{i + 8} \\ = ( {b}_{i} {2}^{64} mod P ) ⊕ [ ( {S}_{i} ≪ 8 ) \& P + {S}_{i} ≫ 11 ] ⊕ {b}_{i + 8}\end{matrix} & Equation ( 2 ) \\ {S}_{i + 1} = {b}_{i} ≪ 7 ⊕ [ {S}_{i} ≪ 8 ) \& P + {S}_{i} ≫ 11 ] ⊕ {b}_{i + 8} . & \end{matrix}$$

Equation (2) may require 3 shifts, 2 XOR, and 1 addition operations irrespective of the length of shingle size.

If the shingle size is 4B and fingerprint length is 19 bits, a similar procedure is described below.

Choose a Mersenne prime 19 bits: P=2¹⁹−1=0x7FFFF;

Calculate the remainder dividing the first 4B, A=[b₁:b₂:b:b₄], of the data block by 0x7FFFF. The system partitions the 4B string (32 bits) into a lower 19-bit string and a remaining high order 13-bit string denoted by [A₁:A₂], where A₁ has 13 bits and A₂ has 19 bits.

A=A₁*2¹⁹+A₂
since
A₁*2¹⁹ mod(2¹⁹−1)=A₁, and A₂ mod(2¹⁹−1)=A₂; note that 2¹⁹ⁱ mod(2¹⁹−1)=1 holds always.

This calculation provides a first signature

$$\begin{matrix}{S}_{1} = A mod ( {2}^{19} - 1 ) \\ = {A}_{1} * {2}^{19} + {A}_{2} mod ( {2}^{23} - 1 ) \\ = {A}_{1} + {A}_{2} mod ( {2}^{19} - 1 ) \\ = {A}_{1} + {A}_{2} ,\end{matrix}$$

with the carry bit wrap around added to the least significant bit of the sum.

Note that

A₁=A>>19, i.e., a logic shift to the right by 19 bits, and

A₂=A&P.

Therefore, the computation of A₁+A₂ involves only shifts and additions and may be given by:

S₁=A>>19 +A&P, with the carry bit wrapped around. Equation (3)

For the remaining 4K−2 signatures, the system may perform the same computation for each 4B word:

$$\begin{matrix}{S}_{i + 1} = [ {b}_{i + 1} \text{:} {b}_{i + 2} \text{:} {b}_{i + 3} \text{:} {b}_{i + 4} ] mod P \\ = [ {b}_{i + 1} \text{:} {b}_{i + 2} \text{:} {b}_{i + 3} \text{:} {b}_{i + 4} ] \& P + \\ [ {b}_{i + 1} \text{:} {b}_{i + 2} \text{:} {b}_{i + 3} \text{:} {b}_{i + 4} ] ≫ 19\end{matrix} \qquad Equation ( 4 )$$

for a shingle size of 4B and fingerprint size of 19 bits.

In general, if the shingle size is small relative to the exponent of the Mersenne prime, the method can carry out the computation for each shingle using Equations (3) and (4). If the shingle size is large, e.g., larger than 8B, the system can calculate the first signature and then recursively calculate the remaining signatures. Let the shingle size be θ bytes (θ>8B) and signature size of μ A bits (length of the Mersenne prime). The system may calculate the first signature as follows:

Partition the first θ bytes of a data block into

$$⌈ \frac{θ}{μ} ⌉ μ \text{-} bit$$

segments from the LSB to MSB, the last segment containing the MSB may have less than μ bits; (this computation can be done using mask and shift operations)

Add all

$$⌈ \frac{θ}{μ} ⌉$$

segments with carry bits wrapped around and added to the LSB;

The sum may be the first signature.

Once the first signature has been calculated, the system may compute the remaining signatures as follows:

$$\begin{matrix}\begin{matrix}{S}_{i + 1} = [ {b}_{i + 1} \text{:} {b}_{i + 2} \text{:} {b}_{i + 3} … {b}_{i + θ} ] mod P \\ = [ \begin{matrix}{b}_{i + 1} {2}^{8 ( θ - 1 )} ⊕ {b}_{i + 2} {2}^{8 ( θ - 2 )} ⊕ … ⊕ \\ {b}_{i + θ - 1} {2}^{8} ⊕ {b}_{i + θ}\end{matrix} ] mod P ; \\ = [ \begin{matrix}{b}_{i} {2}^{8 θ} ⊕ {b}_{i} {2}^{8 θ} ⊕ {b}_{i + 1} {2}^{8 ( θ - 1 )} ⊕ \\ {b}_{i + 2} {2}^{8 ( θ - 2 )} ⊕ … ⊕ {b}_{i + θ - 1} {2}^{8} ⊕ {b}_{i + θ}\end{matrix} ] mod P \\ = [ {b}_{i} {2}^{8 θ} ⊕ {S}_{i} {2}^{8} ⊕ {b}_{i + θ} ] mod P \\ = ( {b}_{i} {2}^{8 θ} mod P ) ⊕ ( {S}_{i} {2}^{8} mod P ) ⊕ {b}_{i + θ} \\ = ( {b}_{i} {2}^{8 θ} mod P ) ⊕ [ ( {S}_{i} ≪ 8 ) \& P + {S}_{i} ≫ ( μ - 8 ) ] ⊕ {b}_{i + θ}\end{matrix} & Equation ( 5 ) \\ {S}_{i + 1} = {b}_{i} ≪ ( 8 θ - ⌊ \frac{8 θ}{μ} ⌋ * μ ) ⊕ [ \begin{matrix}( {S}_{i} ≪ 8 ) \& P + \\ {S}_{i} ≫ ( μ - 8 )\end{matrix} ] ⊕ {b}_{i + θ} & \end{matrix}$$

Subroutine 4: Generate a random irreducible polynomial for each shingle. This generation may be done in the following manner:

Denoting the byte strings by b₁, b₂, b₃, . . . bₙ and taking the shingle size to be 8, the signature of the first shingle may be derived as:

S₁=(b₁*p⁷+b₂*p⁶+b₃*p⁵+b₄*p⁴+b₅*p³+b₆*p²+b₇*p+b₈)mod M,
where p (a prime number) and Mare constants. One way to calculate S₁ is using Horner's formula:

S₁=(p*(( . . . (p*(p b₁+b₂)+b₃) . . . ))+b₈)mod M.

The 2nd and the rest of the signatures may be calculated using the previously calculated signature as follows:

Sᵢ₊₁=(p*(Sᵢ−(bᵢ*p⁷))+bᵢ₊₇) mod M, for i=1, 2, . . . , β−7.

Subroutine 5: Using a shingle size of 8 to 128 bytes to calculate Rabin fingerprints of length 16 or 32 recursively, making use of previously computed fingerprints. For illustrative purposes, assume a shingle size of 8B, fingerprint length of 32 bits, and 4 KB block. For other parameters, the algorithm may be generalized.

Choose an irreducible polynomial of degree 32, g(x);

Calculate the remainder dividing the first 8B, [b₁:b₂:b₃ . . . b₈], of the data block by g(x);

S₁=[b₁:b₂:b₃ . . . b₈] mod g(x)

S₁ may be determined using a slicing-by-8 method or any other method for 32-bit CRC computation on 8B. Note that the speed of computing this first CRC is not significant, since the first CRC may be computed only once per block and may represent a small fraction of the total computation of all 4K−7 fingerprints.

The remaining 4K−6 signatures may be given by

$$\begin{matrix}{S}_{i + 1} = [ {b}_{i + 1} \text{:} {b}_{i + 2} \text{:} {b}_{i + 3 } … {b}_{i + 8} ] mod g ( x ) \\ = [ {b}_{i + 1} {2}^{56} ⊕ {b}_{i + 2} {2}^{48} ⊕ {b}_{i + 3} {2}^{40} … {b}_{i + 7} {2}^{8} ⊕ {b}_{i + 8} ] mod g ( x ) ; \\ = [ \begin{matrix}{b}_{i} {2}^{64} ⊕ {b}_{i} {2}^{64} ⊕ {b}_{i + 1} {2}^{56} ⊕ {b}_{i + 2} {2}^{48} ⊕ \\ {b}_{i + 3} {2}^{40} … {b}_{i + 7} {2}^{8} ⊕ {b}_{i + 8}\end{matrix} ] mod g ( x ) \\ = [ {b}_{i} {2}^{64} ⊕ {S}_{i} {2}^{8} ⊕ {b}_{i + 8} ] mod g ( x ) \\ = [ ( {b}_{i} {2}^{56} ⊕ {S}_{i} ) \text{:} {b}_{i + 8} ] mod g ( x ) \\ = {R}_{Sb 1} ⊕ {R}_{Sb 2} ⊕ {R}_{Sb 3} ⊕ {R}_{Sb 4} ⊕ {b}_{i + 8} Equation ( 7 )\end{matrix} \qquad Equation ( 6 )$$

where R_{Sb1}, R_{Sb2}, R_{Sb3}, R_{Sb4} represent remainders of each of the four bytes in bᵢ2⁵⁶⊕Sᵢ divided by g(x), and may be given respectively by

R_{Sb1}=2³²*1st byte of (bᵢ2⁵⁶⊕Sᵢ)mod g(x),

R_{Sb2}=2²⁴*2nd byte of (bᵢ2⁵⁶⊕Sᵢ)mod g(x),

R_{Sb3}=2¹⁶*3rd byte of (bᵢ2⁵⁶⊕Sᵢ)mod g(x)

R_{Sb4}=2⁸*4th byte of (Bᵢ2⁵⁶⊕Sᵢ)mod g(x)

In some embodiments, Equation (7) uses five XOR operations and five table lookups, irrespective of the length of shingle size. The five tables store the remainder divided by g(x) of a byte shifted to the left by 7 bytes, 4 bytes, 3 bytes, 2 bytes, and 1 byte, respectively.

If the fingerprint length is 16 bits or 2 bytes, then the system may use three table lookups and three XOR operations for each signature, because both bᵢ2⁵⁶ and Sᵢ are two bytes long. Equation (7) may thereby become:

Sᵢ₊₁=R_{Sb1}+R_{Sb2}+bᵢ₊₈

Referring again to FIGS. 43-46, the present disclosure now describes signature sampling techniques. The above disclosure described signature computation techniques, e.g., techniques for computing overall signatures or fingerprints for a given data block. However, comparing all 4K−θ+1 signatures of each block would have a high computation cost, which is not desirable for cache operations. Therefore, selecting representative signatures of each block to compare with representative signatures of other blocks may be desirable. The present disclosure refers to this signature selection process as sampling. Some known sampling techniques generally make use of P random permutations of signatures, and then select the minimum from each permutation, resulting in a set of P signatures as the sketch of the data block. Grouping techniques (e.g., a “super” signature) were also used to get a sharp high-band pass filter effect of a sketch. However, generating random permutations according to known methods may be acceptable for web applications, but is too slow and requires too much processing and memory resources for use in data caching. In contrast, content locality based caching can include sampling algorithms that are fast, efficient, unique, and specifically suitable to storage caching software. The inputs of these algorithms are β−θ+1 signatures of μ bits each. The outputs are selected σ signatures such that a σ<<β−θ+1.

### Sampling Subroutine A (Frequency-Based):

Referring again to FIG. 43 that depicts operation A.1., the signatures are all 1B long, (e.g. if the signatures may be calculated using signature computation subroutine 1, then we have 256 different signature values). The signature sampling may form an array of 256 entries indexed by signature values. Each entry keeps a counter of the number of occurrences of the corresponding signature in the data block. The array may be populated as the signature calculations are being performed. The signature sampling sorts the array and then picks up the top σ most frequent signatures as the final sample signatures for similarity detections.

Referring again to FIG. 44 that depicts operation A.2., if the signature length is more than 1B, i.e. μ>8, the signature sampling picks up all signatures with the LSB being 0. Among the selected signatures, the signature sampling picks up the most significant bytes as the signature and perform the same operation as A.1. above to sort the array and select the top a most frequent signatures as the final sample signatures for similarity detections.

Referring again to FIG. 45 that depicts operation A.3., if the number of remaining signatures is less than 256 after truncating 0 LSBs, the signature sampling may use a frequency histogram of μ-8 bits signatures directly, without using the 256-element array described above. Based on this frequency histogram, the signature sampling picks up the top σ most frequent signatures. For each of these σ signatures, the signature sampling selects the most significant byte of the μ-8 bits signature as the final sample signatures for similarity detections.

Referring again to FIG. 46 that depicts operation A.4., FIG. 46 illustrates a technique that is similar to operation A.3. except for the final signature byte selection. Instead of picking up the most significant byte of the μ-8 bits signature, the signature sampling does mod 2⁷−1 operations on the σ most frequent signatures to derive final signature bytes. For each of a signatures, S_{σ}, the signature sampling does

S_{f}=S_{σ}& 0x7F;
loop:
   S_{σ}=S_{σ}>>7;
   S_{f}=S_{f}+S_{σ}& 0x7F;
   If S_{σ}>0 then goto loop,
   done

### Sampling Subroutine B (Random Based):

The frequency based sampling techniques discussed above have the advantages of catching signatures that identify the most frequently accessed segments in the I/O path and therefore help LPU cache design (LPU denotes Least Popularly Used data replacement cache algorithm and is described herein). However, for some data sets, random sampling may give better performance.

Referring again to FIG. 47, which depicts a sampling subroutine B.1., among the β-θ+1 signatures of μ A bits, the signature sampling does random sampling by storing only the signatures that are linearly congruent modulo 2^{Y}. Such sampling can be done relatively easily and efficiently by examining the least significant Y bits as each signature is being calculated. If the Y bits equal a predefined value (say Y bits 0's), the sampling stores the μ-Y bit signature. Otherwise, the signature sampling ignores the signature. As a result of this random sampling, signature sampling obtains Ω (μ−Y)-bit signatures.

After the random sampling of step B.1., in operation B.2. the sampling builds a histogram of the Ω signatures. The sampling then selects the eight most frequent signatures. These eight signatures may be (μ-Y) bits each. The sampling then selects one byte among the (μ-Y) bits or does mod 2⁷−1 operations to obtain the final eight 1B signatures.

In another sampling operation B.3., on each 4 KB data block, the sampling may calculate only thirty-two signatures, each of which is thirty-one bits resulting from the modulo operation on the 31-bit Mersenne prime. Among the thirty-two signatures, the first four may be calculated on the four shingles at the middle of the first 512B of the 4 KB data block, the second four may be calculated at the middle of the second 512B, and so on, giving rise to 32 signatures total because there eight 512B subblocks in a 4 KB data block. For example, the sampling may start at byte location 256 with shingle size 50B to calculate the first signature based on Mersenne primes. Then the sampling slides the shingle by 1 byte to calculate the second signature for byte 257 through byte 306, until four signatures are obtained. Then the sampling starts the 5th signature at byte location 768, and so on. After the sampling calculates the thirty-two signatures, the sampling performs either:

Frequency histogram to select the top eight most frequent signatures and reduce them from 32 bits to 8 bits by choosing the MSB or doing mod 2⁷−1 as follows. For each of the 8 signatures, S_{σ}, the sampling performs:

S_{f}=S_{σ}& 0x7F;

loop:
S_{σ}=S_{σ}>>7;
S_{f}=S_{f}+S_{σ}& 0x7F;
if S_{σ}>0 then goto loop,
done

Or

Heap sort the thirty-two signatures to select eight signatures that have the least signature values. Then, the sampling may use the same algorithm above to reduce signatures from thirty-two bits to eight bits.

Since the basic data unit in I/O operations is a sector or 512B, the sampling techniques are aware of this fact. This is the rationale behind subroutine B.3. above. The generalized algorithm for subroutine B.3. is given below.

### Algorithm SampleSigComp: Sampling and Signature Computation (Sketch Computation)

Inputs: A data block of 0 bytes (4K to 64K in our case)

Outputs: Eight (or any chosen number, NoSig) 1B signatures (or a few bytes, SigL) as a sketch of the block for similarity comparison purposes

Parameters (tunable): Shingle size: θ; Number of shingles sampled per sector: ω; Starting offset in sector i for signature computation/sampling: ψₙ for n=0, 1, . . . , N, where N is the total number of signatures computed in a program run; A Mersenne Prime: P.

Procedures:

ψ₀=64;

$$For j = 0 to \frac{β}{512} - 1 DO$$

1) Calculate the first signature starting at byte ψₙ+512*j as follows:
a) Partition the first θ bytes starting at ψₙ+512*j into

$$⌈ \frac{θ}{μ} ⌉ μ \text{-} bit$$

segments from the LSB to MSB, the last segment containing the MSB may have less than μ bits, this computation can be done using mask and shift operations as exemplified by Equation (1);
b) Add all

$$⌈ \frac{θ}{μ} ⌉$$

segments with carry bits wrapped around and added to the LSB;
c) Let Sᵢ denote the sum;

2) For i=1 to ω−1 do
Calculate Sᵢ₊₁ using Equation (5):

$${S}_{i + 1} = {b}_{i} ≫ ( ⌊ \frac{8 θ}{μ} ⌋ * 8 ) ⊕ [ ( {S}_{i} ≪ 8 ) \& P + {S}_{i} ≫ ( μ - 8 ) ] ⊕ {b}_{i + θ}$$

where bᵢ and b_{1+θ} are the most significant byte and least significant byte of the shingle, respectively.

3)

$$\begin{matrix}{Ψ}_{n + 1} = 3578 * {Ψ}_{n} + 127 {Mod2}^{9} - 1 \\ = ( 3578 * {Ψ}_{n} + 127 ) \& 0 x 1 FF + ( 3578 * {Ψ}_{n} + 127 ) ≫ 9 ;\end{matrix}$$

### END DO

For all

$$\frac{ωβ}{512}$$

signatures, do heap sort and select the least eight (or NoSig) signatures; (occurrence frequency may be considered while sorting);

Reduce each of the eight signatures, S_{σ} from μ bits to eight (or SigL) bits according to:

S_{f}=S_{σ}& 0x7F;

loop:
S_{σ}=S_{σ}>>7;
S_{f}=S_{f}+s_{σ}& 0x7F;
if S_{σ}>0 then goto loop,

Referring again to FIG. 42, which depicts dynamically setting a signature threshold, once a set of sampled signatures are obtained, the content locality based caching may choose to dynamically set the signature threshold based on the characteristics of an application and data set. FIG. 42 shows the flowchart of this adaptive algorithm. An example of the way it works is as follows:

Starting with an initial signature match threshold, for example three out of eight matching signatures, if at least three of subset of sampled signatures match between two blocks of data, the two blocks are identified as similar. However, if a configurable number of false positive detections are found, an automated signature match threshold configuration facility may increase this signature match threshold.

Likewise, if a number of associated/reference blocks generated using the similarity detection techniques described herein is lower than a predetermined number, the automated signature match threshold configuration facility may decrease the signature match threshold. After a few iterations (e.g. two or more), an optimal threshold value may be determined.

This process may be done on each scanning cycle.

FIGS. 48A-52B illustrate example signature computation processes and corresponding circuits for signature computation, in accordance with some embodiments of the present disclosure. In some embodiments, the processes described herein can be performed in software, hardware, firmware, or combinations thereof. FIGS. 48A-52B illustrate example processes and corresponding circuits for implementing similarity detection and signature computation in ways that leverage fast hardware components, such as shift registers, adders, and logic gates.

FIG. 48A illustrates an example method 4810 of signature computation for content locality caching, in accordance with some embodiments of the present disclosure. Method 4810 can include receiving a block for caching (step 4812); dividing the block into “shingles” (step 4814); for each shingle (step 4816), determining, using a fingerprint circuit, an intermediate fingerprint by processing the shingle (step 4818), determining whether the intermediate fingerprint is more representative of the contents of the block that a previous fingerprint (step 4820); if so, storing, in a fingerprint buffer, the intermediate fingerprint as a representative fingerprint (step 4822); if not, keeping the previous fingerprint in the fingerprint buffer as the representative fingerprint (step 4824); determining whether there are more shingles to process (step 4826); if so, processing the next shingle; and if not, adding the representative fingerprints stored in the fingerprint buffer to a sub-signature “sketch” of the received block (step 4828).

Method 4810 can receive a block for caching (step 4812). The system can divide the block into subsets, or “shingles” (step 4814). For example, the size of the received block can be 4 KB, and the corresponding size of the shingle can be 8 bytes. (Accordingly, for an example block of size 4 KB, there can be 4K-7 shingles corresponding to various subsets of the block.)

For each shingle (step 4816), method 4810 can determine, using a fingerprint circuit, an intermediate fingerprint by processing the shingle (step 4818). In some embodiments, determining the intermediate fingerprint can include computing a hash value for the shingle. In some embodiments, the fingerprint circuits, also referred to herein as signature computation circuits, can process shingles in parallel using multiple fingerprint circuits. The parallel processing can determine multiple fingerprints of multiple shingles concurrently, faster than using a fingerprint circuit for serial or sequential processing. The intermediate fingerprint can be used as a “temporary” fingerprint that represents a current representative fingerprint for a single shingle. In some embodiments, determining the intermediate fingerprint can use Mersenne primes, Rabin fingerprinting, random irreducible polynomials, or other methods that result in a smaller sub-signature than the received shingle. The Mersenne primes, Rabin fingerprinting, and random irreducible polynomials can generally represent content of a shingle. In some embodiments, if the content locality cache uses eight-way parallel fingerprint circuits, the system can generate eight fingerprints using different terms for each fingerprint circuit. For example, if the parallel fingerprint circuits use Rabin fingerprinting, each fingerprint circuit can use different polynomials for the Rabin fingerprinting. If the parallel fingerprint circuits use random irreducible polynomials, each fingerprint can use a different prime modulo for the random irreducible polynomial. A smaller sub-signature can be computationally easier to process, while still representing the contents of the block for use in detecting similarity with reference blocks.

Method 4810 can determine whether the intermediate fingerprint is more representative of the overall contents of the block than a previous fingerprint (step 4820). In some embodiments, determining whether the intermediate fingerprint is more representative can use min wise independent permutations locality sensitive hashing by selecting a minimal fingerprint for the shingles processed by the fingerprint circuit. In other embodiments determining whether the intermediate fingerprint is more representative can select a maximal fingerprint for the shingles by retaining high-order bits of the intermediate fingerprint and discarding low-order bits. Because the fingerprint circuits can process more than one shingle, the previous fingerprint stored in the fingerprint buffer can be a representative fingerprint for all shingles processed so far by the fingerprint circuit. Some shingles can be expected to result in intermediate fingerprints that are relatively higher or lower. In some embodiments, determining whether the intermediate fingerprint is more representative can include selecting an intermediate or previous fingerprint that is maximal (or minimal) for all shingles processed by the fingerprint circuit. Selecting a maximal or minimal fingerprint can generally result in a better and faster measure of the content of the received block by sampling shingles. Selecting a maximal or minimal fingerprint can allow the system to determine similarity of data blocks by performing fast set union and set intersection operations on the minimal or maximal fingerprints. Further description of the min wise independent selection can be found in Andrei Z. Broder, “On the resemblance and containment of documents,” Compression and Complexity of Sequences: Proceedings, Positano, Amalfitan Coast, Salerno, Italy, Jun. 11-13, 1997, IEEE, pp. 21-29, the entire contents of which are incorporated by reference herein.

If the intermediate fingerprint is determined to be more representative of the contents of the block (step 4820: Yes), the intermediate fingerprint can be stored in the fingerprint buffer as the representative fingerprint (step 4822). For example, determining the intermediate fingerprint to be more or less representative of the contents of the block can include determining whether the intermediate fingerprint is greater than or less than the previous fingerprint, depending on whether a maximal or minimal fingerprint is used for sampling. If the intermediate fingerprint is determined to be more representative, the intermediate fingerprint can therefore replace the previous fingerprint that was initially stored in the fingerprint buffer. If the intermediate fingerprint is determined to be less representative of the contents of the block (step 4820: No), method 4810 can keep the previous fingerprint in the fingerprint buffer as the representative fingerprint for the shingles that have been sampled by the fingerprint circuit (step 4824). If there are more shingles to process (step 4826: Yes), method 4810 returns to process a subsequent shingle. If there are no more shingles to process (step 4826: No), the system can use the representative fingerprints stored in the fingerprint buffers as the representative fingerprints for the received block (step 4828).

FIG. 48B illustrates an example of signature computation circuit 1324 for content locality caching, in accordance with some embodiments of the present disclosure. Signature computation circuit 1324 can include block 4804 divided into shingles 4806a-4806b, fingerprint circuits 1340a, 1340d, comparators 1340b, 1340e, and fingerprint buffers 1340c, 1340f to store a “sketch” of resulting signature samples 4802a-4802b. Signature computation circuit 1324 can sometimes be referred to herein as a fingerprint circuit or similarity detection circuit. Some embodiments of signature computation circuit 1324 can perform signature computation, or fingerprint computation, to detect similarity. For example, signature computation circuit 1324 can compute a fingerprint for each shingle 4806a-4806b of a predefined size on data block 4804. A shingle can represent a window, or subset, of data block 4804 for content analysis to determine content similarity. A fingerprint can represent a content signature of data block 4804 or of a subset of data block 4804. For example, a shingle can represent a window, or subset, of data block 4804, where the window is shifted one byte at a time to determine a relevant subset of data block 4804 for analysis. If an example shingle size is 8 bytes and block size is 4 KB, then signature computation circuit 1324 can compute 4K-7 fingerprints in various iterations. Among the computed fingerprints, the content locality cache can select a number of fingerprints 4802a-4802b to represent a “sketch” of data block 4804. For example, signature computation circuit 1324 can store about six to eight selected fingerprints 4802a-4802b in fingerprint buffers 1340c, 1340f, or any other number, for representing an overview of the content of data block 4804. The present disclosure describes about six to eight parallel fingerprint circuits for exemplary purposes and clarity. The actual number of fingerprint circuits used in the cache may be higher or lower, to exploit parallel processing and the implementations described herein, in hardware and/or software. Signature computation circuit 1324 can compute intermediate fingerprints in the process of selecting the overall sketch of the data block.

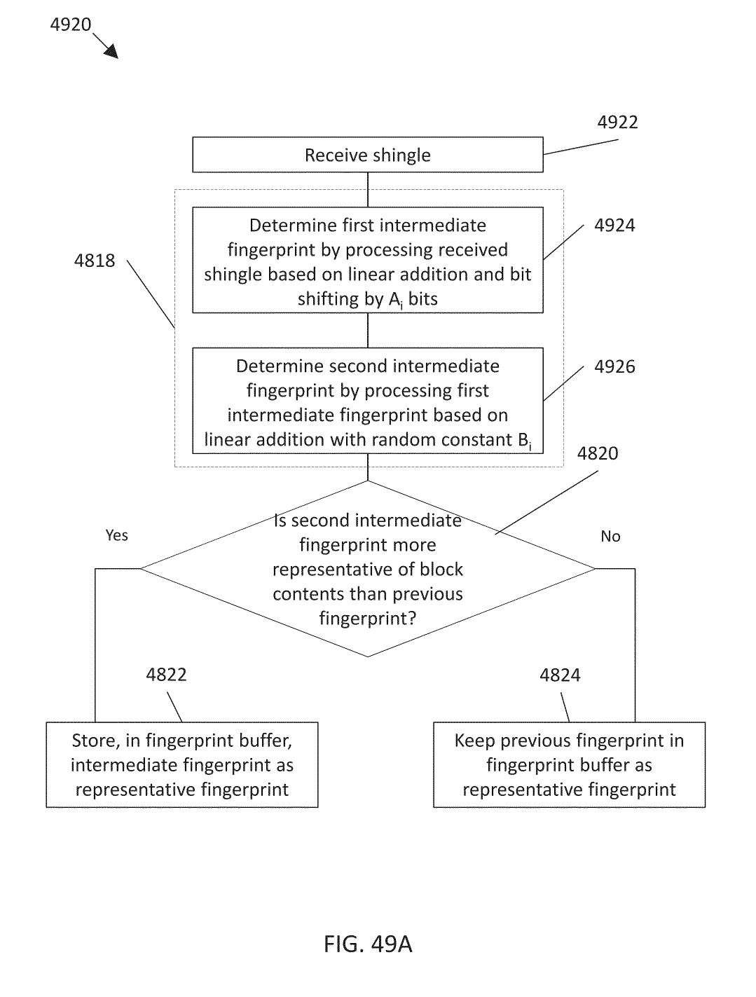

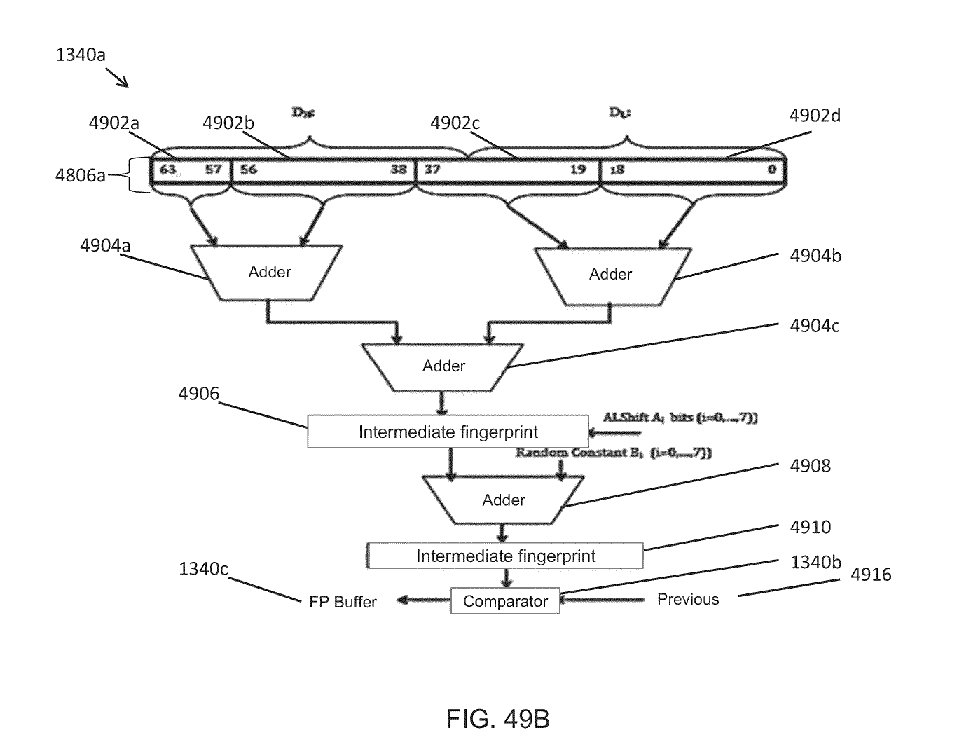

Fingerprint circuits 1340a, 1340d can perform intermediate computations to determine the intermediate fingerprints. FIGS. 49A-52B illustrate some example implementations of signature computation circuits 1324 using Mersenne primes, Rabin fingerprinting, or other processes that can provide an overview of content of a shingle of a data block, or of a data block generally. In some embodiments, comparators 1340b, 1340e can store intermediate fingerprints for comparing against a current maximum or minimum fingerprint stored in fingerprint buffers 1340c, 1340f. If an intermediate fingerprint computed by fingerprint circuits 1340a, 1340d is determined to be greater or lower than a current maximum or current minimum fingerprint stored in fingerprint buffers 1340c, 1340f, then comparators 1340b, 1340e can replace the contents of fingerprint buffers 1340c, 1340f with the new maximum or minimum fingerprint. Signature computation circuit 1324 can allow the content locality caching to use the fingerprints and sketch to perform similarity detection among data blocks, by comparing respective sketches or groups of fingerprints.

FIG. 49A illustrates an example method 4920 of signature computation for the content locality cache, in accordance with some embodiments of the present disclosure. Method 4920 includes receiving a shingle (step 4922); determining a first intermediate fingerprint by processing the received shingle based on linear additions and bit-shifting the result (step 4924); determining a second intermediate fingerprint by processing the first intermediate fingerprint based on linear additions with a random constant (step 4926); determining whether the second intermediate fingerprint is more representative of the contents of the block that a previous fingerprint (step 4820); if so, storing, in a fingerprint buffer, the intermediate fingerprint as a representative fingerprint (step 4822); and if not, keeping the previous fingerprint in the fingerprint buffer as the representative fingerprint (step 4824). In some embodiments, method 4920 can compute the corresponding signature using Mersenne primes. Mersenne primes allow an example implementation of a fingerprint circuit to perform modulo operations on a received shingle using adders that perform relatively fast, rather than using division circuits that perform relatively slow.

The fingerprint circuit can receive a shingle for processing (step 4922). The fingerprint circuit can process multiple shingles of a data block in succession to compute a signature. Furthermore, in some embodiments multiple fingerprint circuits can be arranged in parallel to compute multiple corresponding signatures in parallel for a data block.

Determining a first intermediate fingerprint by processing the received shingle based on linear additions and bit-shifting (step 4924) can include dividing the received shingle into subfields and performing addition among the subfields. For example, the fingerprint circuit can divide the received shingle into four subfields and use adders to add the four subfields and compute the modulo operations corresponding to the Mersenne prime using adders that perform quickly. In some embodiments, the fingerprint circuit can use a first stage of adders to add two groups of subfields, followed by a second stage of adders to add the two groups. If an example of a received shingle is 64-bits and an example Mersenne prime of 2¹⁹−1 is used, an example of the first intermediate fingerprint can be 19 bits after processing using the two stages of adders. The intermediate fingerprint can be bit-shifted by a coefficient Aᵢ to apply a random permutation. Using min wise independent selection, the random permutation can generally provide an improved representation of the contents of the shingle and data block being analyzed. In some embodiments, if the fingerprint circuit is repeated in parallel, a different coefficient can be chosen for each i′th fingerprint circuit.

Determining a second intermediate fingerprint by processing the first intermediate fingerprint based on linear additions with a random constant (step 4926) can include using an adder to add a random coefficient Bᵢ. Using min wise independent selection, the random constant can also generally provide an improved representation of the contents of the shingle and data block being analyzed. In some embodiments, if the fingerprint circuit is repeated in parallel, a different coefficient can be chosen for each i′th fingerprint circuit. In some embodiments, the determining the second intermediate fingerprint can result in a 16-bit intermediate fingerprint for comparison with a previous 16-bit fingerprint in the fingerprint buffer.

Method 4920 can determine whether the intermediate fingerprint is more representative of the overall contents of the block than a previous fingerprint (step 4820). Because the fingerprint circuits can process more than one shingle, the previous fingerprint stored in the fingerprint buffer can be a representative fingerprint for all shingles processed so far by the fingerprint circuit. Some shingles can be expected to result in intermediate fingerprints that are relatively higher or lower. In some embodiments, determining whether the intermediate fingerprint is more representative can include selecting an intermediate or previous fingerprint that is maximal (or minimal) for all shingles processed by the fingerprint circuit. Selecting a maximal or minimal fingerprint can generally result in a better measure of the content of the received block by sampling shingles.

If the second intermediate fingerprint is determined to be more representative of the contents of the block (step 4820: Yes), the second intermediate fingerprint can be stored in the fingerprint buffer as the representative fingerprint (step 4822). For example, determining the intermediate fingerprint to be more or less representative of the contents of the block can include determining whether the intermediate fingerprint is greater than or less than the previous fingerprint, depending on whether a maximal or minimal fingerprint is used for sampling. If the intermediate fingerprint is determined to be more representative, the intermediate fingerprint can therefore replace the previous fingerprint that was initially stored in the fingerprint buffer. If the intermediate fingerprint is determined to be less representative of the contents of the block (step 4820: No), method 4920 can keep the previous fingerprint in the fingerprint buffer as the representative fingerprint for the shingles that have been sampled by the fingerprint circuit (step 4824).

FIG. 49B illustrates an example implementation of fingerprint circuit 1340a, in accordance with some embodiments of the present disclosure. For example, fingerprint circuit 1340a can use a Mersenne prime number to compute a 16-bit fingerprint over 64-bit shingles. Fingerprint circuit 1340a can include shingle 4806a having subfields 4902a-4902d, adders 4904a-4904c, 4908, intermediate fingerprints 4906, 4910, and previous maximum fingerprint 4916.

Fingerprint circuit 1340a can receive shingle 4806a as input. For example, shingle 4806a can be a 64-bit shingle, or any other size shingle that represents a subset or window of a data block. Fingerprint circuit 1340a can divide shingle 4806a into subfields 4902a-4902d. Fingerprint circuit 1340a can perform addition among subfields 4902a-4902d using adders 4904a-4904c to compute intermediate fingerprint 4906. Adders 4904a-4904c allow fingerprint circuit 1340a to compute quickly a modulo corresponding to a Mersenne prime, without needing to use slower division circuits to compute the modulo. FIG. 49B illustrates an example of a fingerprint circuit 1340a corresponding to Mersenne prime 2¹⁹−1, although other Mersenne primes can be used to represent the contents of shingle 4806a and the data block. For example, adders 4904a-4904c may produce a 19-bit intermediate fingerprint. A random permutation can be performed by doing linear transforms based on terms Aᵢ and Bᵢ. The system can generally select values for terms Aᵢ and Bᵢ. For example, fingerprint circuit 1340a can shift intermediate fingerprint 4906 by a number of bits, where the number of bits to shift is given by term A. Fingerprint circuit 1340a can also use adder 4908 to add in a random term Bᵢ to generate a resulting intermediate fingerprint 4910 after the random permutation. In some embodiments, intermediate fingerprint 4910 can be 16 bits. Fingerprint circuit 1340a can use comparator 1340b to select maximum (or minimum) examples of all 4K-7 fingerprints in a 4 KB block, to be buffered in fingerprint (FP) buffer 1340c. In some embodiments, parallel fingerprint computation circuits can use different ALShift and Random Constants Aᵢ and Bᵢ for respective random permutations, so that the permutations are relatively independent. Selecting different values of Aᵢ and Bᵢ can result in different signature samples to obtain a representative sketch of a received data block.

To obtain a maximal (or minimal) fingerprint in each parallel fingerprint circuit, each time an intermediate fingerprint is calculated, comparator 1340b can compare the intermediate fingerprint with fingerprint 4916 previously stored in fingerprint buffer 1340c. If intermediate fingerprint 4910 is smaller than buffered fingerprint 4916, the signature computation can replace the fingerprint in fingerprint buffer 1340c using newly computed fingerprint 4910. When all shingles in a 4 KB block have been parsed by the parallel fingerprint computation circuits, the maximal (or minimal) fingerprint can be stored in fingerprint buffer 1340c, as desired. Accordingly, parallel fingerprint circuits can produce maximal (or minimal) fingerprints selected from different random permutations. These fingerprints can comprise a sketch representing the 4 KB data block to be stored in the tag array associated with the data block.

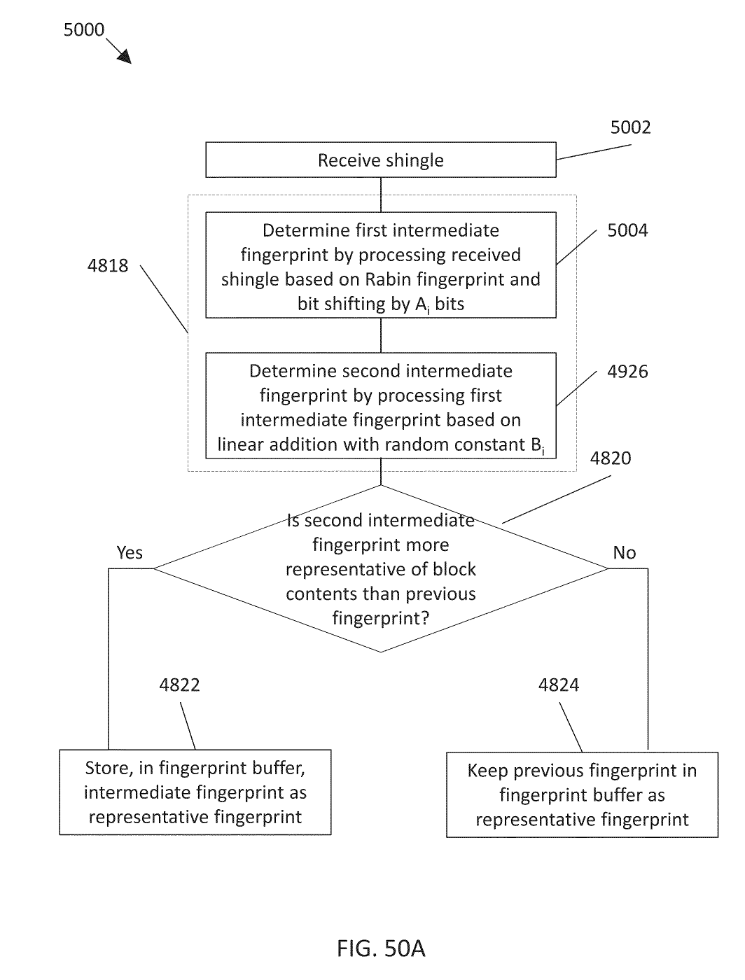

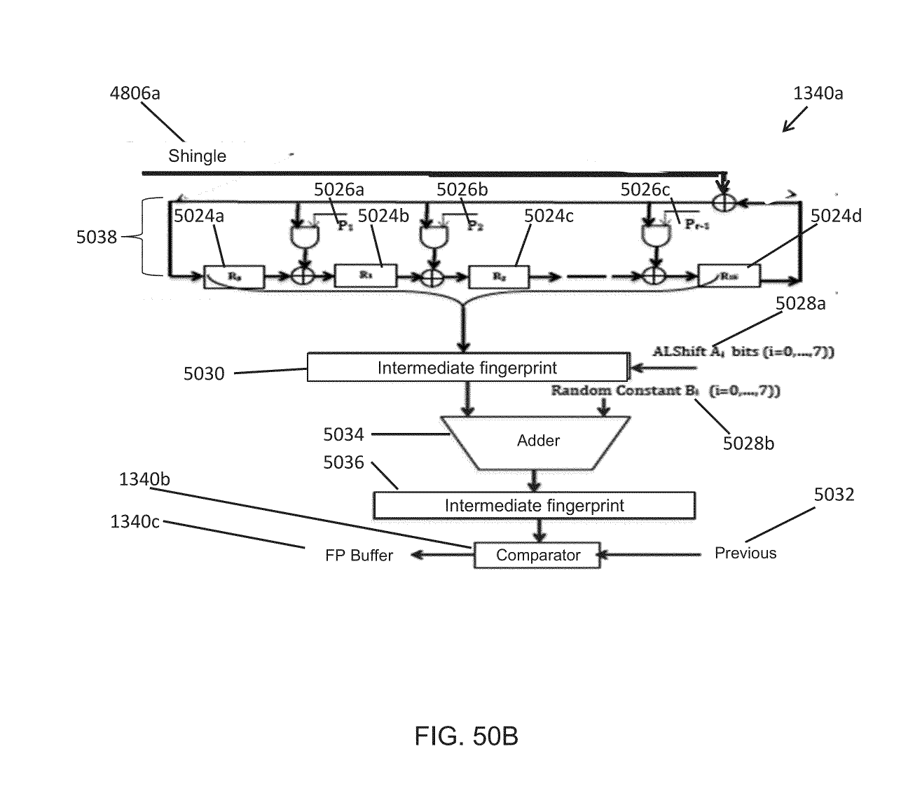

FIG. 50A illustrates an example method 5000 for signature computation for the content locality cache, in accordance with some embodiments of the present disclosure. Method 5000 can include receiving a shingle (step 5002); determining a first intermediate fingerprint by processing the received shingle based on Rabin fingerprinting and bit-shifting the result (step 5004); determining a second intermediate fingerprint by processing the first intermediate fingerprint based on linear additions with a random constant (step 4926); determining whether the second intermediate fingerprint is more representative of the contents of the block that a previous fingerprint (step 4820); if so, storing, in a fingerprint buffer, the intermediate fingerprint as a representative fingerprint (step 4822); and if not, keeping the previous fingerprint in the fingerprint buffer as the representative fingerprint (step 4824). In some embodiments, method 5000 can compute the corresponding signature using Rabin fingerprints and associated polynomials.

The fingerprint circuit can receive a shingle for processing (step 5022). The fingerprint circuit can generally process multiple shingles of a data block in succession to compute a signature. Furthermore, in some embodiments multiple fingerprint circuits can be arranged in parallel to compute multiple corresponding signatures in parallel for a data block.

Determining a first intermediate fingerprint by processing the received shingle based on Rabin fingerprinting and bit-shifting (step 5004) can include applying a polynomial to the received shingle. The polynomial can include terms or coefficients P₁, P₂, . . . , Pᵣ₋₁ to process the received shingle. The polynomial can represent a random irreducible polynomial of the same size as a desired intermediate fingerprint to compute the Rabin fingerprint. Rabin fingerprinting can provide a number of advantages. There can be a lower chance of collisions or conflicts, in which multiple shingles of a given length result in the same hash value even if the multiple shingles represent different contents of data blocks. Additionally, in hardware Rabin fingerprinting can be implemented using shifters and logic gates such as XOR gates, which are relatively fast. Furthermore, when computed over successive shingles, Rabin fingerprinting can leverage previous computations to speed computation of the current intermediate fingerprint. If an example of a received shingle is 64-bits, an example of the first intermediate fingerprint can be 16 bits after processing. If the intermediate fingerprint is desired to be 16 bits, then an example polynomial can be chosen for r=16. The intermediate fingerprint can be bit-shifted by a coefficient Aᵢ to apply a random permutation. In some embodiments, if the fingerprint circuit is repeated in parallel, a different coefficient can be chosen for each i′th fingerprint circuit and different polynomials can be used for each i′th fingerprint circuit.

Determining a second intermediate fingerprint by processing the first intermediate fingerprint based on linear additions with a random constant (step 4926) can include using an adder to add a random coefficient B. In some embodiments, if the fingerprint circuit is repeated in parallel, a different coefficient can be chosen for each i′th fingerprint circuit. In some embodiments, the determining the second intermediate fingerprint can result in a 16-bit intermediate fingerprint for comparison with a previous 16-bit fingerprint in the fingerprint buffer.

Method 5000 can determine whether the intermediate fingerprint is more representative of the overall contents of the block than a previous fingerprint (step 4820). Because the fingerprint circuits can process more than one shingle, the previous fingerprint stored in the fingerprint buffer can be a representative fingerprint for all shingles processed so far by the fingerprint circuit. Some shingles can be expected to result in intermediate fingerprints that are relatively higher or lower. In some embodiments, determining whether the intermediate fingerprint is more representative can include selecting an intermediate or previous fingerprint that is maximal (or minimal) for all shingles processed by the fingerprint circuit. Selecting a maximal or minimal fingerprint can generally result in a better measure of the content of the received block by sampling shingles.

If the second intermediate fingerprint is determined to be more representative of the contents of the block (step 4820: Yes), the second intermediate fingerprint can be stored in the fingerprint buffer as the representative fingerprint (step 4822). For example, determining the intermediate fingerprint to be more or less representative of the contents of the block can include determining whether the intermediate fingerprint is greater than or less than the previous fingerprint, depending on whether a maximal or minimal fingerprint is used for sampling. If the intermediate fingerprint is determined to be more representative, the intermediate fingerprint can therefore replace the previous fingerprint that was initially stored in the fingerprint buffer. If the intermediate fingerprint is determined to be less representative of the contents of the block (step 4820: No), method 5000 can keep the previous fingerprint in the fingerprint buffer as the representative fingerprint for the shingles that have been sampled by the fingerprint circuit (step 4824).

FIG. 50B illustrates another example implementation of fingerprint computation circuit 1340a, in accordance with some embodiments of the present disclosure. For example, fingerprint computation circuit 1340a can use Rabin fingerprinting to compute corresponding signatures. Fingerprint computation circuit 1340a can include shingle 4806a, Rabin fingerprinting subcircuit 5038, intermediate fingerprints 5030, 5036, and coefficients Aᵢ and Bᵢ (5028a, 5028b).

Using Rabin fingerprinting in some embodiments of fingerprint computation circuit 1340a can allow the content locality cache to determine fingerprints based on a property of the block or shingle contents. In general, fingerprint computation circuit 1340a can divide shingle 4806a by a random irreducible polynomial and select the remainder for further use in intermediate fingerprint 5030. As used in Rabin fingerprinting, a random irreducible polynomial can sometimes be referred to as a polynomial that is relatively prime to the input. For example, just as a prime number is not divisible by any other number, input data 5022 is not divisible by the random irreducible polynomial and the random irreducible polynomial is not divisible by input data 5022. Therefore, a remainder can be expected to be generated. Use of Rabin fingerprinting allows the remainder to be generated using a combination of shift registers 5024a-5024d and logic gates such as XOR gates, which perform relatively fast in hardware.

In some embodiments, in an example circuit where r=16, the polynomials can include any eight of the following primitive polynomials implemented as Rabin fingerprinting subcircuit 5038: 210013, 234313, 233303, 307107, 307527, 306357, 201735, 272201, 242413, 270155, 302157, 210205, 305667, 236107. Rabin fingerprinting subcircuit 5038 shows an example subcircuit generated based on a polynomial corresponding to 210013 where Pᵣ₋₁ . . . P₀=(010, 001, 000,000, 001, 011). In other words, the first number in the polynomial is 2 in decimal, which corresponds to 010 in binary for the value of Pᵣ₋₁. The next number in the polynomial is 1 in decimal, corresponding to 001 in binary for the value of Pᵣ₋₂, and so on with 0 in decimal=000 in binary, 0 in decimal=000 in binary, 1 in decimal=001 in binary, and 3 in decimal=011 in binary.

Furthermore, using Rabin fingerprinting can provide efficient reuse of previous calculations. For example, as data block 5022 is being transferred over the I/O bus, Rabin fingerprinting subcircuit 5038 can shift shingles from high order bits to low order bits into shift registers 5024a-5024d. For example, data 5022 can be received most significant bit first. Accordingly, when data transfer on the I/O bus is complete, fingerprint calculations for intermediate fingerprint 5030 can also be expected to complete for the received data block. Some embodiments of fingerprint computation circuit 1340a can use XOR gates and flip flops. The selected hardware can speed the resulting fingerprint computation, compared with relatively slower software implementations of the processes described above. In some embodiments, labeled registers 5024a-5024d can represent single bit registers. For better randomness and independence, in some embodiments fingerprint computation circuit 1340a can use different coefficients 5026a-5026c for different parallel fingerprint circuits.

In some embodiments, fingerprint computation circuit 1340a can perform multiplication of a constant using left shift operations such as with shifters 5024a-5024d. This is because left shift operations can be comparatively faster than multiplication operations that can require multiple instructions to complete.

The fingerprint computation can proceed in a similar manner as described in connection with FIG. 49B. For example, completion of the Rabin fingerprinting can result in intermediate fingerprint 5030. In some embodiments, Rabin fingerprinting subcircuit 5038 can complete with the result being in order of least significant bit first, rather than most significant bit first as data 5022 was received. Accordingly, when swapping the result into a buffer for intermediate fingerprint 5030, Rabin fingerprinting subcircuit 5038 can swap the result to correct the bit order for intermediate fingerprint 5030 to most significant bit first.

Fingerprint circuit 1340a can proceed to perform random permutation and minimum-directed (or maximum-directed) sampling. For example, intermediate fingerprint 5030 can perform a random permutation by performing linear transforms based on coefficients Aᵢ and Bᵢ (5028a, 5028b). Specifically, fingerprint circuit 1340a can shift intermediate fingerprint 5030 based on coefficient Aᵢ (5028a). Fingerprint circuit 1340a can use adder 5034 to add in a random term Bᵢ to generate intermediate fingerprint 5036 after the random permutation. In some embodiments, terms 5028a-5028b in the linear transform formula can be chosen differently for corresponding parallel circuits.

To obtain a maximal (or minimal) fingerprint in each parallel fingerprint circuit, when an intermediate fingerprint 5036 is calculated, comparator 1340b can compare intermediate fingerprint 5036 with previous fingerprint 5032 stored in fingerprint buffer 1340c. If intermediate fingerprint 5036 is smaller than buffered fingerprint 5032, the signature computation can replace the fingerprint in fingerprint buffer 1340c using newly computed fingerprint 5036. When all shingles in a 4 KB block have been parsed by the parallel fingerprint computation circuits, the maximal (or minimal) fingerprint can be stored in fingerprint buffer 1340c, as desired. Accordingly, parallel fingerprint circuits can produce maximal (or minimal) fingerprints selected from different random permutations. These fingerprints can comprise a sketch representing the 4 KB data block to be stored in the tag array associated with the data block.

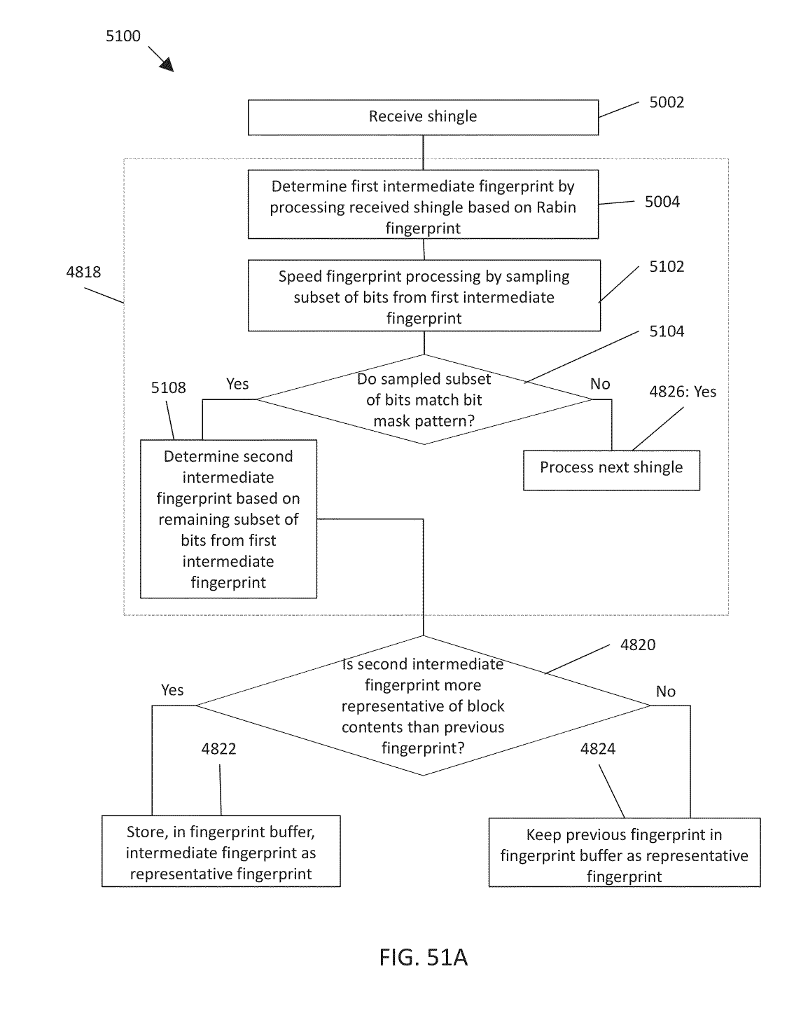

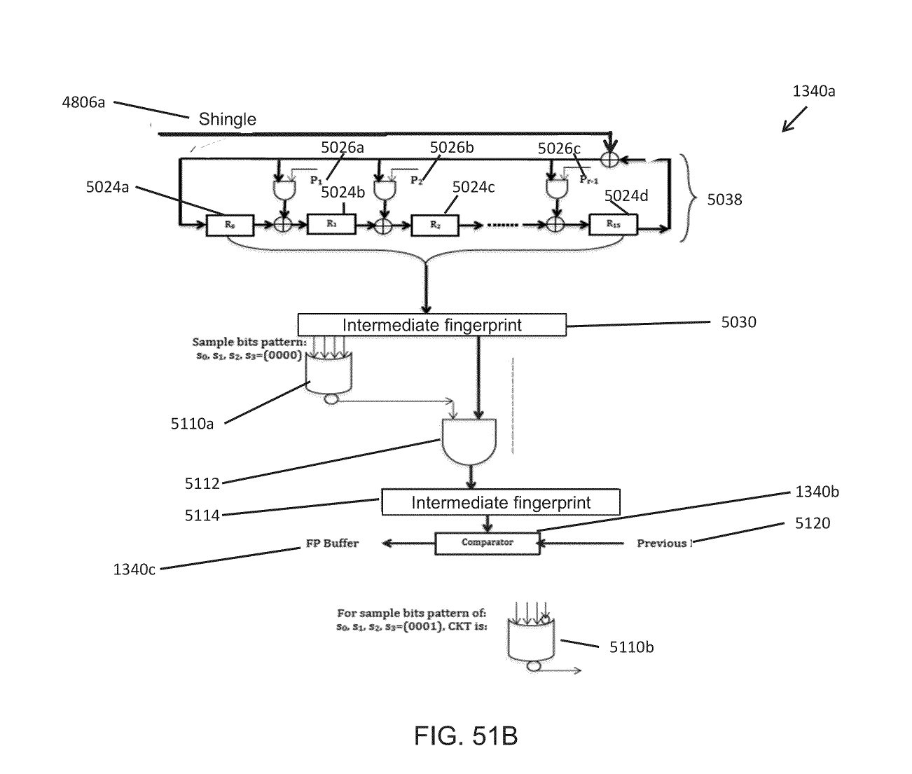

FIG. 51A illustrates an example method 5100 for signature computation for the content locality cache, in accordance with some embodiments of the present disclosure. Method 5100 can include receiving a shingle (step 5002); determining a first intermediate fingerprint by processing the received shingle based on Rabin fingerprints (step 5004); speeding further fingerprint processing by sampling a subset of bits from the first intermediate fingerprint (step 5102); determining whether the sampled bits match a bit mask pattern (step 5104); if the sampled bits do not match the bit pattern, processing the next shingle so as to abort fingerprint processing for the current received shingle (step 4826: Yes); if the sampled bits match the bit mask pattern, determining a second intermediate fingerprint by processing the first intermediate fingerprint based on a remaining subset of bits from the first intermediate fingerprint (step 5108); determining whether the second intermediate fingerprint is more representative of the contents of the block that a previous fingerprint (step 4820); if so, storing, in a fingerprint buffer, the intermediate fingerprint as a representative fingerprint (step 4822); and if not, keeping the previous fingerprint in the fingerprint buffer as the representative fingerprint (step 4824). In some embodiments, method 5100 can compute the corresponding signature by combining Rabin fingerprints and polynomials with sampling.

The fingerprint circuit can receive a shingle for processing (step 5022). The fingerprint circuit can generally process multiple shingles of a data block in succession to compute a signature. Furthermore, in some embodiments multiple fingerprint circuits can be arranged in parallel to compute multiple corresponding signatures in parallel for a data block.

Determining a first intermediate fingerprint by processing the received shingle based on Rabin fingerprinting and bit-shifting (step 5004) can include applying a polynomial to the received shingle. The polynomial can include terms or coefficients P₁, P₂, . . . , Pᵣ₋₁ to process the received shingle. The polynomial can represent an irreducible polynomial of the same size as a desired intermediate fingerprint. If an example of a received shingle is 64-bits, an example of the first intermediate fingerprint can be 16 bits after processing. If the intermediate fingerprint is desired to be 16 bits, then an example polynomial can be chosen for r=16. In some embodiments, if the fingerprint circuit is repeated in parallel, different coefficients or terms can be chosen for P₁, P₂, . . . , Pᵣ₋₁ in each fingerprint circuit.

Speeding the fingerprint processing by sampling a subset of bits from the first intermediate fingerprint (step 5102) can include using a bit mask to sample the subset of bits. An example of a subset of bits from the first intermediate fingerprint can be about 4 bits. If the sampled subset of bits is determined to differ from the bit mask pattern (step 5104: No), method 5100 can process the next shingle, so as to abort fingerprint processing for the current received shingle (step 4826: Yes). In this manner, embodiments of the sampling can speed the fingerprint processing by reducing the number of samples for the fingerprint circuit to process. In other words, some embodiments of the fingerprint circuit can process only fingerprints whose subset of bits matches the sample bit mask.

If the sampled subset of bits is determined to match the bit mask pattern (step 5108: Yes), method 5100 can determine a second intermediate fingerprint based on a remaining subset of bits from the first intermediate fingerprint (step 5108). If an example first intermediate is about 16 bits, the sampling can leave a remaining subset of about 12 bits for further processing as the second intermediate signature. Although intermediate fingerprint sizes of 16 bits and 12 bits are described herein, the sizes of the intermediate fingerprint sizes can vary based on the size of a data block and the contents of the data block. In some embodiments, determining the second intermediate fingerprint can result in a 12-bit second intermediate fingerprint for comparison with a previous 12-bit second intermediate fingerprint in the fingerprint buffer.

Method 5100 can determine whether the second intermediate fingerprint is more representative of the overall contents of the block than a previous fingerprint (step 4820). Because the fingerprint circuits can process more than one shingle, the previous fingerprint stored in the fingerprint buffer can be a representative fingerprint for all shingles processed so far in sequence by the fingerprint circuit. Some shingles can be expected to result in intermediate fingerprints that are relatively higher or lower. In some embodiments, determining whether the intermediate fingerprint is more representative can include selecting an intermediate or previous fingerprint that is maximal (or minimal) for all shingles processed by the fingerprint circuit. Selecting a maximal or minimal fingerprint can generally result in a better measure of the content of the received block by sampling shingles.

If the second intermediate fingerprint is determined to be more representative of the contents of the block (step 4820: Yes), the second intermediate fingerprint can be stored in the fingerprint buffer as the representative fingerprint (step 4822). For example, determining the intermediate fingerprint to be more or less representative of the contents of the block can include determining whether the intermediate fingerprint is greater than or less than the previous fingerprint, depending on whether a maximal or minimal fingerprint is used for sampling. If the intermediate fingerprint is determined to be more representative, the intermediate fingerprint can therefore replace the previous fingerprint that was initially stored in the fingerprint buffer. If the intermediate fingerprint is determined to be less representative of the contents of the block (step 4820: No), method 5100 can keep the previous fingerprint in the fingerprint buffer as the representative fingerprint for the shingles that have been sampled by the fingerprint circuit (step 4824).

FIG. 51B illustrates another example implementation of fingerprint computation circuit 1340a, in accordance with some embodiments of the present disclosure. For example,

FIG. 51 illustrates a different sampling and selection technique. Instead of performing linear transforms based on multiplication and addition as shown previously, some embodiments of fingerprint computation circuit 1340a can use sample bit patterns 5110 to select sample signatures. Fingerprint computation 1340a can include shingle 4806a, Rabin fingerprinting subcircuit 5038, intermediate fingerprints 5030, 5114, sample bitmasks 5110a-5110b, and logic gate 5112.

In some embodiments, fingerprint circuit 1340a can begin similarly as described in connection with FIG. 50B. For example, fingerprint circuit 1340a can use Rabin fingerprinting 5038 to divide shingle 4806a by an irreducible polynomial used for Rabin fingerprinting, and select the remainder for further use in intermediate fingerprint 5030. In some embodiments, in an example circuit where r=16, the polynomials can include any eight of the following primitive polynomials implemented as Rabin fingerprinting subcircuit 5038: 210013, 234313, 233303, 307107, 307527, 306357, 201735, 272201, 242413, 270155, 302157, 210205, 305667, 236107. Rabin fingerprinting subcircuit 5038 shows an example subcircuit generated based on a polynomial corresponding to 210013, where Pᵣ₋₁ . . . P₀=(010, 001, 000,000, 001, 011). In other words, the first number in the polynomial is 2 in decimal, which corresponds to 010 in binary for the value of Pᵣ₋₁. The next number in the polynomial is 1 in decimal, corresponding to 001 in binary for the value of Pᵣ₋₂, and so on with 0 in decimal=000 in binary, 0 in decimal=000 in binary, 1 in decimal=001 in binary, and 3 in decimal=011 in binary.

Rabin fingerprinting subcircuit 5038 can result in intermediate fingerprint 5030. Fingerprint circuit 1340a can use sample bitmask 5110a to mask off, or select, sample bits that match high order bits of intermediate fingerprint 5030. For example, bitmask 5110a can be four bits that match four high order bits of intermediate fingerprint 5030. If logic gate 5112 determines that the high order bits of intermediate fingerprint 5030 match the masked sample bit pattern, fingerprint circuit 1340a can select lower order bits of intermediate fingerprint 5030 as intermediate fingerprint 5114. For example, logic gate 5112 can be a logical AND gate that passes through the low order bits only if the high order bits match bitmask 5110a. In some embodiments, fingerprint circuit 1340a can select the lower order twelve bits of intermediate fingerprint 5030 to determine intermediate fingerprint 5114. If the higher order four bits of intermediate fingerprint 5030 do not match the sample bits encoded in bitmask 5110a, fingerprint circuit 1340a can drop the fingerprint.

In some embodiments, parallel fingerprinting circuits can use different sample bit patterns. For example, if there are eight fingerprinting circuits in parallel, the content locality cache can use eight different bit patterns. Other numbers of parallel fingerprinting circuits can be chosen based on performance needs of the content locality cache. For example, some embodiments of sample bits for use with fingerprint computation circuit 1340a can include s₀, s₁, s₂, s₃, . . . =(0000), (1010), (0101), . . . , (0001), or other permutations of bits. For example, sample bitmask 5110b can implement s₀=0000 for a first fingerprint computation circuit 1340a, s₁=1010 for a second fingerprint computation circuit 1340a, 0101 for a third fingerprint computation circuit 1340a, etc., through 0001 for an eighth fingerprint computation circuit 1340a. Sample bitmask 5010b illustrates how a bitmask can be created based on sample bits. For example, for sample bit pattern (0001), sample bitmask 5110b can accept four inputs, one input corresponding to each bit. Inputs corresponding to logical 0 can enter sample bitmask 5110b directly, such as the leftmost three inputs illustrated in sample bitmask 5110b. Inputs corresponding to logical 1 can enter sample bitmask 5110b via an inverter, or logical not, such as the rightmost input illustrated in sample bitmask 5110b. In this manner, an administrator can create a sample bitmask 5110b gate or circuit corresponding to s₀, . . . , s₇ as described above. Fingerprint circuit 1340a can then sample fingerprints having high order bits that match the sample bit patterns.

Sampling can result in intermediate fingerprint 5114. After sampling, fingerprint circuit 1340a can compare intermediate fingerprint 5114 with a previously saved fingerprint in fingerprint buffer 5120 to determine whether intermediate fingerprint 5114 is larger (or smaller, depending on whether a maximal or minimal fingerprint is desired). If comparator 1340b determines intermediate fingerprint 5114 to be larger, fingerprint circuit 1340a can save intermediate fingerprint 5114 to fingerprint buffer 5120. Otherwise, fingerprint circuit 1340a can drop intermediate fingerprint 5114 and can keep the previously saved fingerprint in fingerprint buffer 5120.

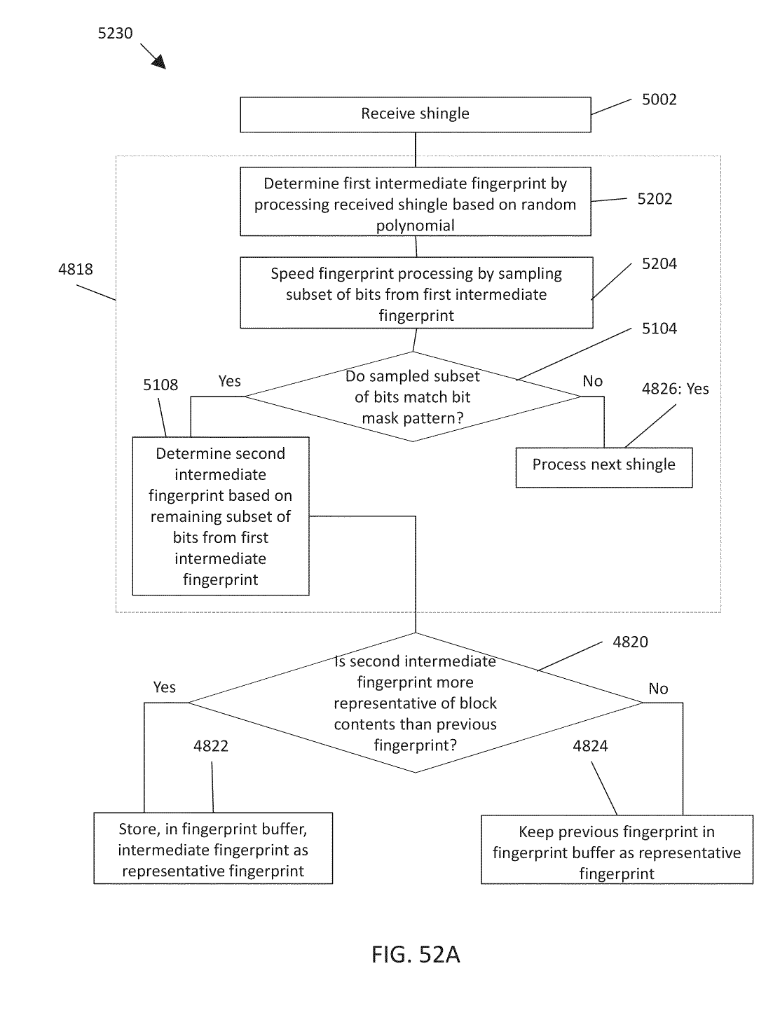

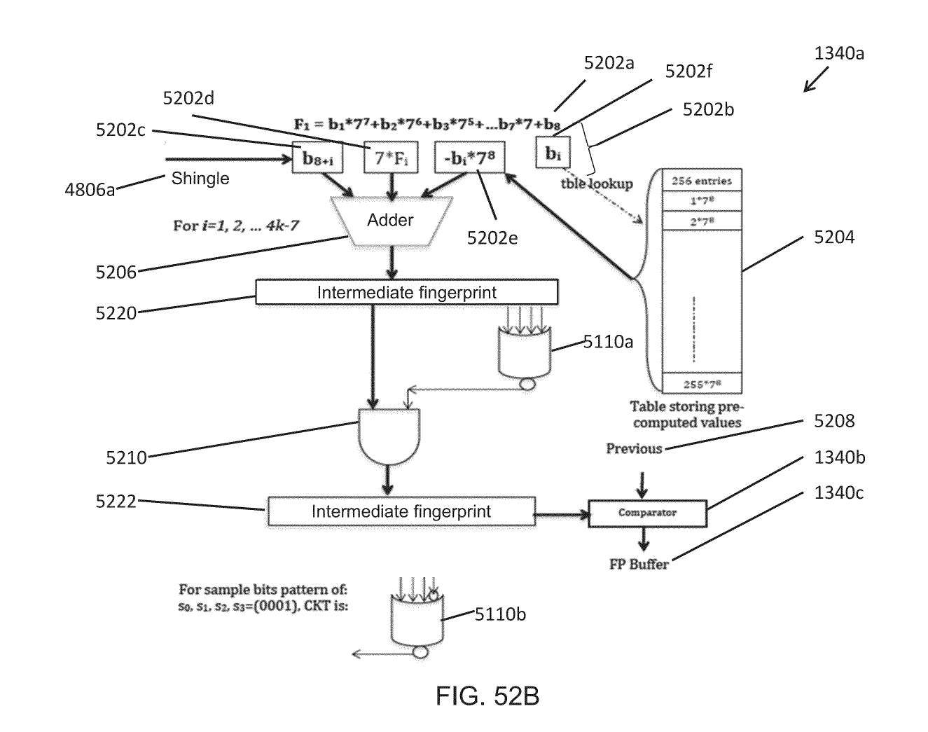

FIG. 52A illustrates an example method 5230 for signature computation for the content locality cache, in accordance with some embodiments of the present disclosure. Method 5230 can include receiving a shingle (step 5002); determining a first intermediate fingerprint by processing the received shingle based on a random irreducible polynomial (step 5202); speeding further fingerprint processing by sampling a subset of bits from the first intermediate fingerprint (step 5204); determining whether the sampled bits match a bit mask pattern (step 5104); if the sampled bits do not match the bit pattern, aborting the fingerprint processing for the received shingle (step 5106); if the sampled bits match the bit mask pattern, determining a second intermediate fingerprint by processing the first intermediate fingerprint based on a remaining subset of bits from the first intermediate fingerprint (step 5108); determining whether the second intermediate fingerprint is more representative of the contents of the block that a previous fingerprint (step 4820); if so, storing, in a fingerprint buffer, the intermediate fingerprint as a representative fingerprint (step 4822); and if not, keeping the previous fingerprint in the fingerprint buffer as the representative fingerprint (step 4824). In some embodiments, method 5230 can compute the corresponding signature by combining fingerprint computation using a random irreducible polynomial with sampling.

The fingerprint circuit can receive a shingle for processing (step 5022). The fingerprint circuit can generally process multiple shingles of a data block in succession to compute a signature. Furthermore, in some embodiments multiple fingerprint circuits can be arranged in parallel to compute multiple corresponding signatures in parallel for a data block.

Determining a first intermediate fingerprint by processing the received shingle based on a random irreducible polynomial (step 5202) can include applying a random irreducible polynomial to the received shingle. In some embodiments, the random irreducible polynomial can be chosen based on a polynomial of a prime number p so as to be irreducible relative to the received shingle. Examples of random irreducible polynomials can include F₁=(b₁*p⁷+b₂*p⁶+b₃*p⁵+b₄*p⁴+b₅*p³+b₆*p²+b₇*p¹+b₈)mod M, where bᵢ denotes the i′th byte string of the shingle and p and M are constants. For example, FIG. 52B illustrates an example random irreducible polynomial of F₁=(b₁*7⁷+b₂*7⁶+b₃*7⁵+b₄*7⁴+b₅*7³+b₆*7²+b₇*7¹+b₈)mod M. M can be chosen based on desired fingerprint length, I/O workload characteristics of applications, circuit complexity, and circuit timing characteristics such as circuit delay. Although FIG. 52B illustrates an example polynomial using p=7 as the chosen prime number, any other prime number can be used. If an example of a received shingle is 64-bits, an example of the first intermediate fingerprint can be 16 bits after processing. Furthermore, in some embodiments, if the fingerprint circuit processes multiple shingles in series, the current random irreducible polynomial can be chosen to be based on a previous random irreducible polynomial. That is, in some embodiments random irreducible polynomial F₂ can be chosen based on random irreducible polynomial F₁. For example, the fingerprint circuit can determine Fⱼ₊₁=b₈₊ᵢ+7*Fⱼ−bᵢ*7⁸. In some embodiments, if the fingerprint circuit is repeated in parallel, a different value for p can be chosen in each fingerprint circuit.

In some embodiments, determining the first intermediate fingerprint by processing the received shingle based on a random irreducible polynomial (step 5202) can include using fast table lookups to speed computation of the random irreducible polynomial. For example, a lookup table in the fingerprint circuit can pre-compute and store possible values of bᵢ*p⁸. Therefore, when the fingerprint circuit determines Fᵢ₊₁ based on Fᵢ, the value of bᵢ*p⁸ used in the formula can be performed via a relatively faster table lookup rather than a relatively slower multiplication or left shift.

Speeding the fingerprint processing by sampling a subset of bits from the first intermediate fingerprint (step 5204) can include using a bit mask to sample the subset of bits. An example of a subset of bits from the first intermediate fingerprint can be about 4 bits such as the lower order 4 bits. If the sampled subset of bits is determined to differ from the bit mask pattern (step 5104: No), method 5230 can abort the fingerprint processing for the received shingle (step 5106). In this manner, embodiments of the sampling can speed the fingerprint processing by reducing the number of intermediate fingerprints or samples for the fingerprint circuit to process. In other words, some embodiments of the fingerprint circuit can process only intermediate fingerprints whose subset of bits matches the sample bit mask.

If the sampled subset of bits is determined to match the bit mask pattern (step 5108: Yes), method 5230 can determine a second intermediate fingerprint based on a remaining subset of bits from the first intermediate fingerprint (step 5108). If an example first intermediate is about 16 bits, the sampling can leave a remaining subset of about 12 bits for further processing as the second intermediate signature. Although intermediate fingerprint sizes of 16 bits and 12 bits are described herein, the sizes of the intermediate fingerprint sizes can vary based on the size and/or contents of a data block. In some embodiments, determining the second intermediate fingerprint can result in a 12-bit second intermediate fingerprint for comparison with a previous 12-bit second intermediate fingerprint in the fingerprint buffer.

Method 5230 can determine whether the second intermediate fingerprint is more representative of the overall contents of the block than a previous fingerprint (step 4820). Because the fingerprint circuits can process more than one shingle, the previous fingerprint stored in the fingerprint buffer can be a representative fingerprint for all shingles processed so far in sequence by the fingerprint circuit. Some shingles can be expected to result in intermediate fingerprints that are relatively higher or lower. In some embodiments, determining whether the intermediate fingerprint is more representative can include selecting an intermediate or previous fingerprint that is maximal (or minimal) for all shingles processed by the fingerprint circuit. Selecting a maximal or minimal fingerprint can generally result in a better measure of the content of the received block by sampling shingles.

If the second intermediate fingerprint is determined to be more representative of the contents of the block (step 4820: Yes), the second intermediate fingerprint can be stored in the fingerprint buffer as the representative fingerprint (step 4822). For example, determining the intermediate fingerprint to be more or less representative of the contents of the block can include determining whether the intermediate fingerprint is greater than or less than the previous fingerprint, depending on whether a maximal or minimal fingerprint is used for sampling. If the intermediate fingerprint is determined to be more representative, the intermediate fingerprint can therefore replace the previous fingerprint that was initially stored in the fingerprint buffer. If the intermediate fingerprint is determined to be less representative of the contents of the block (step 4820: No), method 5230 can keep the previous fingerprint in the fingerprint buffer as the representative fingerprint for the shingles that have been sampled by the fingerprint circuit (step 4824).

FIG. 52B illustrates another example implementation of fingerprint circuit 1340a, in accordance with some embodiments of the present disclosure. Fingerprint circuit 1340a illustrates a hardware circuit corresponding to a software implementation of signature computation for content locality caching. Fingerprint circuit 1340a includes polynomial 5202a implemented using terms 5202b, adder 5206, intermediate fingerprints 5220, 5222, logic gate 5210, and sample bitmasks 5110a-5110b.

In some embodiments, fingerprint circuit 1304a can generate a random irreducible polynomial such as polynomial 5202a for a shingle of data 5212. Further description on generating random irreducible polynomials for each shingle is disclosed in Udi Manber, “Finding Similar Files in a Large File System,” 1994 USENIX Tech Conference, the entire contents of which are incorporated by reference herein.

Polynomial 5202a can denote the byte string corresponding to data 5212 by b₁, b₂, b₃, . . . , bₙ. In some embodiments, taking the shingle size to be eight bytes, fingerprint circuit 1340a can determine intermediate fingerprint 5220 to be:

F₁=(b₁*p⁷+b₂*p⁶+b₃*p⁵+b₄*p⁴+b₅*p³+b₆*p²+b₇*p¹+b₈)mod M

where p and M are constants. For example, fingerprint circuit 1340a illustrates an example in which p=7 with a shingle size of eight bytes. In general, p can be any prime number. Constant M can be determined based on fingerprint length. For example, FIG. 52 illustrates an example in which M=2¹⁶, while a different implementation such as some embodiments of a software implementation can use M=2²⁴. In some embodiments, the parameters may be tuned and determined based on I/O workload characteristics of applications, circuit complexity, and circuit delay.

In some embodiments, fingerprint circuit 1340a can use Horner's formula to calculate F₁ in polynomial 5202a:

F₁=(p·(( . . . (p·(·d b₁+b₂)+b₃) . . . ))+b₈)mod M.

Furthermore, fingerprint circuit 1340a can calculate second fingerprint F₂ (5202b) based on fingerprint F₁ (5202a) and adder 5206 as follows:

F₂=(p*(F₁−(b₁*p⁷))+b₉)mod M

The result of adder 5206 can be stored in intermediate fingerprint 5220. In some embodiments, intermediate fingerprint 5220 can be sixteen bits. Some embodiments of fingerprint circuit 1340a can calculate fingerprints recursively for the rest of the shingles.

In some embodiments, fingerprint circuit 1340a can precompute possible values of bᵢ*p⁸, and store the precomputed values in lookup table 5204. For example, fingerprint circuit 1340a can precompute all 256 possible values of bᵢ*p⁸. During signature computation, in some embodiments fingerprint circuit 1340a can look up in lookup table 5204 to find a desired value corresponding to a current byte value under analysis. Fingerprint circuit 1340a can then perform addition using adder 5206 to obtain intermediate fingerprint 5220. In some embodiments, intermediate fingerprint 5220 can be sixteen bits.

Fingerprint circuit 1340a can use sample bitmask 5110a to mask off, or select, sample bits that match low order bits of intermediate fingerprint 5220. For example, bitmask 5110a can be four bits that match four low order bits of intermediate fingerprint 5220. If logic gate 5210 determines that the low order bits of intermediate fingerprint 5220 match the masked sample bit pattern, fingerprint circuit 1340a can select higher order bits of intermediate fingerprint 5220 as intermediate fingerprint 5222. For example, logic gate 5210 can be a logical AND gate that passes through the higher order bits only if the lower order bits match bitmask 5110a. In some embodiments, fingerprint circuit 1340a can select the higher order twelve bits of intermediate fingerprint 5220 to determine intermediate fingerprint 5222. If the lower order four bits of intermediate fingerprint 5030 do not match the sample bits encoded in bitmask 5110a, fingerprint circuit 1340a can drop the fingerprint.

In some embodiments, parallel fingerprinting circuits can use different sample bit patterns. For example, if there are eight fingerprinting circuits in parallel, the content locality cache can use eight different bit patterns. Other numbers of parallel fingerprinting circuits can be chosen based on performance needs of the content locality cache. For example, some embodiments of sample bits for use with fingerprint computation circuit 1340a can include s₀, s₁, s₂, s₃, . . . (0000), (1010), (0101), . . . , (0001), or other permutations of bits. For example, sample bitmask 5110b can implement s₀=0000 for a first fingerprint computation circuit 1340a, S₁=1010 for a second fingerprint computation circuit 1340a, 0101 for a third fingerprint computation circuit 1340a, etc., through 0001 for an eighth fingerprint computation circuit 1340a. Sample bitmask 5010b illustrates how a bitmask can be created based on sample bits. For example, for sample bit pattern (0001), sample bitmask 5110b can accept four inputs, one input corresponding to each bit. Inputs corresponding to logical 0 can enter sample bitmask 5110b directly, such as the leftmost three inputs illustrated in sample bitmask 5110b. Inputs corresponding to logical 1 can enter sample bitmask 5110b via an inverter, or logical not, such as the rightmost input illustrated in sample bitmask 5110b. In this manner, an administrator can create a sample bitmask 5110b gate or circuit corresponding to s₀, s₇ as described above. Fingerprint circuit 1340a can then sample fingerprints having high order bits that match the sample bit patterns.

In some embodiments, sampling can result in intermediate fingerprint 5222. For example, intermediate fingerprint 5222 can be twelve bits after the low order four bits have been masked off. After sampling, fingerprint circuit 1340a can compare intermediate fingerprint 5222 with a previously saved fingerprint in fingerprint buffer 5208 using comparator 1340b to determine whether intermediate fingerprint 5222 is larger (or smaller, depending on whether a maximal or minimal fingerprint is desired). If comparator 1340b determines intermediate fingerprint 5222 to be larger, fingerprint circuit 1340a can save intermediate fingerprint 5222 to fingerprint buffer 5208. Otherwise, fingerprint circuit 1340a can drop intermediate fingerprint 5222 and can keep the previously saved fingerprint in fingerprint buffer 5208. The resulting fingerprint stored in fingerprint buffer 1340c can be used as part of a sketch of a data block corresponding to data 5212.

### Periodic Independent Block Scanning

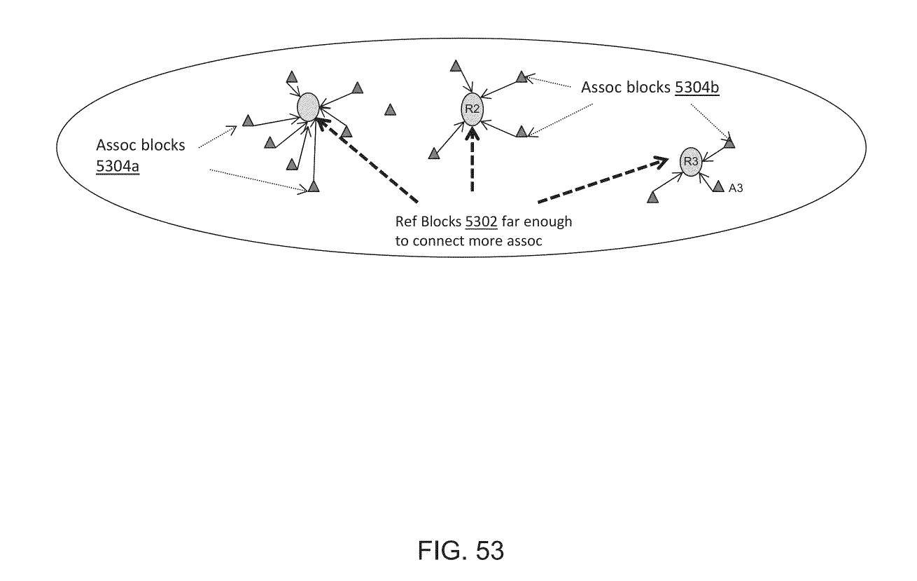

FIG. 53 illustrates an example block diagram of periodic scanning between reference blocks and associated blocks, in accordance with some embodiments of the present disclosure.

Periodically, the content locality cache can use scan logic to scan independent blocks in the background, to identify new reference blocks and associated delta blocks. In some embodiments, during each scan cycle the scan logic can iterate over independent blocks starting with most recently used blocks to least recently used blocks. For each block, the content locality cache can accumulate a popularity measure for the block by adding popularity values corresponding to fingerprints of a related sketch. If the popularity exceeds a predetermined threshold, the independent block may become a reference candidate. The reference candidate blocks can then participate in similarity detection to identify associated blocks that can be delta compressed to small enough deltas. During the scan process, in some embodiments RAM cache can be used as temporary storage. For example, the RAM can store intermediate data until blocks are classified and stored in their respective data area in the nonvolatile data array.

While selecting reference blocks, one consideration is that distance in terms of similarity between any two reference blocks 5202 be selected to be large enough so that each reference block forms a center of cluster surrounded by associated blocks 5204a, 5204b. This consideration can have a direct impact on I/O performance in addition to content popularity. For example, let blocks R3 (reference block) and A3 (associated block) both have a high popularity value, and further assume R3 and A3 are very similar in content. The content locality cache can select one block as a reference block (e.g., R3) while selecting the other block as an associated delta block (e.g., A3). In contrast, if both R3 and A3 were classified as reference blocks, the number of associated blocks would be much smaller than identifying blocks R3 and R2 as reference blocks. This is because reference block R2 could be far away from reference block R3. Selecting reference blocks with an appropriate distance in similarity may give rise to larger numbers of possible associated blocks.

In some embodiments, the periodical scanning can be triggered either after a fixed number of I/O operations or a fixed amount of time. For example, the scanning can be triggered after a predetermined threshold number of I/O operations, e.g., 20,000 I/O operations. Therefore, the content locality cache can use a counter or timer/idle detector 1334 for this purpose (shown in FIG. 13B). It may also be desirable to flush cached dirty blocks from write-back cache to primary storage when possible, so that primary storage can quickly have the most up to date data. It may be particularly beneficial to start dirty block flushing when the system is determined to be idle. Timer/idle detector 1334 (shown in FIG. 13B) can also serve this purpose.

Eviction logic may identify cached blocks to evict by updating a least recently used (LRU) counter in a status bit field of a tag array corresponding to each cached block. For example, upon a cache miss, the LRU counter of the newly cached block may be set to a maximal value. All LRU counters corresponding to data blocks in cache may be decremented by 1. Upon a cache hit, the LRU counter of the hit block may be set to maximal. LRU counters of other blocks that were smaller than the original LRU value of the accessed block may be decremented by 1. In this way, the system preserves a least recently used (LRU) ordering of all cached data blocks. For example, if a set size of the cache is 1 MB, the systems may use 8-bit LRU counters for a block size of 4 KB. For larger set sizes, the systems may use longer LRU counters. For example, a 32-bit LRU counter may be able to accommodate a set size of up to 16 TB.

When cache is full, a cache miss may trigger eviction of another cached block to make room for caching the missed block. For example, the eviction logic may select the cache block with the lowest LRU counter value. If the selected block is an independent block, the systems can simply replace the independent block and write the independent block back to primary storage if the independent block is in dirty state. If the selected block is an associated delta block in dirty state, the eviction logic may trigger a decompression operation with respect to the reference block identified by a reference pointer of the associated delta block. After the decompression, the recreated block may be written back to the primary storage. Lastly, if the selected block is a reference block, the eviction logic may find all related associated blocks with matching reference pointers. For example, the eviction logic may perform an associative search in the tag array to identify the related associated blocks. All such matched associated blocks may be evicted together with the reference block. In practice, eviction of a reference block is expected to be a rare event because any time an associated block is accessed by an I/O operation, the corresponding reference block is also accessed. Therefore, reference blocks exhibit a much higher chance to be on top of the LRU list compared with other blocks. If a reference block ends up falling down to the bottom of the LRU list, in practice the chances are that the corresponding associated blocks in the cache are no longer active. I.e., the corresponding associated blocks have not been referenced by I/O operations for a long time. These corresponding associated blocks have therefore either already been evicted from the cache, or should be evicted.

### Comparison of Expected Performance

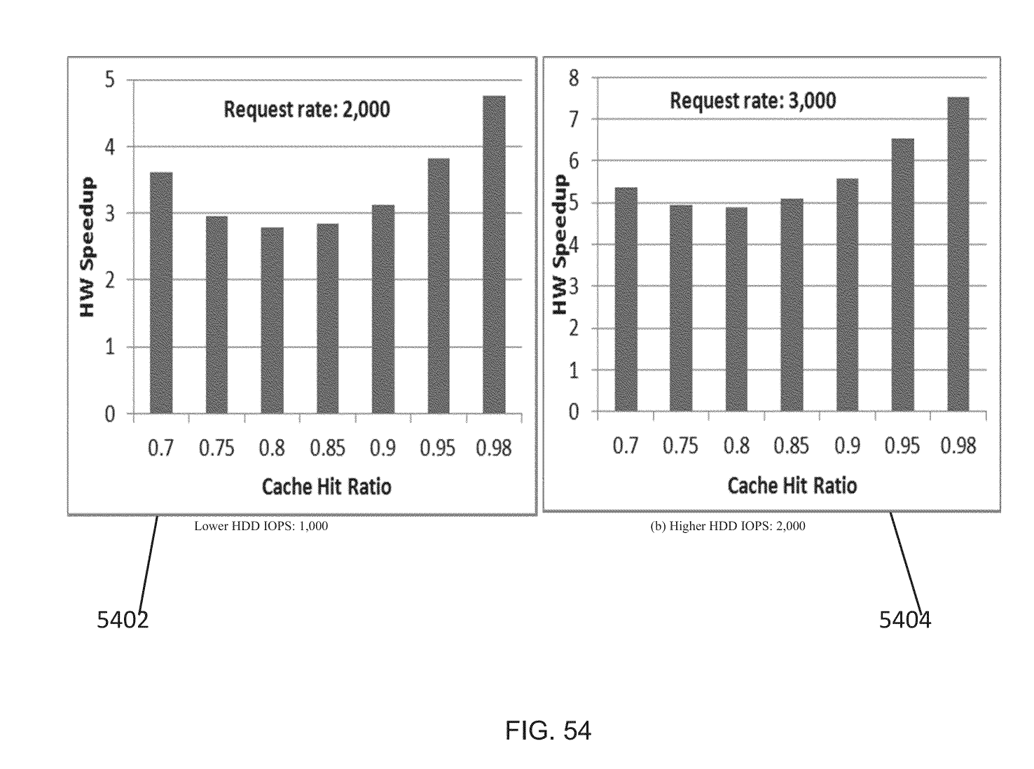

FIG. 54 illustrates expected performance for an example hardware implementation of content locality based caching, in accordance with some embodiments of the present disclosure. FIG. 54 illustrates example performance analysis graphs 5402, 5404 to assess potential benefits of the content locality based cache design.

Average I/O access time with the content locality cache may be expressed by

T_{Ave}=H_{R}* T_{H}+(1−H_{R})*T_{M} (8)

where H_{R} represents a cache hit ratio, T_{H} represents an access time upon a cache hit, and T_{M} represents access time upon a cache miss. Graphs 5402, 5404 illustrate expected hardware speedup as a function of H_{R}. The present disclosure first derives a number of equations for representing hardware speedup as a function of H_{R} and other factors, and then applies the equations to explain graphs 5402, 5404.

In some embodiments, whenever the I/O request rate gets high and approaches the I/O service rate, there may be a queuing effect to queue requests for servicing. In this case, analysis of average I/O access time may increase in complexity. One simplification may be to assume that both request process and service process follow a Poisson distribution (i.e., a probabilistic memoryless distribution). With this simplification, average I/O access time may be given with simplified formulas as follows.

Let the I/O request rate, i.e., the number of I/O requests received by the storage system per second, be represented by λ. Let the service rate, i.e., the number of I/Os served by the storage system per second, be represented by μ. If the disk access time is assumed to be 10 ms, then t=1/10 ms=100 IOPS (I/O operations per second). With cache, if the average I/O service latency is 500 us (microseconds), then μ=1/500 us=2,000 IOPS. Traffic intensity, or queue utilization (i.e., the proportion of time that primary storage is busy), ρ, may thereby be given by

ρ=λ/μ, where ρ is expected to be less than 1

Average I/O time including queuing delay may then be given by (M/M/1 queue)

$${T}_{total} = \frac{1 / μ}{1 - ρ} = \frac{1}{μ - λ} \qquad ( 9 )$$

Accordingly, service rate μ may become

μ=1/T_{Ave}=1/(H_{R}*T_{H}+(1−H_{R})*T_{M}). (10)

When μ is close to λ, I/O latency may become large. Therefore, the content locality cache may benefit from limiting I/O latency by maximizing H_{R} while minimizing T_{H} and T_{M} to keep the systems stable.

Returning to graphs 5402, 5404, FIG. 54 illustrates an expected example hardware speedup over a corresponding software implementation as a function of cache hit ratio H_{R}. FIG. 54 assumes that a software implementation takes 200 μs to finish one SSD operation, while a corresponding hardware implementation takes 50 μs. Graph 5302 illustrates setting IOPS for the primary storage to 1,000 assuming a typical and low end RAID storage. Graph 5402 further illustrates setting the I/O request rate from the host to 2,000. Graph 5402 thereby illustrates that the expected hardware speedup may be substantial for hit ratios ranging from 70% to 98%. Graph 5404 illustrates that, upon increasing IOPS of the primary storage and host I/O request rate to 2,000 and 3,000, respectively, the speedups may be expected to be even greater.

One interesting note is that the hardware speedup changes from high to low and then to high again when cache hit ratio increases from 70% to 98% as illustrated in graphs 5302, 5304. The reason for these speedup changes may be explained herein. At lower cache hit ratio, average I/O access time calculated using Equation (8) is large, resulting in the service rate μ (Equation (10)) being close to the host I/O request rate λ. As a result, queuing delay may become large and therefore any latency improvement can result in great performance gain. As hit ratio H_{R} increases, the queuing effect reduces because the service rate μ increases with respect to the fixed request rate λ. However, as the hit ratio increases further, the cache access time becomes a significant portion of the total I/O time. Therefore, the hardware speedup increases again as shown in graphs 5402, 5404.

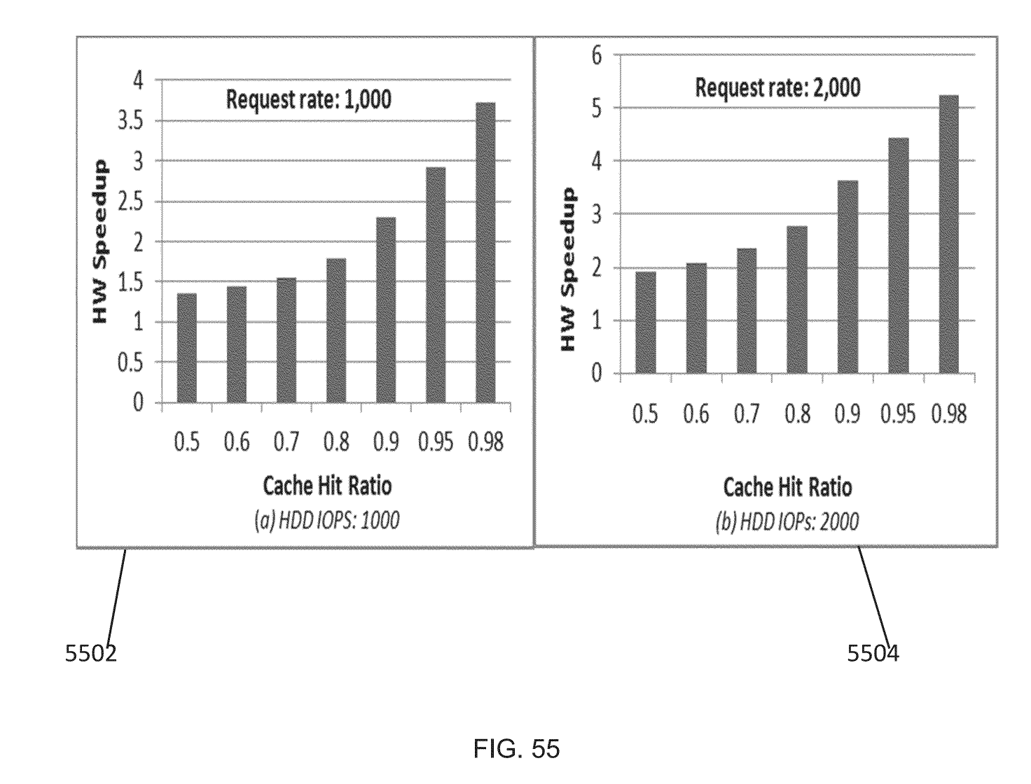

FIG. 55 illustrates expected performance for another example hardware implementation of content locality based caching, in accordance with some embodiments of the present disclosure. FIG. 55 illustrates example performance analysis graphs 5502, 5504 to assess potential benefits of the content locality based cache design. In contrast to FIG. 54, graphs 5502, 5504 use a smaller I/O request rate to plot hardware speedup as a function of hit ratio H_{R}. Accordingly, FIG. 55 allows verification of the observation and analysis of the speedup changes with respect to hit ratio.

Graphs 5502, 5504 illustrate that queuing effect ρ is not significant because host request rate λ may be much smaller than service rate μ of the example storage system. Similar to FIG. 54, the hardware speedup may monotonically increase as the hit ratio increases, which is the result of cache hit time difference.

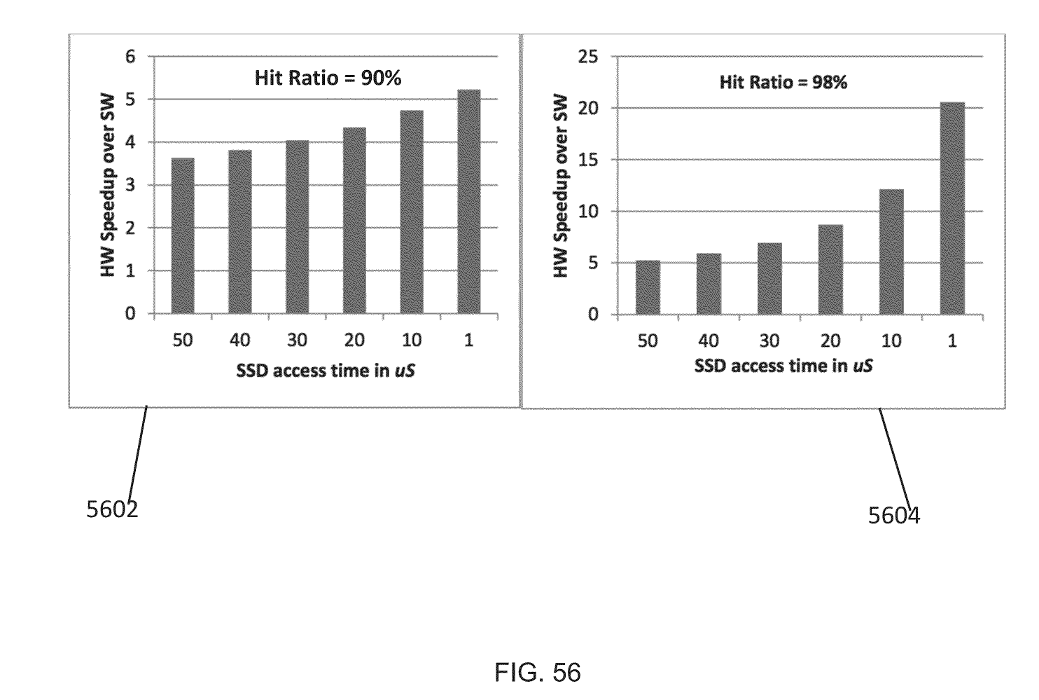

FIG. 56 illustrates expected performance for another example hardware implementation of the content locality based caching, in accordance with some embodiments of the present disclosure. FIG. 56 illustrates example performance analysis graphs 5602, 5604 to assess potential benefits of the content locality based cache design.

As the SSD latency reduces following the technology trend, the content locality caching is likely to show increasing performance advantages. To quantitatively analyze such trend, graphs 5602, 5604 plot expected hardware speedup for different SSD access times. Graphs 5602, 5604 illustrate hypothetically decreasing SSD access latency for both hardware implementations and software implementations. Graphs 5602, 5604 keep all other parameters similar to the parameters illustrated in graphs 5502, 5504 (shown in FIG. 55). Graphs 5602, 5604 illustrate that as SSD technology improves, expected advantages of the hardware implementation of content locality based caching may become more pronounced. That is, the higher the cache hit ratio, the greater performance improvement the hardware implementation of content locality based caching may provide when compared with a software implementation.

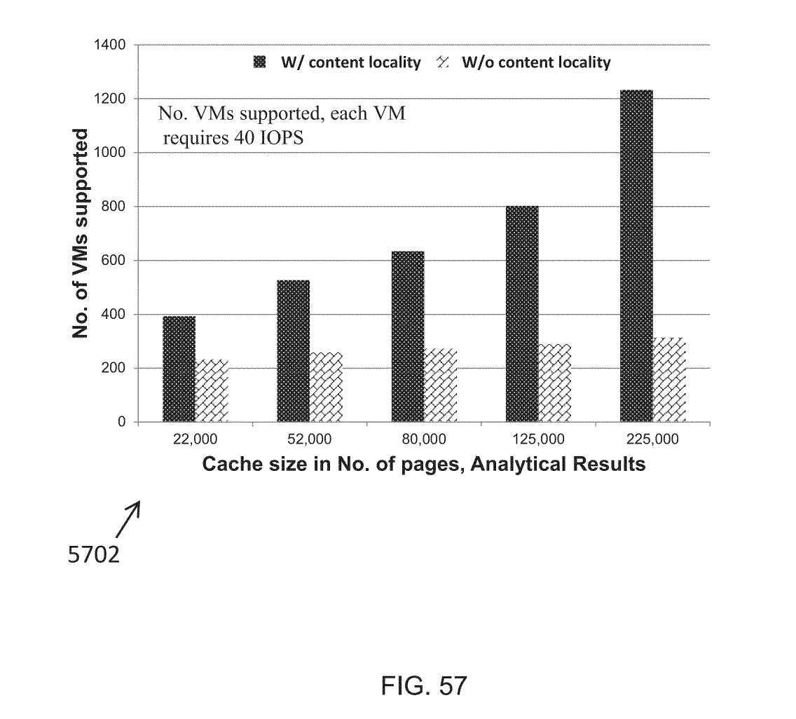

FIG. 57 illustrates an expected comparison 5702 of a number of virtual machines supportable in content locality based caching compared with traditional caching, in accordance with some embodiments of the present disclosure.

In virtualized environments such as environments running multiple virtual machines (VMs), storage I/O has become a performance bottleneck. Reasons include: (1) multiple VMs may share primary storage, which may cause the primary storage to be a bottleneck, and (2) aggregated I/O operations from multiple virtual machines may appear mostly random from the perspective of the primary storage. First, multiple virtual machines (VMs) on a hypervisor may share storage I/O devices. A hypervisor refers to a separate “virtual machine monitor” running on the system that manages operation of multiple VMs. Each VM may have its own OS image and application environment stored on primary data stores. These OS images and application environments may create a burden of I/O contention, thereby causing bottlenecks at primary storage. Second, although I/O operation streams of individual VMs may show some spatial locality with sequential I/O operations, aggregated I/O operations from the perspective of the storage device may appear mostly randomized. Accordingly, the primary storage may perform poorly, exacerbating adverse bottleneck effects.

Graph 5702 illustrates that the content locality based cache may be expected to improve VM performance when compared to traditional cache solutions. Accordingly, the content locality based cache may support more VMs on a single hypervisor. The content locality based cache may boost VM performance in two independent ways: (1) decreasing latencies of random I/O operations, and (2) exploiting content locality of OS images and application code, in addition to content locality of data. First, effectively caching hot data in SSD may be expected to decrease latencies dramatically of random I/O operations, by eliminating a number of random seeks and rotation delays associated with HDDs. Second, OS images and application code of multiple VMs running on the hypervisor may be mostly similar in data content. Therefore, OS iamges and application code may also be expected to benefit from content locality. The systems may further take advantage of content locality of data being accessed. As a result, the caching may reduce active data footprints stored in SSD cache, which may increase cache efficiency. If the content locality cache is implemented in hardware, some embodiments may omit the need to have special software running on a hypervisor (except for generic driver software for the hardware). In other words, the corresponding caching functions may be offloaded and run on a hardware implementation, a custom ASIC, or firmware on the primary storage device.

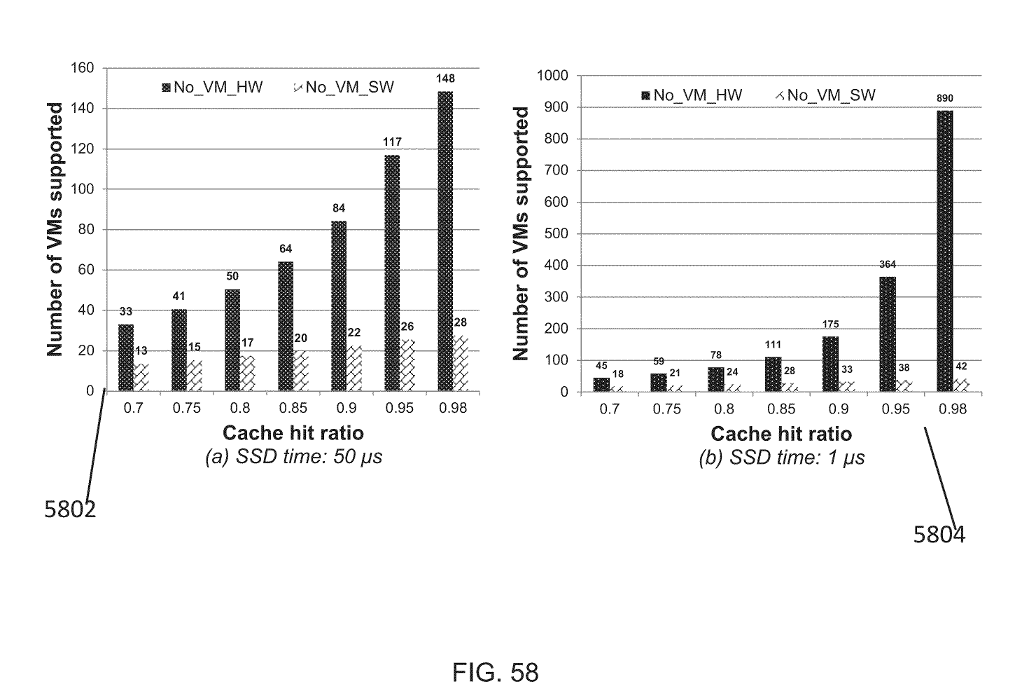

FIG. 58 illustrates expected comparisons 5802, 5804 of a number of virtual machines supportable in content locality based caching using an example hardware implementation compared with an example software implementation, in accordance with some embodiments of the present disclosure.

Graphs 5802, 5804 analyze potential or expected benefits of a hardware implementation in virtual environments having multiple virtual machines (VMs). For example, suppose that each VM running on a hypervisor using content locality caching requires certain IOPS to run with a maximally tolerable I/O latency, T_{Max}. With these I/O constraints, graphs 5702, 5704 illustrate an example analysis of how many VMs the hypercache can support in a hardware implementation (No_VM_HW) and in a software implementation (No_VM_SW). Let N_{VM} be the number of VMs that can run on the hypervisor with the above I/O requirements. Equation (9) results in:

T_{Max}=Tₜₒₜₐₗ=1/(1/T_{Ave}−N_{VM}*IOPS),

which leads to:

N_{VM}=(T_{Max}−T_{Ave})/(T_{Max}*T_{Ave}*IOPS). (11)

Based on Equation (11), FIG. 58 illustrates an example number of VMs supported on a hypervisor as a function of cache hit ratio H_{R}, assuming SSD access time to be 50 μs (graph 5702) and 1 μs (graph 5704). Graphs 5802, 5804 further assume the HDD may be a high performance SAN with average IOPS being 2K, each VM requiring 100 IOPS, and a maximal I/O latency of 10 ms. Generally, the number of virtual machines supported would be limited without cache. Graphs 5802, 5804 illustrate that by using an SSD cache, a software implementation may expect to support a number of VMs from 13 to 42 (No_VM_SW) depending on cache hit ratio. Under a hardware implementation, the expected number of VMs supported may go as high as 890 (No_VM_HW), which may represent an over twentyfold boost in virtual environments.

Furthermore, some embodiments may also reduce memory pressures that many VMs experience, by offloading content locality based cache functions to a hardware implementation. VM companies have proposed techniques for reducing memory pressure such as ballooning, page sharing, and swapping. Regardless of such techniques, available physical memory to VMs remains a limiting factor for the number of VMs that a hypervisor can support. If content locality based caching is implemented in software, the cache can require at least some amount of memory, thereby competing with memory available to VMs. Therefore, offloading content locality based caching to a hardware implementation on a storage device may be expected to increase the number of VMs that can run on a hypervisor on the same server hardware.

The present disclosure has presented a hardware implementation of a cache design using solid state drive (SSD) technology that exploits content locality, temporal locality, and spatial locality of I/O operations. The hardware implementation may be easily implemented using simple hardware and intelligent processing units. Many caching functions may be carried out in parallel to normal I/O processes, with minimal overhead. In addition to effective cache functions, content locality based caching also offers advantages in terms of increasing SSD endurance, data reduction as a superset of deduplication, and excellent scalability for clusters of servers. The present disclosure has described approximate analysis that shows expected benefits of offloading caching to hardware implementations. The performance improvement of offloading the cache functions may be expected to be significant due to high speed hardware that manages caching in parallel to applications running on host. Furthermore, in some embodiments the overall performance gain of implementing caching on hardware may be amplified in virtualized environments, leading to increased number of virtual machines that can be supported and corresponding high I/O performance.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it may be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It may further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the methods and systems described herein have been disclosed in connection with some embodiments shown and described in detail, various modifications and improvements thereon may become readily apparent to those skilled in the art. Accordingly, the spirit and scope of the methods and systems described herein is not to be limited by the foregoing examples, but is to be understood in the broadest sense allowable by law.

All documents referenced herein are hereby incorporated by reference.

What is claimed is:

1. A method for computing a signature of contents of a block in a cache, the method comprising:
dividing a received block into shingles, wherein each shingle represents a subset of the received block;
for each shingle,
determining an intermediate fingerprint by processing the shingle;
determining whether the intermediate fingerprint is more representative of the contents of the block than a previous fingerprint;
if the intermediate fingerprint is determined to be more representative of the contents of the block, storing the intermediate fingerprint as a representative fingerprint;
if the intermediate fingerprint is determined to be less representative of the contents of the block, keeping the previous fingerprint as the representative fingerprint;
determining whether there are more shingles to process;
if there are more shingles to process, processing the next shingle; and
if there are no more shingles to process, computing the signature of the contents of the block by adding the representative fingerprint to a sketch of the received block.

2. The method of claim 1,
wherein determining whether the intermediate fingerprint is more representative of the contents of the block than the previous fingerprint comprises comparing the intermediate fingerprint with the previous fingerprint to determine whether the intermediate fingerprint is larger compared with the previous fingerprint, and
if the intermediate fingerprint is determined to be larger compared with the previous fingerprint, the intermediate fingerprint is determined to be more representative of the contents of the block.

3. The method of claim 1,
wherein determining whether the intermediate fingerprint is more representative of the contents of the block than the previous fingerprint comprises comparing the intermediate fingerprint with the previous fingerprint to determine whether the intermediate fingerprint is smaller compared with the previous fingerprint, and
if the intermediate fingerprint is determined to be smaller compared with the previous fingerprint, the intermediate fingerprint is determined to be more representative of the contents of the block.

4. The method of claim 1, wherein determining the intermediate fingerprint comprises computing a hash value for the shingle.

5. The method of claim 1, wherein determining the intermediate fingerprint comprises:
determining a first intermediate fingerprint by performing a modulo operation between a Mersenne prime and the shingle, wherein the modulo operation is performed using a plurality of addition operations;
determining a second intermediate fingerprint by performing a random permutation of the first intermediate fingerprint; and
using the second intermediate fingerprint as the intermediate fingerprint.

6. The method of claim 5, wherein performing the random permutation of the first intermediate fingerprint comprises:
performing a bit shift operation by a random number of bits on the first intermediate fingerprint; and
performing an addition operation by a random constant on the second intermediate fingerprint.

7. The method of claim 1, wherein determining the intermediate fingerprint comprises:
determining a first intermediate fingerprint by performing Rabin fingerprinting on the shingle, wherein the Rabin fingerprinting calculates a random irreducible polynomial based on the shingle using a plurality of shift operations and exclusive or (XOR) operations;
determining a second intermediate fingerprint by performing a random permutation of the first intermediate fingerprint; and
using the second intermediate fingerprint as the intermediate fingerprint.

8. The method of claim 7, comprising
sampling a first subset of bits from the first intermediate fingerprint;
determining whether the sampled first subset of bits from the first intermediate fingerprint matches a bit mask pattern;
if the sampled first subset of bits from the first intermediate fingerprint matches the bit mask pattern, determining the second intermediate fingerprint based on a remaining second subset of bits from the first intermediate fingerprint; and
otherwise, processing the next shingle.

9. The method of claim 1, wherein determining the intermediate fingerprint comprises:
determining a first intermediate fingerprint by calculating a random irreducible polynomial based on the shingle;
sampling a first subset of bits from the first intermediate fingerprint;
determining whether the sampled first subset of bits from the first intermediate fingerprint matches a bit mask pattern;
if the sampled first subset of bits from the first intermediate fingerprint matches the bit mask pattern,
determining a second intermediate fingerprint based on a remaining second subset of bits from the first intermediate fingerprint, and
using the second intermediate fingerprint as the intermediate fingerprint; and otherwise,
processing the next shingle.

10. The method of claim 9, wherein calculating the random irreducible polynomial comprises performing a table lookup of a pre-computed term of the random irreducible polynomial.

11. The method of claim 9, wherein the random irreducible polynomial comprises (b₁*p⁷+b₂*p⁶+b₃*p⁵+b₄*p⁴+b₅*p³+b₆*p²+b₇*p¹+b₈)mod M, wherein bᵢ denotes an i′th byte string of the shingle, wherein p denotes a prime constant, and M denotes a constant.

12. A circuit for computing a signature of contents of a block in a cache, the circuit comprising:
a fingerprint circuit configured for processing a shingle of a received block, wherein the shingle represents a subset of the contents of the received block, and wherein the fingerprint circuit is configured to determine an intermediate fingerprint by processing the shingle;
a fingerprint buffer configured for storing a previous fingerprint; and
a comparator in electrical communication with the fingerprint circuit and the fingerprint buffer,
wherein the comparator is configured for comparing the intermediate fingerprint from the fingerprint circuit with the previous fingerprint from the fingerprint buffer to determine whether the intermediate fingerprint is more representative of the contents of the received block than the previous fingerprint, and
wherein the comparator is configured for storing, in the fingerprint buffer, the intermediate fingerprint as a representative fingerprint for inclusion in the signature of the contents of the block, if the intermediate fingerprint is determined to be more representative.

13. The circuit of claim 12,
wherein the comparator configured for comparing the intermediate fingerprint from the fingerprint circuit with the previous fingerprint from the fingerprint buffer to determine whether the intermediate fingerprint is more representative of the contents of the previous block than the previous fingerprint comprises the comparator being configured for determining whether the intermediate fingerprint is larger than the previous fingerprint, and
wherein determining whether the intermediate fingerprint is larger than the previous fingerprint determines whether the intermediate fingerprint is more representative of the contents of the received block than the previous fingerprint.

14. The circuit of claim 12,
wherein the comparator configured for comparing the intermediate fingerprint from the fingerprint circuit with the previous fingerprint from the fingerprint buffer to determine whether the intermediate fingerprint is more representative of the contents of the previous block than the previous fingerprint comprises the comparator being configured for determining whether the intermediate fingerprint is smaller than the previous fingerprint, and
wherein determining whether the intermediate fingerprint is smaller than the previous fingerprint determines whether the intermediate fingerprint is more representative of the contents of the received block than the previous fingerprint.

15. The circuit of claim 12, wherein the fingerprint circuit comprises:
a first adder, a second adder, and a third adder configured for determining a first intermediate fingerprint by performing a modulo operation between a Mersenne prime and the shingle, wherein the modulo operation is performed by:
adding, using the first adder, a first subset of high order bits of the shingle to a second subset of high order bits of the shingle,
adding, using the second adder, a first subset of low order bits of the shingle to a second subset of low order bits of the shingle, and
determining, using the third adder, the first intermediate fingerprint by adding a result of the first adder to a result of the second adder; and
a bit shifter and a fourth adder configured for determining a second intermediate fingerprint by performing a random permutation of the first intermediate fingerprint, wherein performing the random permutation includes:
performing, using the bit shifter, a bit shift operation by a random number of bits on the first intermediate fingerprint
performing, using the fourth adder, an addition operation by a random constant on the second intermediate fingerprint, and
using the second intermediate fingerprint as the intermediate fingerprint.

16. The circuit of claim 12, wherein the fingerprint circuit comprises:
a polynomial subcircuit configured for determining the first intermediate fingerprint, wherein the polynomial subcircuit includes a plurality of shift registers and a plurality of logic gates arranged to generate a Rabin fingerprint of the shingle, wherein the Rabin fingerprint represents a hash value of the contents of the received block; and
a bit shifter and an adder configured for determining a second intermediate fingerprint by performing a random permutation of the first intermediate fingerprint, wherein performing the random permutation includes:
performing, using the bit shifter, a bit shift operation by a random number of bits on the first intermediate fingerprint
performing, using the adder, an addition operation by a random constant on the second intermediate fingerprint, and
using the second intermediate fingerprint as the intermediate fingerprint.

17. The circuit of claim 12, wherein the fingerprint circuit comprises:
a polynomial subcircuit configured for determining the first intermediate fingerprint, wherein the polynomial subcircuit includes a plurality of shift registers and a plurality of logic gates arranged to generate a Rabin fingerprint of the shingle, wherein the Rabin fingerprint represents a hash value of the contents of the received block; and
a first logic gate and a second logic gate,
wherein the first logic gate is configured for sampling a first subset of bits from the first intermediate fingerprint by bit masking a subset of high order bits from the first intermediate fingerprint, and
wherein the second logic gate is configured for
determining the second intermediate fingerprint, upon performing a logical AND operation to determine whether the sampled first subset of bits from the first intermediate fingerprint matches the bit mask pattern; and
using the second intermediate fingerprint as the intermediate fingerprint.

18. The circuit of claim 12, wherein the fingerprint circuit comprises:
a polynomial subcircuit configured for determining the first intermediate fingerprint, wherein the polynomial subcircuit includes a plurality of shift registers and an adder, wherein the plurality of shift registers and the adder are arranged to calculate a random irreducible polynomial based on the shingle, wherein the random irreducible polynomial represents a hash value of the contents of the received block; and
a first logic gate and a second logic gate,
wherein the first logic gate is configured for sampling a first subset of bits from the first intermediate fingerprint by bit masking a subset of low order bits from the first intermediate fingerprint, and
wherein the second logic gate is configured for:
determining the second intermediate fingerprint, upon performing a logical AND operation to determine whether the sampled first subset of bits from the first intermediate fingerprint matches the bit mask pattern; and
using the second intermediate fingerprint as the intermediate fingerprint.

19. The circuit of claim 18,
wherein the polynomial subcircuit further includes a lookup table,
wherein the lookup table comprises a pre-computed term of the random irreducible polynomial, and
wherein a term of the random irreducible polynomial is calculated based on looking up a corresponding pre-computed term in the lookup table.

20. The circuit of claim 18, wherein the polynomial subcircuit is configured to store in the shift registers the random irreducible polynomial (b₁*p⁷+b₂*p⁶+b₃*p⁵+b₄*p⁴+b₅*p³+b₆*p²+b₇*p¹+b₈)mod M, wherein bᵢ denotes an i′th byte string of the shingle, wherein p denotes a prime constant, and wherein M denotes a constant.
